(19) United States
(12) Patent Application Publication
(10) Pub. No.: US 2024/0187183 A1
(43) Pub. Date: Jun. 6, 2024

(54) METHOD AND APPARATUS FOR TRANSMITTING PHASE TRACKING SIGNAL CONSIDERING MULTI-PANEL SIMULTANEOUS TRANSMISSION IN WIRELESS COMMUNICATION SYSTEM

(71) Applicant: Samsung Electronics Co., Ltd., Gyeonggi-do (KR)

(72) Inventors: Seongmok LIM, Gyeonggi-do (KR); Kyoungmin PARK, Gyeonggi-do (KR); Ameha Tsegaye ABEBE, Gyeonggi-do (KR); Youngrok JANG, Gyeonggi-do (KR); Hyoungju JI, Gyeonggi-do (KR); Kyungjun CHOI, Gyeonggi-do (KR)

(21) Appl. No.: 18/505,443

(22) Filed: Nov. 9, 2023

(30) Foreign Application Priority Data
Nov. 10, 2022 (KR) 10-2022-0150008

(51) Int. Cl. H04L 5/00; H04W 72/0457; H04W 72/232

(52) U.S. Cl. CPC H04L 5/0051; H04W 72/0457; H04W 72/232

(57) ABSTRACT

The disclosure relates to a 5G or 6G communication system for supporting a higher data transmission rate. A method performed by a UE in a wireless communication system is provided, which includes receiving, from a BS, configuration information associated with a UL, the configuration information including SRS resource set information including a first SRS resource set and a second SRS resource set, information indicating that at most two PT-RS ports are used for the UL, and information for a configuration of simultaneous transmission across multi-panel (STxMP); receiving, from the BS, DCI including association information between a PT-RS port and a DMRS port; and in case STxMP is configured, transmitting, based on the DCI, the PT-RS using a first PT-RS port and a second PT-RS port, according to the received configuration of the STxMP. The first PT-RS port is associated with at least one first DMRS port associated with the first SRS resource set, and the second PT-RS port is associated with at least one second DMRS port associated with the second SRS resource set.

### CROSS-REFERENCE TO RELATED APPLICATION(S)

This application is based on and claims priority under 35 U.S.C. § 119 to Korean Patent Application No. 10-2022-0150008, which was filed in the Korean Intellectual Property Office on Nov. 10, 2022, the entire disclosure of which is incorporated herein by reference.

### BACKGROUND

### 1. Field

The disclosure relates generally to operations of a user equipment (UE) and a base station (BS) in a wireless communication system (or mobile communication system). More specifically, the disclosure relates to a method for performing simultaneous uplink (UL) transmission by using multiple panels in a wireless communication system, a UE capability reporting method of the UE for corresponding operations, a method for transmitting a phase tracking reference signal (PT-RS) in case of simultaneous multi-panel transmission based on a higher layer parameter configuration of a BS and scheduling information on a UL channel in which the UE is scheduled, and an apparatus capable of performing the methods.

### 2. Description of Related Art

5th generation (5G) mobile communication technologies define broad frequency bands such that high transmission rates and new services are possible, and can be implemented in “sub 6 GHz” bands such as 3.5 GHz, and in “above 6 GHz” bands, referred to as mmWave, including 28 GHz and 39 GHz. In addition, it has been considered to implement 6^{th} generation (6G) mobile communication technologies (referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by newer 5G mobile communication technologies, such as physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, a non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that that will be connected to communication networks is expected to exponentially increase, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

In addition, the development of such a 5G mobile communication system includes a new waveform, full dimensional MIMO (FD-MIMO), array antennas for guaranteeing coverage in the THz band of 6G mobile communication technology, multi-antenna transmission technologies such as large scale antennas, metamaterial-based lenses and antennas to improve coverage of terahertz band signals, high-dimensional spatial multiplexing technology using orbital angular momentum (OAM), reconfigurable intelligent surface RIS) technology, as well as full duplex technology to improve frequency efficiency and system network of 6G mobile communication technology, satellite. Additionally, AI may be utilized from the design stage and end-to-end development of AI-based communication technology that realizes system optimization by internalizing AI-supported functions and next-generation distributed computing technology that realizes complex services beyond the limits of terminal computing capabilities by utilizing ultra-high-performance communication and computing resources could be the basis for.

### SUMMARY

An aspect of the disclosure is to provide a method and an apparatus for effectively providing a service in mobile communication systems.

Another aspect of the disclosure is to provide a method for transmitting a phase tracking signal for simultaneous transmission of multiple UL channels by using multiple panels in a wireless communication system.

In accordance with an aspect of the disclosure, a method performed by a UE in a wireless communication system is provided. The method includes receiving, from a BS, configuration information associated with an uplink (UL), the configuration information including sounding reference signal (SRS) resource set information including a first SRS resource set and a second SRS resource set, information indicating that at most two phase tracking reference signal (PT-RS) ports are used for the UL, and information for a configuration of simultaneous transmission across multi-panel (STxMP); receiving, from the BS, downlink control information (DCI) including association information between a PT-RS port and a demodulation reference signal (DMRS) port; and transmitting, based on the DCI, the PT-RS using a first PT-RS port and a second PT-RS port, according to the received configuration of the STxMP. The first PT-RS port is associated with at least one first DMRS port associated with the first SRS resource set, and the second PT-RS port is associated with at least one second DMRS port associated with the second SRS resource set.

In accordance with another aspect of the disclosure, a method performed by a BS in a wireless communication system is provided. The method includes transmitting, to a UE, configuration information associated with a UL, the configuration information including SRS resource set information including a first SRS resource set and a second SRS resource set, and information indicating that at most two PT-RS ports are used for the UL, and information for a configuration of simultaneous transmission across multi-panel (STxMP); transmitting, to the UE, DCI including association information between a PT-RS port and a DMRS port; and in case STxMP is configured, receiving, based on the DCI, the PT-RS based on a first PT-RS port and a second PT-RS port, according to the received configuration of the STxMP. The first PT-RS port is associated with at least one first DMRS port associated with the first SRS resource set, and the second PT-RS port is associated with at least one second DMRS port associated with the second SRS resource set.

In accordance with another aspect of the disclosure, a UE is provided for use in a wireless communication system. The UE includes a transceiver; and a controller coupled with the transceiver and configured to receive, from a BS, configuration information associated with a UL, the configuration information including SRS resource set information including a first SRS resource set and a second SRS resource set, information indicating that at most two PT-RS ports are used for the UL, and information for a configuration of simultaneous transmission across multi-panel (STxMP), receive, from the BS, DCI including association information between a PT-RS port and a DMRS port, and in case STxMP is configured, transmitting, based on the DCI, the PT-RS using a first PT-RS port and a second PT-RS port according to the received configuration of the STxMP. The first PT-RS port is associated with at least one first DMRS port associated with the first SRS resource set, and the second PT-RS port is associated with at least one second DMRS port associated with the second SRS resource set.

In accordance with another aspect of the disclosure, a BS is provided for use in a wireless communication system. The BS includes a transceiver; and a controller coupled with the transceiver and configured to transmit, to a UE, configuration information associated with a UL, the configuration information including SRS resource set information including a first SRS resource set and a second SRS resource set, information indicating that at most two PT-RS ports are used for the UL, and information for a configuration of simultaneous transmission across multi-panel (STxMP), transmit, to the UE, DCI including association information between a PT-RS port and a DMRS port, and in case STxMP is configured, receiving the PT-RS based on a first PT-RS port and a second PT-RS port, according to the received configuration of the STxMP. The first PT-RS port is associated with at least one first DMRS port associated with the first SRS resource set, and the second PT-RS port is associated with at least one second DMRS port associated with the second SRS resource set.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain in a wireless communication system according to an embodiment;

FIG. 2 illustrates a frame, a subframe, and a slot in a wireless communication system according to an embodiment;

FIG. 3 illustrates a BWP configuration in a wireless communication system according to an embodiment of the disclosure;

FIG. 4 illustrates a BS beam allocation according to a transmission configuration indicator (TCI) state configuration in a wireless communication system according to an embodiment;

FIG. 5 illustrates a frequency axis resource allocation for a p2hysical downlink (DL) shared channel (PDSCH) in a wireless communication system according to an embodiment;

FIG. 6 illustrates a time axis resource allocation for a PDSCH in a wireless communication system according to an embodiment;

FIG. 7 illustrates a procedure for beam configuration and activation of a PDSCH according to an embodiment;

FIG. 8 illustrates a medium access control (MAC) control element (CE) for physical UL control channel (PUCCH) resource group-based spatial relation activation in a wireless communication system according to an embodiment;

FIG. 9 illustrates a repetitive physical UL shared channel (PUSCH) transmission type-B in a wireless communication system according to an embodiment;

FIG. 10 illustrates a radio protocol structure of a BS and a UE in a single cell, carrier aggregation (CA), and dual connectivity (DC) situation in a wireless communication system according to an embodiment;

FIG. 11 illustrates an antenna port configuration and resource allocation for cooperative communication in a wireless communication system according to an embodiment;

FIG. 12 illustrates a configuration of DCI for cooperative communication in a wireless communication system according to an embodiment;

FIG. 13 illustrates an enhanced PDSCH TCI state activation/deactivation MAC-CE structure according to an embodiment;

FIG. 14 illustrates a radio link monitoring (RLM) reference signal (RS) selection process according to an embodiment;

FIG. 15 illustrates a MAC-CE structure for activation and indication of a joint TCI state in a wireless communication system according to an embodiment;

FIG. 16 illustrates a MAC-CE structure for activation and indication of a joint TCI state in a wireless communication system according to an embodiment;

FIG. 17 illustrates a MAC-CE structure for activation and indication of a joint TCI state in a wireless communication system according to an embodiment;

FIG. 18 illustrates a MAC-CE structure for activation and indication of a separate TCI state in a wireless communication system according to an embodiment;

FIG. 19 illustrates a MAC-CE structure for activation and indication of a separate TCI state in a wireless communication system according to an embodiment;

FIG. 20 illustrates a MAC-CE structure for activation and indication of a separate TCI state in a wireless communication system according to an embodiment;

FIG. 21 illustrates a MAC-CE structure for activation and indication of a separate TCI state in a wireless communication system according to an embodiment;

FIG. 22 illustrates a MAC-CE structure for activation and indication of a joint and separate TCI state in a wireless communication system according to an embodiment;

FIG. 23 illustrates a MAC-CE structure for activation and indication of a joint and separate TCI state in a wireless communication system according to an embodiment;

FIG. 24 illustrates a beam application time (BAT) using a unified TCI scheme in a wireless communication system according to an embodiment;

FIG. 25 illustrates a MAC-CE structure for activation and indication of multiple joint TCI states in a wireless communication system according to an embodiment;

FIG. 26 illustrates a MAC-CE structure for activation and indication of multiple separate TCI states in a wireless communication system according to an embodiment;

FIG. 27 illustrates a MAC-CE structure for activation and indication of multiple separate TCI states in a wireless communication system according to an embodiment;

FIG. 28 illustrates a MAC-CE structure for activation and indication of a joint TCI state or separate DL or UL TCI state in a wireless communication system according to an embodiment;

FIG. 29 illustrates a MAC-CE structure for activation and indication of multiple joint TCI states, or separate DL or UL TCI states in a wireless communication system according to an embodiment;

FIG. 30 illustrates a MAC-CE structure for activation and indication of multiple joint TCI states, or separate DL or UL TCI states in a wireless communication system according to an embodiment;

FIG. 31 illustrates two SRS resource sets including two SRS resources and a UE supporting simultaneous UL transmission by using two panels in a wireless communication system according to an embodiment;

FIG. 32 illustrates two SRS resource sets including two SRS resources and a UE supporting simultaneous UL transmission by using two panels in a wireless communication system according to an embodiment;

FIG. 33 illustrates two PUSCHs simultaneously transmitted to a single DCI-based multi-panel according to an embodiment;

FIG. 34 illustrates two PUSCHs simultaneously transmitted to a multi-DCI-based multi-panel according to an embodiment;

FIG. 35 illustrates a UE according to an embodiment; and

FIG. 36 illustrates a BS according to an embodiment.

### DETAILED DESCRIPTION

Hereinafter, various embodiments of the disclosure will be described in detail with reference to the attached drawings.

In describing the embodiments, description of technical content that is well known in the technical field to which this disclosure belongs and that is not directly related to this disclosure will be omitted. This is to convey the disclosure more clearly without obscuring it with unnecessary explanation.

Some components in the attached drawings are exaggerated, omitted, or schematically shown. Additionally, the size of each component does not entirely reflect its actual size. In each drawing, identical or corresponding components may be assigned the same reference numbers.

Various advantages and features of the disclosure and methods for achieving them will become clear by referring to the embodiments described in detail below along with the accompanying drawings. However, the present disclosure is not limited to the embodiments disclosed below and may be implemented in various different forms, and the present embodiments are merely intended to ensure that the disclosure is complete and are within the scope of common knowledge in the technical field to which the present disclosure pertains. It is provided to fully inform those who have the scope of the disclosure, and the disclosure is only defined by the scope of the claims.

The terms described below are terms defined in consideration of the functions in the present disclosure, and may vary depending on the intention or custom of the user or operator. Therefore, the definition should be made based on the contents throughout this disclosure.

Each block of the processing flow diagrams and combinations of the flow diagram diagrams can be performed by computer program instructions. These computer program instructions can be mounted on a processor of a general-purpose computer, special-purpose computer, or other programmable data processing equipment, so that the instructions performed through the processor of the computer or other programmable data processing equipment are described in the flow chart block(s). These computer program instructions may also be stored in computer-usable or computer-readable memory that can be directed to a computer or other programmable data processing equipment to implement a function in a particular manner, so that the computer-usable or computer-readable memory. It is also possible to produce manufactured items containing instruction means that perform the functions described in the flowchart block(s).

Computer program instructions can also be mounted on a computer or other programmable data processing equipment, so that a series of operational steps are performed on the computer or other programmable data processing equipment to create a process that is executed by the computer, thereby generating a process that is executed by the computer or other programmable data processing equipment. Instructions that perform processing equipment may also provide steps for executing the functions described in the flow diagram block(s).

Additionally, each block may represent a module, segment, or portion of code that includes one or more executable instructions for executing specified logical function(s). Additionally, in some alternative execution examples, it is possible for the functions mentioned in the blocks to occur out of order. For example, it is possible for two blocks shown in succession to be performed substantially simultaneously, or it is possible for the blocks to be performed in reverse order depending on the corresponding function.

The term ‘unit’ may refer to software or hardware components such as a field programmable gate array (FPGA) or an application specific integrated circuit (ASIC), and ‘unit’ performs certain roles. do. However, ‘unit’ is not limited to software or hardware. The ‘˜unit’ may be configured to reside in an addressable storage medium and may be configured to reproduce on one or more processors. Therefore, as an example, ‘— unit’ may refer to components such as software components, object-oriented software components, class components, and task components, processes, functions, properties, and procedures., subroutines, segments of program code, drivers, firmware, microcode, circuitry, data, databases, data structures, tables, arrays, and variables. The functions provided within the components and ‘units’ may be combined into a smaller number of components and ‘units’ or may be further separated into additional components and ‘units’. Additionally, components and units' may be implemented to regenerate one or more central processing units (CPUs) within a device or a secure multimedia card. Additionally, a ‘— unit’ may include one or more processors.

Wireless communication systems have moved away from providing early voice-oriented services to, e.g., 3^{rd} generation partnership project (3GPP) high speed packet access (HSPA), long term evolution (LTE) or evolved universal terrestrial radio access (EUTRA), and LTE-advanced. Additionally, broadband wireless that provides high-speed, high-quality packet data services such as communication standards such as LTE-A, LTE-Pro, 3GPP2's high rate packet data (HRPD), ultra mobile broadband (UMB), and IEEE's 802.16e, is evolving into a communication system.

As a representative example of the broadband wireless communication system, the LTE system adopts orthogonal frequency division multiplexing (OFDM) in the DL, and single carrier frequency division multiplexing (SC-FDMA) in the UL. Herein, a UL refers to a wireless link in which a terminal (e.g., a UE or an mobile station (MS)) transmits data or control signals to a BS (or eNode B), and a DL refers to a wireless link in which the BS transmits data or control signals to the UE. The wireless link may transmit data or control signals. In a multiple access method, the time-frequency resources to carry data or control information for each user are usually allocated and operated so that they do not overlap, i.e., orthogonality is established, so that each user's data or control information may be distinguished.

As a future communication system after LTE, a 5G communication system should be able to freely reflect the various requirements of users and service providers, supporting services that simultaneously satisfy various requirements. Services considered for the 5G communication system include eMBB, mMTC, and URLLC.

eMBB aims to provide more improved data transmission speeds than those supported by existing LTE, LTE-A or LTE-Pro. For example, in a 5G communication system, eMBB should be able to provide a peak data rate of 20 Gbps in the DL and 10 Gbps in the UL from the perspective of one BS. In addition, the 5G communication system should provide the maximum transmission rate and at the same time provide increased user perceived data rate. In order to meet these requirements, improvements in various transmission and reception technologies are required, including more advanced multi-antenna (e.g., MIMO) transmission technology.

In addition, while LTE transmits signals using a maximum of 20 MHz transmission bandwidth in the 2 GHz band, the 5G communication system uses a frequency bandwidth wider than 20 MHz in the 3-6 GHz or above 6 GHz frequency band to transmit the data, and transmission speed required by the 5G communication system can be satisfied.

mMTC is being considered to support application services such as the Internet of things (IoT) in 5G communication systems. In order to efficiently provide the IoT, mMTC requires support for access to a large number of terminals within a cell, improved coverage of terminals, improved battery time, and reduced terminal costs. Since the IoT provides communication functions by attaching various sensors and various devices, it must be able to support a large number of terminals (e.g., 1,000,000 terminals/km 2) within a cell.

Additionally, due to the nature of the service, terminals that support mMTC are likely to be located in shadow areas that cannot be covered by cells, such as the basement of a building, so they may require wider coverage than other services provided by the 5G communication system. Terminals that support mMTC must be composed of low-cost terminals, and since it is difficult to frequently replace the terminal's battery, a very long battery life time, such as 10 to 15 years, may be required.

URLLC is a cellular-based wireless communication service used for a specific purpose (e.g., mission-critical), such as remote control of robots or machinery, industrial automation, unmanned aerial vehicles, remote health care, and emergency situations. Services used for emergency alerts, etc., can be considered. Therefore, the communication provided by URLLC should provide very low latency and very high reliability. For example, a service that supports URLLC should satisfy an air interface latency of less than 0.5 milliseconds and has a packet error rate of less than 10⁻⁵. Therefore, for services supporting URLLC, the 5G system must provide a smaller transmit time interval (TTI) than other services, and at the same time, design requirements that wide resources must be allocated in the frequency band to ensure the reliability of the communication link may be required.

The three 5G services, i.e., eMBB, URLLC, and mMTC, can be multiplexed and transmitted in one system. Different transmission/reception techniques and transmission/reception parameters can be used between services to satisfy the different requirements of each service. Of course, 5G is not limited to the three services mentioned above.

Hereinafter, a BS is an entity that performs resource allocation for the terminal and may include a gNode B, an eNode B, a Node B, a wireless access unit, a BS controller, or a node on a network. A terminal may include a UE, an MS, a cellular phone, a smartphone, a computer, or a multimedia system capable of performing communication functions.

Although an LTE or LTE-A system may be described herein as an example, embodiments of the disclosure may also be applied to other communication systems with similar technical background or channel type, e.g., 5G mobile communication technology such as NR, developed after LTE-A, and the term 5G hereinafter may also include the existing LTE, LTE-A, and other similar services.

In addition, this disclosure may be applied to other communication systems through some modifications without significantly departing from the scope of the present disclosure at the discretion of a person with skilled technical knowledge.

[NR Time-Frequency Resource]

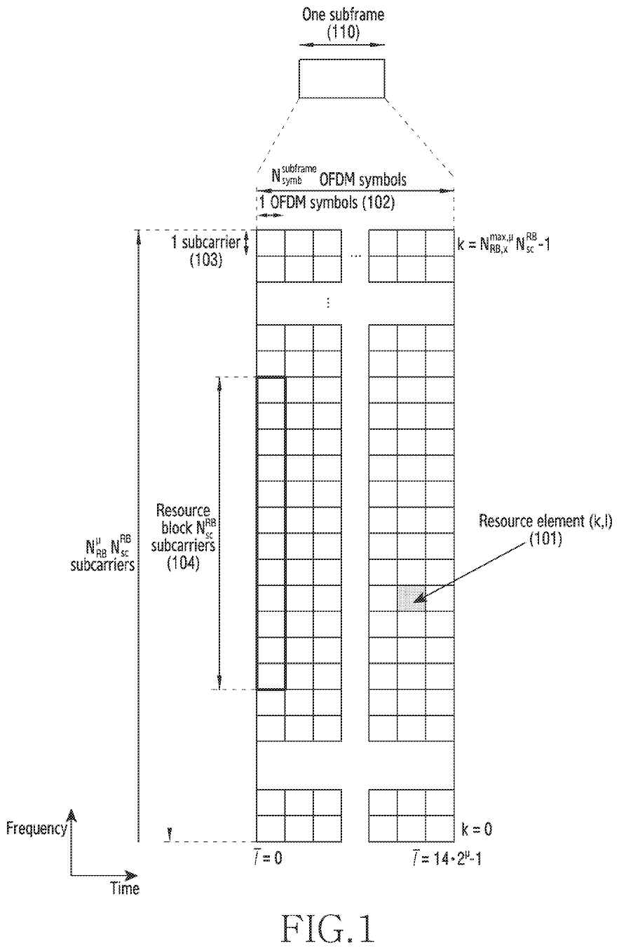

FIG. 1 illustrates a time-frequency domain in a wireless communication system according to an embodiment.

Referring to FIG. 1, a horizontal axis indicates a time domain, and a vertical axis indicates a frequency domain. A basic unit of a resource in the time-frequency domain is a resource element (RE) 101 and may be defined as one OFDM symbol 102 in the time axis and one subcarrier 103 in the frequency axis. In the frequency domain, N_{SC}^{RB}(e.g., 12) consecutive REs may constitute one resource block (RB) 104. One subframe 110 in the time axis may include multiple OFDM symbols 102. For example, one subframe may have a length of 1 ms.

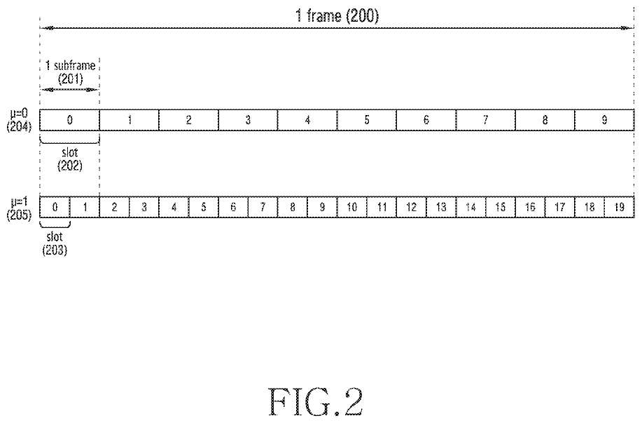

FIG. 2 illustrates a frame, a subframe, and a slot in a wireless communication system according to an embodiment.

Referring to FIG. 2, a frame 200, a subframe 201, and a slot 202 are illustrated. A frame 200 may be defined as 10 ms. A subframe 201 may be defined as 1 ms, and accordingly, the frame 200 may include 10 subframes 201. A slot 202 or 203 may be defined as 14 OFDM symbols (i.e., the number of symbols per slot (N_{symb}^{slot}=14).

The subframe 201 may include one or multiple slots 202 and 203, and the number of slots 202 and 203 per subframe 201 may vary according to a configuration value μ (204 or 205) for SCS. An example of FIG. 2 shows a case in which the SCS configuration value corresponds to μ=0 (204) and a case in which the SCS configuration value corresponds to μ=1 (205). In the case of μ=0 (204), one subframe 201 may include one slot 202, and, in the case of μ=1 (205), one subframe 201 may include two slots 203. That is, the number (Nₛₗₒₜ^{subframe,μ}) of slots per subframe may vary according to the configuration value μ for SCS, and accordingly, the number (Nₛₗₒₜ^{frame,μ}) of slots per frame may also vary. Nₛₗₒₜ^{subframe,μ} and Nₛₗₒₜ^{frame,μ} according to each SCS configuration μ may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

[BWP]

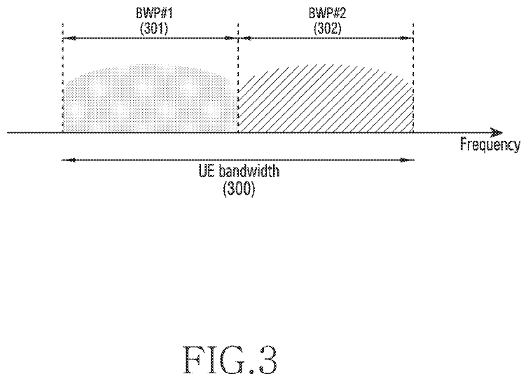

FIG. 3 illustrates a BWP configuration in a wireless communication system according to an embodiment.

Referring to FIG. 3, a UE bandwidth 300 is configured of two BWPs, i.e., BWP #1 301 and BWP #2 302. The BS may configure one or multiple BWPs to the UE, and may configure information below for each BWP.

TABLE 2

| | |
|---|---|
| BWP ::= | SEQUENCE |
| bwp-Id | BWP-Id, |

Bandwidth part identifier)

| | |
|---|---|
| locationAndBandwidth | INTEGER (1..65536), |

(Bandwidth part location)

| | |
|---|---|
| subcarrierSpacing | ENUMERATED {n0, n1, n2, n3, n4, n5}, |

(Subcarrier spacing)

| | |
|---|---|
| cyclicPrefix | ENUMERATED { extended } |

(Cyclic prefix)
}

Additionally, various parameters regarding a BWP may be configured to the UE in addition to the configuration information. The information may be transferred, to the UE, by the BS, through higher layer signaling, e.g., radio resource control (RRC). Among one or multiple configured BWPs, at least one BWP may be activated. Information indicating whether the configured BWPs are activated may be semi-statically transferred, from the BS, to the UE, through RRC signaling or may be dynamically transferred through DCI.

According to some embodiments, the UE, before an RRC connection, may receive a configuration of an initial BWP for initial access from the BS through a master information block (MIB). More specifically, the UE may receive configuration information for a control resource set (CORESET) and a search space in which a physical DL control channel (PDCCH) for receiving system information (SI) (e.g., corresponding to remaining SI (RMSI) or SI block 1 (SIB1)) for initial access through the MIB may be transmitted in an initial access step. Each of the control region and the search space configured through the MIB may be considered as an identifier (ID) 0. The BS may inform the UE of configuration information such as frequency allocation information for control region #0, time allocation information, numerology, etc., through the MIB. Furthermore, the BS may inform the UE of configuration information for a monitoring period and a monitoring occasion of control region #0, i.e., configuration information for search space #0 through the MIB. The UE may consider a frequency region configured as control region #0 acquired from the MIB as an initial BWP for initial access. Here, the ID of the initial BWP may be considered as 0.

The configuration of the BWP supported by 5G may be used for various purposes.

According to some embodiments, when a bandwidth supported by the UE is smaller than the system bandwidth, the smaller bandwidth may be supported through the configuration of the BWP. For example, the BS may configure a frequency location (configuration information 2) of the BWP in the UE, and thus, the UE may transmit and receive data at a specific frequency location within the system bandwidth.

According to some embodiments, the BS may configure multiple BWPs in the UE in order to support different numerologies. For example, in order to support a UE to perform data transmission and reception using both SCS of 15 kHz and SCS of 30 kHz, two BWPs may be configured as SCSs of 15 kHz and 30 kHz, respectively. Different BWPs may be frequency-division-multiplexed (FDMed), and when data is transmitted and received at particular SCS, the BWP configured at the corresponding SCS may be activated.

Furthermore, the BS may configure BWPs with different sized bandwidths in the UE in order to reduce power consumption of the UE. For example, when the UE supports a very large bandwidth, e.g., a bandwidth of 100 MHz and always transmits and receives data through the corresponding bandwidth, very high power consumption may be caused. Particularly, monitoring an unnecessary DL control channel through a large bandwidth of 100 MHz in a state having no traffic is very inefficient in terms of the aspect of power consumption. In order to reduce power consumption of the UE, the BS may configure a BWP having a relatively narrow bandwidth, e.g., a bandwidth of 20 MHz to the UE. The UE may perform a monitoring operation in the BWP of 20 MHz in the state having no traffic, and if data is generated, may transmit and receive data through the BWP of 100 MHz according to an instruction from the BS.

In a method for configuring the BWP, UEs, before an RRC connection, may receive configuration information for an initial BWP through an MIB in an initial access step. More specifically, the UE may be configured with a control region (i.e., a CORESET) for a DL control channel in which DCI for scheduling an SI block (SIB) may be transmitted from an MIB of a physical broadcast channel (PBCH).

A bandwidth of the control region configured as the MIB may be considered as an initial BWP, and the UE may receive a PDSCH, in which the SIB is transmitted, through the configured initial BWP. The initial BWP may be for reception of the SIB and also for other SI (OSI), paging, or random access.

[BWP Change]

In case that one or multiple BWPs are configured in the UE, the BS may indicate a change (or switching or transition) in the BWPs to the UE through a BWP indicator field within the DCI. For example, in FIG. 3, when a currently activated BWP of the UE is BWP #1 301, the BS may indicate BWP #2 302 to the UE through a BWP indicator within DCI and the UE may make a BWP change to BWP #2 302 indicated by the received BWP indicator within DCI.

As described above, since the DCI-based BWP switching may be indicated by the DCI for scheduling the PDSCH or the PUSCH, the UE should be able to receive or transmit the PDSCH or the PUSCH scheduled by the corresponding DCI in the changed BWP without any difficulty if the UE receives a BWP switching request. To this end, the standard has defined requirements for a delay time (T_{BWP}) required for the BWP switching, and may be defined as below.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note1}
Depends on UE capability.
Note 2:
If the BWP switch involves changing of SCS, the BWP switch delay is determined by the larger one between the SCS before BWP switch and the SCS after BWP switch.

The requirements for the BWP switching delay time support type 1 or type 2 according to a capability of the UE. The UE may report a supportable BWP delay time type to the BS.

In case that the UE receives DCI including a BWP switching indicator in slot n according to the requirements for the BWP switching delay time, the UE may complete a switching to a new BWP indicated by the BWP switching indicator at a time point that is not later than slot n+T_{BWP} and transmit and receive a data channel scheduled by the corresponding DCI in the switched new BWP.

In case that the BS tries to schedule a data channel in the new BWP, the BS may determine allocation of time domain resources for the data channel in consideration of the BWP switching delay time (T_{BWP}) of the UE. That is, in case of scheduling the data channel in the new BWP, the BS may schedule the corresponding data channel after the BWP switching delay time as a method of determining allocation of time domain resources for the data channel. Accordingly, the UE may not expect that the DCI indicating the BWP switching indicates a slot offset (K0 or K2) value smaller than the BWP switching delay time (T_{BWP}).

If the UE receives DCI (e.g., DCI format 1_1 or 0_1) indicating the BWP switching, the UE may perform no transmission or reception during a time interval corresponding to symbols from a third symbol of a slot for receiving the PDCCH including the corresponding DCI to a start point of the slot indicated by the slot offset (K0 or K2) value indicated by a time domain resource allocation (TDRA) indicator field within the corresponding DCI. For example, in case that the UE receives DCI indicating the BWP switching in slot n and a slot offset value indicated by the corresponding DCI is K, the UE may perform no transmission or reception from the third symbol of slot n to a symbol before slot n+K (that is, the last symbol of slot n+K−1).

[PDCCH: In Relation to DCI]

In a 5G system, scheduling information on UL data (or a PUSCH) or DL data (or a PDSCH) is transferred through DCI from a BS to a UE. The UE may monitor a fallback DCI format and a non-fallback DCI format for the PUSCH or the PDSCH. The fallback DCI format may be configured with a fixed field pre-defined between the BS and the UE, and the non-fallback DCI format may include a configurable field.

DCI may go through a channel coding and modulation process, and then be transmitted through a PDCCH. A cyclic redundancy check (CRC) may be attached to a DCI message payload, and the CRC may be scrambled by a radio network temporary identifier (RNTI) corresponding to the identity of the UE. Different types of RNTIs may be used according to the purpose of a DCI message, e.g., a UE-specific (UE-specific) data transmission, a power control command, a random access response (RAR), etc. That is, an RNTI may not be explicitly transmitted, and may be transmitted after being included in a CRC calculation process. If the UE has received a DCI message transmitted on a PDCCH, the UE may identify a CRC by using an allocated RNTI, and if a CRC identification result is correct, the UE may identify that the message has been transmitted to the UE.

For example, a DCI scheduling a PDSCH for SI may be scrambled by an SI-RNTI. DCI scheduling a PDSCH for an RAR message may be scrambled by a random access (RA)-RNTI. DCI scheduling a PDSCH for a paging message may be scrambled by a paging (P)-RNTI. DCI notifying of a slot format indicator (SFI) may be scrambled by an SFI-RNTI. DCI notifying of a transmit power control (TPC) may be scrambled by a TPC-RNTI. DCI scheduling a UE-specific PDSCH or PUSCH may be scrambled by a cell RNTI (C-RNTI).

DCI format 0_0 may be used for fallback DCI scheduling a PUSCH, and in this case, a CRC may be scrambled by a C-RNTI. DCI format 0_0 having a CRC scrambled by a C-RNTI may include, e.g., information as shown in Table 4 below.

TABLE 4

| | |
|---|---|
| - | Identifier for DCI formats - [1] bit |
| - | Frequency domain resource assignment - [┌log₂(N_{RB}^{UL,BWP}(N_{RB}^{UL,BWP} +1)/2)┐ ] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL indicator - 0 or 1 bit |

DCI format 0_1 may be used for non-fallback DCI scheduling a PUSCH, and in this case, a CRC may be scrambled by a C-RNTI. DCI format 0_1 having a CRC scrambled by a C-RNTI may include, e.g., information as shown in Table 5 below.

```
TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
    • For resource allocation type 0, ┌N_{RB}^{UL,BWP} / P┐ bits
    • For resource allocation type 1, ┌log₂(N_{RB}^{UL,BWP} (N_{RB}^{UL,BWP} + 1)/2)┐ bits
- Time domain resource assignment - 1, 2, 3, or 4 bits
- VRB-to-PRB mapping - 0 or 1 bit, only for resource allocation type 1.
    • 0 bit if only resource allocation type 0 is configured;
    • 1 bit otherwise.
- Frequency hopping flag - 0 or 1 bit, only for resource allocation type 1.
    • 0 bit if only resource allocation type 0 is configured;
    • 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
    • 1 bit for semi-static HARQ-ACK codebook;
    •  2 bits for dynamic HARQ-ACK codebook with single HARQ-ACK codebook.
- 2nd downlink assignment index - 0 or 2 bits
    • 2 bits for dynamic HARQ-ACK codebook with two HARQ-ACK sub-codebooks;
    • 0 bit otherwise.
- TPC command for scheduled PUSCH - 2 bits
-  $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    •  $⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$
    • ┌log₂ (N_{SRS})┐ bits for codebook based PUSCH transmission.
- Precoding information and number of layers -up to 6 bits
- Antenna ports -up to 5 bits
- SRS request -2 bits
- CSI request - 0, 1, 2, 3, 4, 5, or 6 bits
- CBG transmission information - 0, 2, 4, 6, or 8 bits
- PTRS-DMRS association -0 or 2 bits.
- beta_offset indicator - 0 or 2 bits
- DMRS sequence initialization- 0 or 1 bit
```

DCI format 1_0 may be used for fallback DCI scheduling a PDSCH, and in this case, a CRC may be scrambled by a C-RNTI. DCI format 1_0 having a CRC scrambled by a C-RNTI may include, e.g., information as shown in Table 6 below.

TABLE 6

| | |
|---|---|
| - | Identifier for DCI formats - [1] bit |
| - | Frequency domain resource assignment - [┌log₂(N_{RB}^{UL,BWP}(N_{RB}^{UL,BWP} +1)/2)┐ ] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator - 3 bits |
| - | PDSCH-to-HARQ feedback timing indicator - [3] bits |

DCI format 1_1 may be used for non-fallback DCI scheduling a PDSCH, and in this case, a CRC may be scrambled by a C-RNTI. DCI format 1_1 having a CRC scrambled by a C-RNTI may include, e.g., information as shown in Table 7 below.

TABLE 7

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL,BWP}/P┐ bits |
| | • | For resource allocation type 1, ┌log₂(N_{RB}^{UL,BWP}(N_{RB}^{UL,BWP} +1)/2)┐ bits |
| - | Time domain resource assignment -1, 2, 3, or 4 bits | |
| - | VRB-to-PRB mapping - 0 or 1 bit, only for resource allocation | |
| | type 1. | |
| | • | 0 bit if only resource allocation type 0 is configured; |
| | • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

[Quasi-Co-Location (QCL), TCI State]

In a wireless communication system, one or more different antenna ports (or one or more channels, signals, and combinations thereof, but commonly referred to as different antenna ports for convenience in the following description of the disclosure) may be associated with each other by a QCL configuration as shown in Table 8 below. The TCI state is to inform of a QCL relation between a PDCCH (or a PDCCH DMRS) and another RS or channel, and a reference antenna port A (reference RS #A) and another purpose antenna port B (target RS #B) which are QCLed means that the UE is allowed to apply some or all of large-scale channel parameters estimated in the antenna port A to channel measurement from the antenna port B. The QCL is used to associate different parameters according to 1) time tracking influenced by an average delay and a delay spread, 2) frequency tracking influenced by a Doppler shift and a Doppler spread, 3) radio resource management (RRM) influenced by an average gain, and 4) beam management (BM) influenced by a spatial parameter, and the like. Accordingly, NR supports four types of QCL relations as shown in Table 8 below.

TABLE 8

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial reception (Rx) parameter may collectively refer to some or all of various parameters such as angle of arrival (AoA), power of angular spectrum (PAS) of AoA, angle of departure (AoD), PAS of AoD, transmission and reception channel correlation, transmitting/receiving beamforming, and spatial channel correlation.

The QCL relation may be configured in the UE through an RRC parameter TCI-state and QCL-Info as shown in Table 9 below.

Referring to Table 9 below, the BS may configure one or more TCI states in the UE and inform the UE of a maximum of two QCL relations (qcl-Type 1 and qcl-Type 2) for an RS referring to an ID of the TCI state, i.e., a target RS. Here, each piece of the QCL information (QCL-Info) included in the TCI state includes a serving cell index and a BWP index of a reference RS indicated by the corresponding QCL information, a type and an ID of the reference RS, and the QCL type as shown in Table 8 above.

TABLE 9

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

...
}

| QCL-Info ::= | SEQUENCE { | |
|---|---|---|
| cell | ServCellIndex | OPTIONAL, -- Need R |
| bwp-Id | BWP-Id | OPTIONAL, -- Cond |

CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

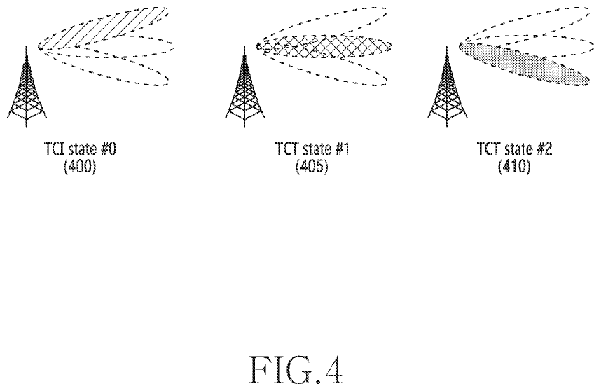

FIG. 4 illustrates a BS beam allocation according to a TCI state configuration in a wireless communication system according to an embodiment.

Referring to FIG. 4, a BS may transfer information on N different beams to a UE through N different TCI states. For example, when N=3 as illustrated in FIG. 4, the BS may notify that a qcl-Type 2 parameter included in three TCI states 400, 405, and 410 is associated with a channel state information (CSI)-RS or synchronization signal block (SSB) corresponding to different beams to be configured as QCL type D and antenna ports referring to the different TCI states 400, 405, and 410 are associated with different spatial Rx parameters, i.e., different beams.

Tables 10 to 14 below show valid TCI state configurations according to the target antenna port type.

More specifically, Table 10 shows valid TCI state configurations when a target antenna port is a CSI-RS for tracking (i.e., a tracking RS (TRS)). The TRS may be referred to as a non-zero power (NZP) CSI-RS for which a repetition parameter is not configured and trs-Info is configured as true among CSI-RSs. The third configuration in Table 10 may be used for an aperiodic TRS.

TABLE 10

| | | | DL RS 2 | qcl-Type2 |
|---|---|---|---|---|
| Valid TCI state | | | (If | (If |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 11 shows valid TCI state configurations when the target antenna port is a CSI-RS for CSI. The CSI-RS for CSI is an NZP CSI-RS for which a parameter (e.g., a repetition parameter) indicating repetition is not configured and trs-Info is not configured as true among the CSI-RSs.

TABLE 11

| | | | DL RS 2 | qcl-Type2 |
|---|---|---|---|---|
| Valid TCI state | | | (If | (If |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 12 shows valid TCI state configurations when the target antenna port is a CSI-RS for BM (i.e., a CSI-RS for L1 reference signal received power (RSRP) reporting). Among the CSI-RSs, the CSI-RS for BM is an NZP CSI-RS for which a repetition parameter is configured to have a value of on or off and trs-Info is not configured as true.

TABLE 12

| | | | DL RS 2 | qcl-Type2 |
|---|---|---|---|---|
| Valid TCI state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 13 shows valid TCI state configurations when the target antenna port is a PDCCH DMRS.

TABLE 13

| | | | DL RS 2 | qcl-Type2 |
|---|---|---|---|---|
| Valid TCI state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 14 shows valid TCI state configurations when the target antenna port is a PDSCH DMRS.

TABLE 14

| | | | DL RS 2 | qcl-Type2 |
|---|---|---|---|---|
| Valid TCI state | | | (If | (If |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

In a representative QCL configuration method using Tables 10 to 14, a target antenna port and a reference antenna port for each operation may be configured and operated as “SSB”->“TRS”->“CSI-RS for CSI, CSI-RS for BM, PDCCH DMRS, or PDSCH DMRS”. As such, it is possible to assist the reception operation of the UE by associating statistical characteristics which may be measured from the SSB and the TRS with respective antenna ports.

[PDSCH: In Relation to Frequency Resource Allocation]

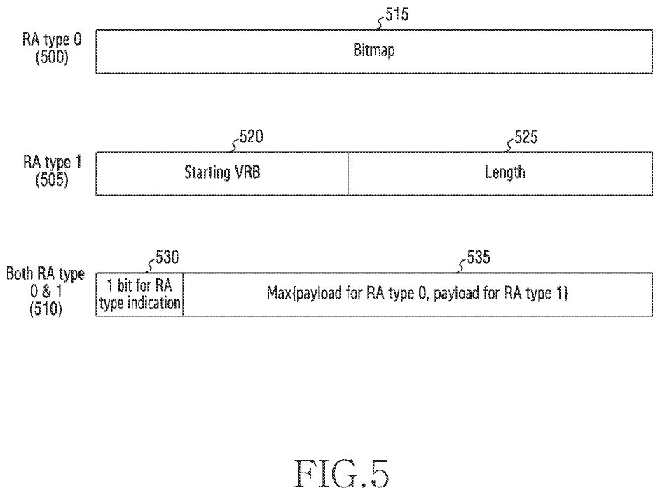

FIG. 5 illustrates a frequency axis resource allocation for a PDSCH in a wireless communication system according to an embodiment.

More specifically, FIG. 5 illustrates three frequency axis resource allocation methods of type 0 500, type 1 505, and dynamic switch 510 which may be configured through a higher layer in an NR wireless communication system.

Referring to FIG. 5, in case that the UE is configured to use only resource type 0 through higher layer signaling (500), some pieces of DCI for allocating the PDSCH to the corresponding UE includes a bitmap of N_RBG bits. In this case, N_RBG is the number of resource block groups (RBGs), and may be determined as shown in Table 15 below according to a BWP size allocated by a BWP indicator and a higher-layer parameter rbg-Size, and data is transmitted to an RBG indicated as 1 by the bitmap.

TABLE 15

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In case that the UE is configured to use only resource type 1 through higher-layer signaling (505), some pieces of DCI for allocating the PDSCH to the corresponding UE have frequency axis resource allocation information including ┌log₂ (N_{RB}^{DL,BWP}(N_{RB}^{DL,BWP}+1)/2┐ bits. The BS may configure a starting virtual resources block (VRB) 520 and a length 525 of frequency axis resources allocated sequentially therefrom.

In case that the UE is configured to use both resource type 0 and resource type 1 through higher layer signaling (510), some pieces of DCI for allocating the PDSCH to the corresponding UE include frequency axis resource allocation information of bits of a larger value 535 among payload 515 for configuring resource type 0 and payload 520 and 525 for configuring resource type 1. Here, one bit 530 may be added to the first part (e.g., a most significant bit (MSB)) of the frequency axis resource allocation information within the DCI, and the use of resource type 0 may be indicated when the corresponding bit 530 is “0” and the use of resource type 1 may be indicated when the corresponding bit 530 is “1”.

[PDSCH/PUSCH: In Relation to Time Resource Allocation]

A TDRA method for a data channel in a next-generation mobile communication system (e.g., a 5G or NR system) is described below.

ABS may configure, for a UE, through higher layer signaling (e.g., RRC signaling), a table for TDRA information on a DL data channel (e.g., a PDSCH) and a UL data channel (e.g., a PUSCH). A table including up to 16 entries (maxNrofDL-Allocations=16) may be configured for the PDSCH, and a table including up to 16 entries (maxNrofUL-Allocations=16) may be configured for the PUSCH.

In an embodiment, the TDRA information may include a PDCCH-to-PDSCH slot timing (corresponding to a time interval in units of slots between a time point at which a PDCCH is received and a time point at which a PDSCH scheduled by the received PDCCH is transmitted, and denoted as K0), a PDCCH-to-PUSCH slot timing (corresponding to a time interval in units of slots between a time point at which a PDCCH is received and a time point at which a PUSCH scheduled by the received PDCCH is transmitted, and denoted as K2), and information on a position and length of a start symbol in which the PDSCH or PUSCH is scheduled within a slot, a mapping type of the PDSCH, PUSCH, or the like. For example, information shown in Table 16 or 17 below may be transmitted from the BS to the UE.

TABLE 16
PDSCH-TimeDomainResourceAllocation List information element

PDSCH-TimeDomainResource AllocationList ::= SEQUENCE
(SIZE(1..maxNrofDL-Allocations)) OF PDSCH-TimeDomainResourceAllocation

| | |
|---|---|
| PDSCH-TimeDomainResource Allocation ::= | SEQUENCE { |

| | |
|---|---|
| k0 | INTEGER(0..32) |

OPTIONAL, -- Need S
(PDCCH-to-PDSCH timing, slot units)

| | |
|---|---|
| mappingType | ENUMERATED {typeA, typeB}, |

(PDSCH mapping type)

| | |
|---|---|
| startSymbolAndLength | INTEGER (0..127) |

(Start symbol and length of PDSCH)
}

TABLE 17
PUSCH-TimeDomainResourceAllocation information element

PUSCH-TimeDomainResource AllocationList ::= SEQUENCE
(SIZE(1..maxNrofUL-Allocations)) OF PUSCH-TimeDomainResource Allocation

| | |
|---|---|
| PUSCH-TimeDomainResource Allocation ::= | SEQUENCE { |

| | |
|---|---|
| k2 | INTEGER(0..32) |

OPTIONAL, -- Need S
e

| | |
|---|---|
| mappingType | ENUMERATED {typeA, typeB}, |

(PUSCH mapping type)

| | |
|---|---|
| startSymbolAndLength | INTEGER (0..127) |

(Start symbol and length of PUSCH)
}

The BS may notify of one among the entries in the tables for the TDRA information to the UE through L1 signaling (e.g., DCI) (e.g., the entry may be indicated by a “time domain resource allocation” field in the DCI). The UE may acquire the TDRA information for the PDSCH or PUSCH, based on the DCI received from the BS.

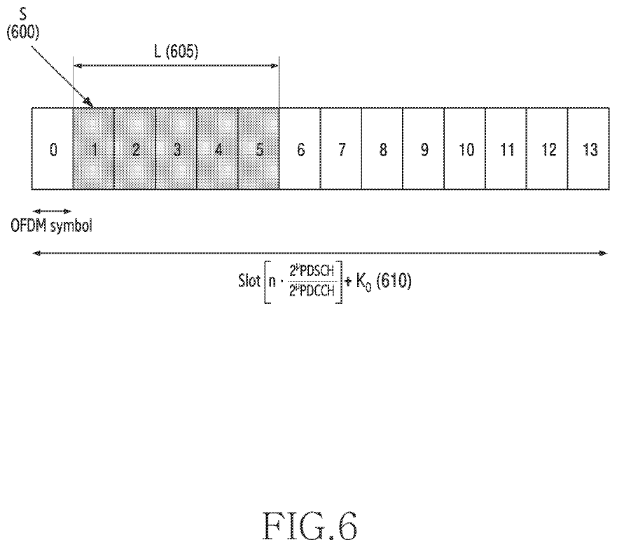

FIG. 6 illustrates a time axis resource allocation for a PDSCH in a wireless communication system according to an embodiment.

Referring to FIG. 6, the BS may indicate a time axis location of PDSCH resources according to SCS (μ_{PDSCH}, μ_{PDCCH}) of a data channel and a control channel configured using a higher layer, a scheduling offset (K0) value, and an OFDM symbol start location 600 and length 605 within one slot dynamically indicated through DCI.

[PDSCH: TCI State Activation MAC-CE]

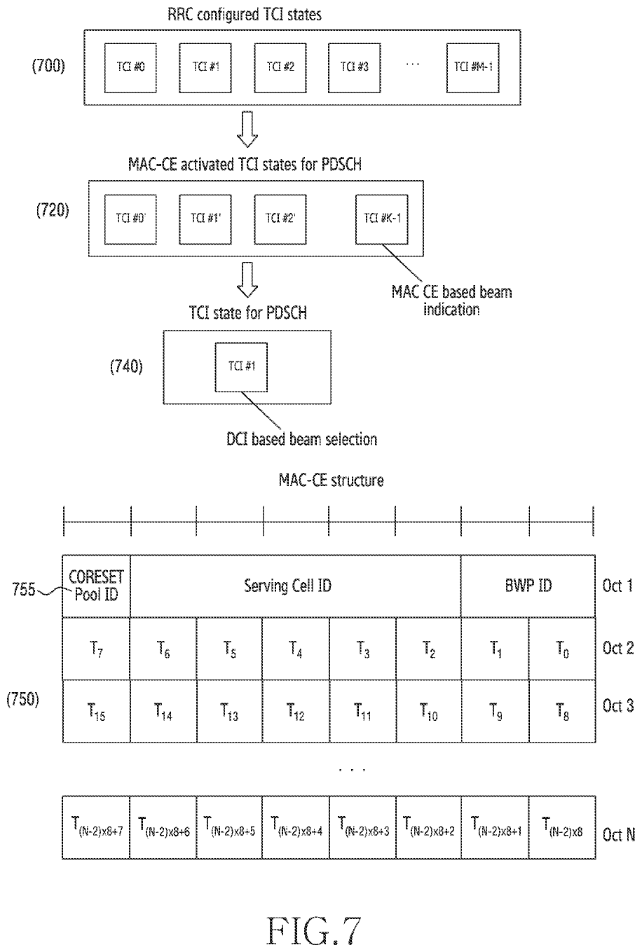

FIG. 7 illustrates a procedure for beam configuration and activation of a PDSCH according to an embodiment.

Referring to FIG. 7, a list of TCI states for a PDSCH may be indicated through a higher layer list such as RRC (700). The list of TCI states may be indicated by, e.g., tci-StatesToAddModList and/or tci-StatesToReleaseList in PDSCH-Config IE for each BWP. Apart of the list of the TCI states may be activated through the MAC-CE (720). A TCI state for a PDSCH among the TCI states activated through the MAC-CE may be indicated through DCI (740). The maximum number of TCI states to be activated may be determined according to the capability reported by the UE. Reference numeral 750 illustrates an example of a MAC-CE structure for PDSCH TCI state activation/deactivation.

The meaning of each field in the MAC CE and values configurable for each field may be defined as shown in Table 18 below.

TABLE 18

| | |
|---|---|
| - | Serving Cell ID: This field indicates the identity of the Serving Cell for which the MAC |
| | CE applies. The length of the field is 5 bits. If the indicated Serving Cell is configured |
| | as part of a simultaneousTCI-UpdateList1 or simultaneousTCI-UpdateList2 as |
| | specified in TS 38.331 [5], this MAC CE applies to all the Serving Cells configured in |
| | the set simultaneousTCI-UpdateList1 or simultaneousTCI-UpdateList2, respectively; |
| - | BWP ID: This field indicates a DL BWP for which the MAC CE applies as the |
| | codepoint of the DCI bandwidth part indicator field as specified in TS 38.212 [9]. The |
| | length of the BWP ID field is 2 bits. This field is ignored if this MAC CE applies to a |
| | set of Serving Cells; |
| - | Tᵢ: If there is a TCI state with TCI-StateId i as specified in TS 38.331 [5], this field |
| | indicates the activation/deactivation status of the TCI state with TCI-StateId i, otherwise |
| | MAC entity shall ignore the Ti field. The Ti field is set to 1 to indicate that the TCI state |
| | with TCI-Stateld i shall be activated and mapped to the codepoint of the DCI |
| | Transmission Configuration Indication field, as specified in TS 38.214 [7]. The Ti field |
| | is set to 0 to indicate that the TCI state with TCI-Stateld i shall be deactivated and is |
| | not mapped to the codepoint of the DCI Transmission Configuration Indication field. |
| | The codepoint to which the TCI State is mapped is determined by its ordinal position |
| | among all the TCI States with Ti field set to 1, i.e. the first TCI State with Tᵢ field set to |
| | 1 shall be mapped to the codepoint value 0, second TCI State with Ti field set to 1 shall |
| | be mapped to the codepoint value 1 and so on. The maximum number of activated TCI |
| | states is 8; |
| - | CORESET Pool ID: This field indicates that mapping between the activated TCI states |
| | and the codepoint of the DCI Transmission Configuration Indication set by field Ti is |
| | specific to the ControlResourceSetId configured with CORESET Pool ID as specified |
| | in TS 38.331 [5]. This field set to 1 indicates that this MAC CE shall be applied for the |
| | DL transmission scheduled by CORESET with the CORESET pool ID equal to 1, |
| | otherwise, this MAC CE shall be applied for the DL transmission scheduled by |
| | CORESET pool ID equal to 0. If the coresetPoolIndex is not configured for any |
| | CORESET, MAC entity shall ignore the CORESET Pool ID field in this MAC CE when |
| | receiving the MAC CE. If the Serving Cell in the MAC CE is configured in a cell list |
| | that contains more than one Serving Cell, the CORESET Pool ID field shall be ignored |
| | when receiving the MAC CE. |

[PUCCH: In Relation to Transmission]

A UE in an NR system may transmit control information (i.e., UL control information (UCI)) to a BS through a PUCCH. The control information may include at least one of hybrid automatic repeat request (HARD) information, i.e., an acknowledgement (ACK) or negative ACK (NACK), indicating whether or not demodulation/decoding is successful for a transport block (TB) received by the UE through the PDSCH, a scheduling request (SR) in which the UE requests resource allocation to the PUSCH BS for UL data transmission, or CSI, which is information for reporting the channel state of the UE.

PUCCH resources may be largely divided into long PUCCH and short PUCCH according to the length of the allocated symbol. In an NR system, a long PUCCH has a length of 4 symbols or more in a slot, and a short PUCCH has a length of 2 symbols or less in a slot.

The long PUCCH may be used for improving UL cell coverage, and thus, may be transmitted in a single-carrier discrete Fourier transform (DFT)-spread (S)-OFDM scheme rather than OFDM transmission. The long PUCCH supports transport formats such as PUCCH format 1, PUCCH format 3, and PUCCH format 4 according to the number of supportable control information bits and whether UE multiplexing is supported through pre-DFT orthogonal cover code (OCC) support at an inverse fast Fourier transform (IFFT) front end.

A PUCCH format 1 is a DFT-S-OFDM-based long PUCCH format capable of supporting up to 2 bits of control information, and uses a frequency resource of 1 RB. Control information may include a combination or each of HARQ-ACK and SR. In PUCCH format 1, an OFDM symbol including a DMRS, and an OFDM symbol including UCI are repeatedly configured.

When the number of transmission symbols of PUCCH format 1 is 8 symbols, the symbols may include a DMRS symbol, a UCI symbol, a DMRS symbol, a UCI symbol, a DMRS symbol, a UCI symbol, a DMRS symbol, and a UCI symbol in order from the first start symbol of the 8 symbols. The DMRS symbol is spread using an orthogonal code (or orthogonal sequence or spreading code, wᵢ(m)) on the time axis in a sequence corresponding to a length of 1 RB on the frequency axis within one OFDM symbol, and may be transmitted after performing IFFT.

The UCI symbol may be transmitted after the UE binary phase shift keying (BPSK)-modulates 1-bit control information and quadrature phase shift keying (QPSK)-modulates 2-bit control information to generate d(0), scrambles by multiplying the generated d(0) by a sequence corresponding to the length of 1 RB on the frequency axis, spreads the scrambled sequence by using an orthogonal code (or orthogonal sequence or spreading code, wᵢ(m)) on the time axis, and performs IFFT.

The UE generates a sequence based on the group hopping or sequence hopping configuration and the configured ID configured through the higher layer signaling from the BS, and generates a sequence corresponding to a length of 1 RB by cyclic shifting a sequence generated with an initial cyclic shift (CS) value configured as an upper signal.

Here, wᵢ(m) is determined as

$${w}_{i} ( m ) = {e}^{\frac{j 2 πϕ ( m )}{{N}_{SF}}}$$

when the length (e.g., N_{SF}) of the spreading code is given, and is specifically given as shown on Table 19 below. In addition, i refers to the index of the spreading code itself, and m refers to the index of elements of the spreading code. The numbers in [ ] in Table 19 refer to φ(m) and when, e.g., the length of the spreading code is 2 and the index of the configured spreading code 1=0, the spreading code wᵢ(m) becomes wᵢ(0)=e^{j2π·0/N}^{_{SF}}=1 and wᵢ(1)=e^{j2x·0/N}^{_{SF}}=1, and thus wᵢ(m)=[1 1].

TABLE 19
Spreading code for PUCCH format 1 wᵢ(m) = e^{j2πφ(m)/N}^{_{SF}}

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

The PUCCH format 3 is a DFT-S-OFDM-based long PUCCH format capable of supporting more than 2 bits of control information, and the number of RBs used can be configured through a higher layer. The control information may be configured by each of or a combination of HARQ-ACK, SR, and CSI. In the PUCCH format 3, the location of the DMRS symbol is presented in Table 20, depending on whether frequency hopping is enabled within the slot and whether additional DMRS symbols are configured.

TABLE 20

| | DMRS location in PUCCH format 3/4 transmission | | | |
|---|---|---|---|---|
| | Additional DMRS is not | | | |
| | configured | | Additional DMRS is configured | |
| | Frequency | Frequency | Frequency | Frequency |
| PUCCH format 3/4 | hopping is not | hopping is | hopping is not | hopping is |
| transmission length | configured | configured | configured | configured |
| 4 | 1 | 0.2 | 1 | 0.2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, when the number of transmission symbols of PUCCH format 3 is 8, the 8 symbols have the first start symbol of 0, and the DMRS is transmitted in first and fifth symbols. Table 20 may be applied to the DMRS symbol location of PUCCH format 4 in the same manner.

PUCCH format 4 is a DFT-S-OFDM-based long PUCCH format which may support control information larger than 2 bits and uses frequency resources of 1 RB. Control information may include a combination or each of HARQ-ACK, SR, and CSI. A difference between PUCCH format 4 and PUCCH format 3 is that PUCCH format 4 of multiple UEs may be multiplexed in one RB in the case of PUCCH format 4. PUCCH format 4 of multiple UEs may be multiplexed through the application of pre-DFT OCC to control information at the IFFT front end. However, the number of control information symbols transmittable by the UE is reduced according to the number of multiplexed UEs. The number of UEs which may be multiplexed, i.e., the number of different available OCCs may be 2 or 4, and the number of OCCs and applicable OCC indexes may be configured through a higher layer.

The short PUCCH may be transmitted through both a DL-centric slot and a UL-centric slot and may generally be transmitted through the last symbol of the slot or an OFDM symbol in the back (e.g., a last OFDM symbol, a second-to-last OFDM symbol, or a last two OFDM symbols). Of course, the short PUCCH may be transmitted at a random location within the slot. The short PUCCH may be transmitted using one OFDM symbol or two OFDM symbols. The short PUCCH may be used to reduce a delay time compared to the long PUCCH in the state in which the UL cell coverage is good, and may be transmitted in a CP-OFDM scheme.

The short PUCCH may support transmission formats such as PUCCH format 0 and PUCCH format 2 according to the number of supportable control information bits.

The PUCCH format 0 has a short PUCCH format which may support control information up to 2 bits and uses frequency resources of 1 RB. Control information may include a combination or each of HARQ-ACK and SR. The PUCCH format 0 has a structure in which no DMRS is transmitted and only a sequence mapped to 12 subcarriers in the frequency axis within one OFDM symbol is transmitted. The UE generates a sequence based on the group hopping or sequence hopping configuration and the configured ID configured through the higher layer signaling from the BS, performs CS on the generated sequence by a final CS value obtained by adding different CS values to an indicated initial CS value according to ACK or NACK, maps the sequence to 12 subcarriers, and performs transmission.

For example, when HARQ-ACK is 1 bit as shown in Table 21 below, the final CS is generated by adding 6 to the initial CS value in the case of ACK and the final CS is generated by adding 0 to the initial CS in the case of NACK. Here, 0 corresponding to the CS value for NACK and 6 corresponding to the CS value for ACK are defined in the standard, and the UE always generates PUCCH format 0 according to the value defined in the standard and transmit 1-bit HARQ-ACK.

TABLE 21

| 1 bit HARQ-ACK | NACK | ACK |
|---|---|---|
| Final CS | (Initial CS + 0) mod 12 = | (Initial CS + 6) mod 12 |
| | Initial CS | |

For example, when HARQ-ACK is 2 bits, the UE adds 0 to the initial CS value in the case of (NACK, NACK), 3 to the initial CS value in the case of (NACK, ACK), and 6 to the initial CS value in the case of (ACK, ACK), and 9 to the initial CS value in the case of (ACK, NACK) as shown in Table 22 below. Here, 0 corresponding to the CS value for (NACK, NACK), 3 corresponding to the CS value for (NACK, ACK), 6 corresponding to the CS value for (ACK, ACK), and 9 corresponding to the CS value for (ACK, ACK) are defined in the standard, and the UE may generate PUCCH format 0 according to the value defined in the standard and transmit 2-bit HARQ-ACK. In case that the final CS value is larger than 12 by the CS value added to the initial CS value according to ACK or NACK, the sequence has a length of 12 and thus modulo 12 may be applied to the final CS value.

TABLE 22

| 2 bit | | | | |
|---|---|---|---|---|
| HARQ-ACK | NACK, NACK | NACK, ACK | ACK, ACK | ACK, NACK |
| Final CS | (Initial CS + 0) mod | (Initial CS + 3) | (Initial CS + 6) | (Initial CS + 9) |
| | 12 = Initial CS | mod 12 | mod 12 | mod 12 |

The PUCCH format 2 has a short PUCCH format supporting control information larger than 2 bits, and the number of used RBs may be configured through a higher layer. Control information may include a combination or each of HARQ-ACK, SR, and CSI. When an index of a first subcarrier is #0, the location of subcarriers for transmitting the DMRS within one OFDM symbol may be fixed to subcarriers having indexes #1, #4, #7, and #10. The control information may be mapped to the remaining subcarriers except for the subcarriers in which the DMRS is located after a channel coding and modulation process.

The configurable values and ranges for each of the above-described PUCCH formats may be summarized as shown in Table 23 below. In Table 23 below, a case in which there is no need to configure a value is indicated by N.A.

TABLE 23

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurability | ✓ | ✓ | ✓ | ✓ | ✓ |
| | Value range | 0-13 | 0-10 | 0-13 | 0-10 | 0-10 |
| Number of | Configurability | ✓ | ✓ | ✓ | ✓ | ✓ |
| symbols in a slot | Value range | 1, 2 | 4-14 | 1, 2 | 4-14 | 4-14 |
| Index for | Configurability | ✓ | ✓ | ✓ | ✓ | ✓ |
| identifying | Value range | 0-274 | 0-274 | 0-274 | 0-274 | 0-274 |
| starting PRB | | | | | | |
| Number of PRBs | Configurability | N.A. | N.A. | ✓ | ✓ | N.A. |
| | Value range | N.A. | N.A. | 1-16 | 1-6, 8-10, | N.A. |
| | | (Default is 1) | (Default is 1) | | 12, 15, 16 | (Defaul is 1) |
| Enabling frequency | Configurability | ✓ | ✓ | ✓ | ✓ | ✓ |
| hopping (intra-slot) | Value range | On/Off (only | On/Off | On/Off (only | On/Off | On/Off |
| | | for 2 symbol) | | for 2 symbol) | | |
| Freq cy resource | Configurability | ✓ | ✓ | ✓ | ✓ | ✓ |
| of 2^{nd} hop if | Value range | 0-274 | 0-274 | 0-274 | 0-274 | 0-274 |
| Intra-slot | | | | | | |
| frequency | | | | | | |
| hopping is | | | | | | |
| enabled | | | | | | |
| Index of initial | Configurability | ✓ | ✓ | N.A. | N.A. | N.A. |
| cyclic shift | Valute range | 0-11 | 0-11 | N.A. | N.A. | N.A. |
| Index of | Configurability | N.A. | ✓ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | ✓ |
| Pre-DFT OCC | Value range | N.A. | N.A. | N.A. | N.A. | 2, 4 |
| Index of Pre-DFT | Configurability | N.A. | N.A. | N.A. | N.A. | ✓ |
| OCC | Value range | N.A. | N.A. | N.A. | N.A. | 0, 1, 2, 3 |

In order to improve the UL coverage, multi-slot repetition may be supported for PUCCH formats 1, 3, and 4, and the PUCCH repetition may be configured for each PUCCH format. The UE may perform repetitive transmission for the PUCCH including UCI as many as the number of slots configured through nrofSlots, which is higher layer signaling. For PUCCH repetitive transmission, PUCCH transmission of each slot, may be performed using the same number of consecutive symbols, and the number of corresponding consecutive symbols may be configured through nrofSymbols in PUCCH-format1, PUCCH-format3 or PUCCH-format4, which is higher layer signaling. For PUCCH repetitive transmission, PUCCH transmission of each slot may be performed using the same start symbol, and corresponding start symbol may be configured through startingSymbolIndex in PUCCH-format 1, PUCCH-format 3, or PUCCH-format 4, which is higher-layer signaling. For PUCCH repetitive transmission, a single PUCCH-spatialRelationInfo may be configured for a single PUCCH resource. For PUCCH repetitive transmission, if the UE is configured to perform frequency hopping in PUCCH transmission in different slots, the UE may perform frequency hopping in units of slots. In addition, if the UE is configured to perform frequency hopping in PUCCH transmission in different slots, in the even-numbered slot, the UE may start PUCCH transmission from a first physical RB (PRB) index configured through startingPRB, which is higher layer signaling, and in the odd-numbered slot, the UE may start PUCCH transmission from the second PRB index configured through secondHopPRB, which is higher layer signaling. Additionally, if the UE is configured to perform frequency hopping in PUCCH transmission in different slots, an index of a slot for first PUCCH transmission indicated to the UE is 0, and the number of PUCCH repetitive transmissions may be increased regardless of PUCCH transmission performed in each slot during all of the configured

PUCCH repetitive transmissions. If the UE is configured to perform frequency hopping in PUCCH transmission in different slots, the UE does not expect that frequency hopping in the slot is configured during PUCCH transmission. If the UE is not configured to perform frequency hopping in PUCCH transmission in different slots and is configured to perform frequency hopping in a slot, the first and second PRB indexes may be equally applied within the slot. If the number of UL symbols capable of PUCCH transmission is smaller than nrofSymbols configured for higher layer signaling, the UE may not transmit PUCCH. If the UE fails to transmit PUCCH for any reason in a certain slot during PUCCH repetitive transmission, the UE may increase the number of PUCCH repetitive transmissions.

[PUCCH: PUCCH Resource Configuration]

A BS may configure PUCCH resources for each BWP through a higher layer for a specific UE. A PUCCH resource configuration may be as shown as in Table 24 below.

TABLE 24

| | |
|---|---|
| PUCCH-Config ::= | SEQUENCE { |
| resourceSetToAddModList | SEQUENCE (SIZE |
| (1..maxNrofPUCCH-ResourceSets)) OF PUCCH-ResourceSet | OPTIONAL, -- Need N |
| resourceSetToReleaseList | SEQUENCE (SIZE (1..maxNrofPUCCH- |

ResourceSets)) OF PUCCH-ResourceSetId OPTIONAL, -- Need N

| | |
|---|---|
| resourceToAddModList | SEQUENCE (SIZE |
| (1..maxNrofPUCCH-Resources)) OF PUCCH-Resource | OPTIONAL, -- Need N |
| resourceToReleaseList | SEQUENCE (SIZE (1..maxNrofPUCCH- |
| Resources)) OF PUCCH-ResourceId | OPTIONAL, -- Need N |
| format1 | SetupRelease { PUCCH-FormatConfig } |

OPTIONAL, -- Need M

| | |
|---|---|
| format2 | SetupRelease { PUCCH-FormatConfig } |

OPTIONAL, -- Need M

| | |
|---|---|
| format3 | SetupRelease { PUCCH-FormatConfig } |

OPTIONAL, -- Need M

| | |
|---|---|
| format4 | SetupRelease { PUCCH-FormatConfig } |

OPTIONAL, -- Need M

| | |
|---|---|
| schedulingRequestResourceToAddModList | SEQUENCE (SIZE (1..maxNrofSR- |

Resources)) OF SchedulingRequestResourceConfig
OPTIONAL, -- Need N

| | |
|---|---|
| schedulingRequestResourceToReleaseList | SEQUENCE (SIZE (1..maxNrofSR- |

Resources)) OF SchedulingRequestResourceId
OPTIONAL, -- Need N

| | |
|---|---|
| multi-CSI-PUCCH-ResourceList | SEQUENCE (SIZE (1..2)) OF PUCCH- |

ResourceId OPTIONAL, -- Need M

| | |
|---|---|
| dl-DataToUL-ACK | SEQUENCE (SIZE (1..8)) OF INTEGER (0..15) |

OPTIONAL, -- Need M

| | |
|---|---|
| spatialRelationInfoToAddModList | SEQUENCE (SIZE |

(1..maxNrofSpatialRelationInfos)) OF PUCCH-SpatialRelationInfo
OPTIONAL, -- Need N

| | |
|---|---|
| spatialRelationInfoToReleaseList | SEQUENCE (SIZE |

(1..maxNrofSpatialRelationInfos)) OF PUCCH-SpatialRelationInfoId
OPTIONAL, -- Need N

| | |
|---|---|
| pucch-PowerControl | PUCCH-PowerControl |

```
OPTIONAL, -- Need M
  ...,
  [[
```

| | |
|---|---|
| resourceToAddModListExt-r16 | SEQUENCE (SIZE (1..maxNrofPUCCH- |
| Resources)) OF PUCCH-ResourceExt-r16 | OPTIONAL, -- Need N |
| dl-DataToUL-ACK-r16 | SetupRelease { DL-DataToUL-ACK-r16 } |

OPTIONAL, -- Need M

| | |
|---|---|
| ul-AccessConfigListDCI-1-1-r16 | SetupRelease { UL-AccessConfigListDCI-1-1-r16 } |

OPTIONAL, -- Need M

| | |
|---|---|
| subslotLengthForPUCCH-r16 | CHOICE { |
| normalCP-r16 | ENUMERATED {n2,n7}, |
| extendedCP-r16 | ENUMERATED {n2,n6} |

}
OPTIONAL, -- Need R

| | |
|---|---|
| dl-DataToUL-ACK-DCI-1-2-r16 | SetupRelease { DL-DataToUL-ACK-DCI-1-2-r16} |

OPTIONAL, -- Need M

| | |
|---|---|
| numberOfBitsForPUCCH-ResourceIndicatorDCI-1-2-r16 | INTEGER (0..3) |

OPTIONAL, -- Need R

| | |
|---|---|
| dmrs-UplinkTransformPrecodingPUCCH-r16 | ENUMERATED {enabled} |

OPTIONAL, -- Cond PI2-BPSK

| | |
|---|---|
| spatialRelationInfoToAddModListSizeExt-v1610 | SEQUENCE (SIZE |

(1..maxNrofSpatialRelationInfosDiff-r16)) OF PUCCH-SpatialRelationInfo
OPTIONAL, -- Need N

| | |
|---|---|
| spatialRelationInfoToReleaseListSizeExt-v1610 | SEQUENCE (SIZE |

(1..maxNrofSpatialRelationInfosDiff-r16)) OF PUCCH-SpatialRelationInfoId
OPTIONAL, -- Need N

| | |
|---|---|
| spatialRelationInfoToAddModListExt-v1610 | SEQUENCE (SIZE |

(1..maxNrofSpatialRelationInfos-r16)) OF PUCCH-SpatialRelationInfoExt-r16
OPTIONAL, -- Need N

| | |
|---|---|
| spatialRelationInfoToReleaseListExt-v1610 | SEQUENCE (SIZE |

(1..maxNrofSpatialRelationInfos-r16)) OF PUCCH-SpatialRelationInfoId-r16
OPTIONAL, -- Need N

| | |
|---|---|
| resourceGroupToAddModList-r16 | SEQUENCE (SIZE |

(1..maxNrofPUCCH-ResourceGroups-r16)) OF PUCCH-ResourceGroup-r16
OPTIONAL, -- Need N

| | |
|---|---|
| resourceGroupToReleaseList-r16 | SEQUENCE (SIZE (1..maxNrofPUCCH- |

ResourceGroups-r16)) OF PUCCH-ResourceGroupId-r16
OPTIONAL, -- Need N

| | |
|---|---|
| sps-PUCCH-AN-List-r16 | SetupRelease { SPS-PUCCH-AN-List-r16 } |

OPTIONAL, -- Need M

| | |
|---|---|
| schedulingRequestResourceToAddModListExt-v1610 | SEQUENCE (SIZE |

(1..maxNrofSR-Resources)) OF SchedulingRequestResourceConfigExt-v1610
OPTIONAL -- Need N
]]
}

According to Table 24, one or multiple PUCCH resource sets in the PUCCH resource configuration for a specific BWP may be configured, and a maximum payload value for UCI transmission may be configured in some of the PUCCH resource sets. One or multiple PUCCH resources may belong to each PUCCH resource set, and each PUCCH resource may belong to one of the above-described PUCCH formats.

For the PUCCH resource set, the first PUCCH resource set may have a fixed maximum payload value of 2 bits. Accordingly, the corresponding value may not be separately configured through a higher layer or the like. When the remaining PUCCH resource sets are configured, the index of the corresponding PUCCH resource set may be configured in ascending order according to the maximum payload value, and no maximum payload value may be configured in the last PUCCH resource set.

A higher-layer configuration for the PUCCH resource set may be as shown as in Table 25 below.

TABLE 25

| | |
|---|---|
| PUCCH-ResourceSet ::= | SEQUENCE { |
| pucch-ResourceSetId | PUCCH-ResourceSetId, |
| resourceList | SEQUENCE (SIZE (1..maxNrofPUCCH- |

ResourcesPerSet)) OF PUCCH-ResourceId,

| | |
|---|---|
| maxPayloadSize | INTEGER (4..256) |

OPTIONAL -- Need R
}

The resourceList parameter of Table 25 may include IDs of PUCCH resources belonging to the PUCCH resource set.

In initial access or when no PUCCH resource set is configured, a PUCCH resource set as shown in Table 26 below, including multiple cell-specific PUCCH resources, may be used in the initial BWP. The PUCCH resource to be used for initial access in this PUCCH resource set may be indicated through SIB1.

TABLE 26

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

The maximum payload of each PUCCH resource included in the PUCCH resource set may be 2 bits in the case of PUCCH format 0 or 1, and in the case of the remaining formats, it may be determined by the symbol length, the number of PRBs, and the maximum code rate. The symbol length and the number of PRBs may be configured for each PUCCH resource, and the maximum code rate may be configured for each PUCCH format.

In the case of SR transmission, a PUCCH resource for an SR corresponding to a schedulingRequestID may be configured through a higher layer as shown in Table 27 below. The PUCCH resource may be a resource belonging to PUCCH format 0 or PUCCH format 1.

TABLE 27

| SchedulingRequestResourceConfig ::= | SEQUENCE { |
|---|---|
| schedulingRequestResourceId | SchedulingRequestResourceId, |
| schedulingRequestID | SchedulingRequestId, |
| periodicityAndOffset | CHOICE { |
| sym2 | NULL, |
| sym6or7 | NULL, |
| sl1 | NULL, |
| -- Recurs in every slot | |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |
| } | |
| OPTIONAL, -- Need M | |
| resource | PUCCH-ResourceId |

OPTIONAL -- Need M
}

A transmission period and an offset of the configured PUCCH resource may be configured through a parameter periodicityAndOffset in Table 27. When there is UL data to be transmitted by the UE at a time point corresponding to the configured period and offset, the corresponding PUCCH resource may be transmitted, and otherwise, the corresponding PUCCH resource may not be transmitted.

In the case of CSI transmission, PUCCH resources to transmit a periodic or semi-persistent CSI report through the PUCCH may be configured in a parameter pucch-CSI-ResourceList as shown in [Table 28] below. The parameter pucch-CSI-ResourceList includes a list of the PUCCH resource for each BWP for a cell or a CC to transmit the corresponding CSI report. The PUCCH resource may be a resource belonging to PUCCH format 2, PUCCH format 3, or PUCCH format 4. The transmission period and the offset of the PUCCH resource may be configured through reportSlotConfig in Table 28.

TABLE 28

| CSI-ReportConfig ::= | SEQUENCE { |
|---|---|
| reportConfigId | CSI-ReportConfigId, |
| carrier | ServCellIndex |
| OPTIONAL, -- Need S | |
| ... | |
| reportConfigType | CHOICE { |
| periodic | SEQUENCE { |
| reportSlotConfig | CSI- |
| ReportPeriodicityAndOffset, | |
| pucch-CSI-ResourceList | SEQUENCE (SIZE |
| (1..maxNrofBWPs)) OF PUCCH-CSI-Resource | |
| }, | |
| semiPersistentOnPUCCH | SEQUENCE { |
| reportSlotConfig | CSI- |
| ReportPeriodicityAndOffset, | |
| pucch-CSI-ResourceList | SEQUENCE (SIZE |
| (1..maxNrofBWPs)) OF PUCCH-CSI-Resource | |
| }, | |
| semiPersistentOnPUSCH | SEQUENCE { |
| reportSlotConfig | ENUMERATED {sl5, sl10, |
| sl20, sl40, sl80, sl160, sl320}, | |
| reportSlotOffsetList | SEQUENCE (SIZE (1.. maxNrofUL- |
| Allocations)) OF INTEGER(0..32), | |
| p0alpha | P0-PUSCH-AlphaSetId |
| }, | |
| aperiodic | SEQUENCE { |
| reportSlotOffsetList | SEQUENCE (SIZE (1..maxNrofUL- |

```
Allocations)) OF INTEGER(0..32)
    }
  },
  ...
}
```

In the case of HARQ-ACK transmission, a resource set of the PUCCH resource to be transmitted may be first selected according to a payload of UCI including the corresponding HARQ-ACK. That is, a PUCCH resource set having a minimum payload which is not smaller than the UCI payload may be selected. Subsequently, a PUCCH resource within the PUCCH resource set may be selected through a PUCCH resource indicator (PM) within DCI scheduling a TB corresponding to the corresponding HARQ-ACK, and the PRI may be a PRI as shown in Table 6 or 7. The relation between the PRI and the PUCCH resource selected from the PUCCH resource set may be as shown as in Table 29 below.

TABLE 29

| PUCCH | |
|---|---|
| resource | |
| indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUOCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

If the number of PUCCH resources within the selected PUCCH resource set is larger than 8, a PUCCH resource may be selected using Equation (1) below.

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + {Δ}_{PRI} \cdot \\ ⌈ \frac{{R}_{PUCCH}}{8} ⌉ if {Δ}_{PRI} < {R}_{PUCCH} mod 8\end{matrix} \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8 if {Δ}_{PRI} \geq {R}_{PUCCH} mod 8\end{matrix}\end{matrix} \} \qquad ( 1 )$$

In Equation 1, r_{PUCCH} denotes an index of a PUCCH resource selected within a PUCCH resource set, R_{PUCCH} denotes the number of PUCCH resources belonging to the PUCCH resource set, Δ_{PRI} denotes a PRI value, N_{CCE,p} denotes the total number of CCEs of a CORESET p to which received DCI belongs, and n_{CCE,p} denotes a first CCE index for received DCI.

A time point at which the corresponding PUCCH resource is transmitted is after K₁ slots from TB transmission corresponding to the corresponding HARQ-ACK. Candidates for a value of K₁ may be configured through a higher layer and, more specifically, may be configured in a parameter dl-DataToUL-ACK within PUCCH-Config as shown in Table 27.

Among the candidates, one value of K₁ may be selected by a PDSCH-to-HARQ feedback timing indicator within DCI scheduling a TB, and the value may be a value as shown in Table 5 or 6. The value of K₁ may have a slot or a subslot unit. The subslot is a unit having a length smaller than that of the slot, and one or multiple symbols may correspond to one subslot.

The UE may transmit UCI through one or two PUCCH resources within one slot or subslot, and when UCI is transmitted through two PUCCH resources within one slot/sub slot, i) each PUCH resource may not overlap in units of symbols and ii) at least one PUCCH resource may be short PUCCHs. The UE may not expect transmission of a plurality of PUCCH resources for HARQ-ACK transmission within one slot.

[PUCCH: In Relation to Transmission Beam]

If a UE does not have a UE-specific configuration (i.e., a dedicated PUCCH resource configuration) for the PUCCH resource configuration, the PUCCH resource set may be provided through higher layer signaling, e.g., pucch-ResourceCommon, and in this case, a beam configuration for PUCCH transmission follows a beam configuration used in PUSCH transmission scheduled through an RAR UL grant.

If the UE has a UE-specific configuration (i.e., a dedicated PUCCH resource configuration) for PUCCH resource configuration, a beam configuration for PUCCH transmission may be provided through pucch-spatialRelationInfoId, which is higher signaling as illustrated in Table 24. If the UE receives a configuration of one pucch-spatialRelationInfoId, the beam configuration for PUCCH transmission of the UE may be provided through one pucch-spatialRelationInfoId. If the UE receives a configuration of multiple pucch-spatialRelationInfoID, the UE may receive an indication of activation for one of the multiple pucch-spatialRelationInfoID through a MAC CE. The UE may receive a configuration of a maximum of eight pucch-spatialRelationInfoID through higher-layer signaling and receive an indication of activation for only one pucch-spatialRelationInfoID. When the UE receives an indication of activation for pucch-spatialRelationInfoID through the MAC CE, the UE may apply activation of pucch-spatialRelationInfoID through the MAC CE, starting at a first slot after 3Nₛₗₒₜ^{subframe,μ} slots from a slot for HARQ-ACK transmission for a PDSCH through which the MAC CE including activation information of pucch-spatialRelationInfoID is transmitted. Here, μ is numerology applied to PUCCH transmission, and Nₛₗₒₜ^{subframe,μ} is the number of slots per subframe in the given numerology.

A higher-layer configuration for pucch-spatialRelationInfo may be as shown as in Table 30 below.

TABLE 30

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex |

OPTIONAL, -- Need S

| | |
|---|---|
| referenceSignal | CHOICE { |
| ssb-Index | SSB-Index, |
| csi-RS-Index | NZP-CSI-RS-ResourceId, |
| srs | PUCCH-SRS |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

| | |
|---|---|
| PUCCH-SpatialRelationInfoId ::= | INTEGER (1..maxNrofSpatialRelationInfos) |

According to Table 30, one referenceSignal configuration may exist within a specific pucch-spatialRelationInfo configuration, and the corresponding referenceSignal may be ssb-Index indicating a specific SS/PBCH, csi-RS-Index indicating a specific CSI-RS, or srs indicating a specific SRS. If referenceSignal is configured as ssb-Index, the UE may configure, as the beam for PUCCH transmission, a beam used for reception of an SS/PBCH corresponding to ssb-Index among the SS/PBCHs within the same serving cell or, if servingCellId is provided, configure, as the beam for pucch transmission a beam used for reception of an SS/PBCH corresponding to ssb-Index among the SS/PBCHs within a cell indicated by servingCellId.

If referenceSignal is configured as csi-RS-Index, the UE may configure, as the beam for PUCCH transmission, a beam used for reception of a CSI-RS corresponding to csi-RS-Index among the CSI-RSs within the same serving cell or, if servingCellId is provided, configure, as the beam for pucch transmission, a beam used for reception of a CSI-RS corresponding to csi-RS-Index among the CSI-RSs within a cell indicated by servingCellId.

If referenceSignal is configured as srs, the UE may configure, as the beam for PUCCH transmission, a transmission beam used for transmission of an SRS corresponding to a resource index provided through a higher-layer signaling resource within the same serving cell and/or an activated UL BWP or, if servingCellID and/or ULBWP is provided, configure, as the beam for PUCCH transmission, a transmission beam used for transmission of an SRS corresponding to a resource index provided through a higher-layer signaling resource within a cell indicated by servingCellID and/or ULBWP and/or an UL BWP. Within a specific pucch-spatialRelationInfo configuration, one pucch-PathlossReferenceRS-Id configuration may exist. PUCCH-PathlossReferenceRS in Table 31 may be mapped to pucch-PathlossReferenceRS-Id of Table 30, and a maximum of four PUCCH-PathlossReferenceRS may be configured through pathlossReferenceRSs within higher-layer signaling PUCCH-PowerControl in Table 30. The ssb-Index is configured when PUCCH-PathlossReferenceRS is connected to the SS/PBCH through higher-layer signaling referenceSignal in Table 30, and csi-RS-Index may be configured when PUCCH-PathlossReferenceRS is connected to the CSI-RS.

TABLE 31

| | |
|---|---|
| PUCCH-PowerControl ::= | SEQUENCE { |
| deltaF-PUCCH-f0 | INTEGER (−16..15) |

OPTIONAL, -- Need R

| | |
|---|---|
| deltaF-PUCCH-f1 | INTEGER (−16..15) |

OPTIONAL, -- Need R

| | |
|---|---|
| deltaF-PUCCH-f2 | INTEGER (−16..15) |

OPTIONAL, -- Need R

| | |
|---|---|
| deltaF-PUCCH-f3 | INTEGER (−16..15) |

OPTIONAL, -- Need R

| | |
|---|---|
| deltaF-PUCCH-f4 | INTEGER (−16..15) |

OPTIONAL, -- Need R

| | |
|---|---|
| p0-Set | SEQUENCE (SIZE (1..maxNrofPUCCH-P0- |
| PerSet)) OF P0-PUCCH | OPTIONAL, -- Need M |
| pathlossReferenceRSs | SEQUENCE (SIZE (1..maxNrofPUCCH- |

PathlossReferenceRSs)) OF PUCCH-PathlossReferenceRS
OPTIONAL, -- Need M

| | |
|---|---|
| twoPUCCH-PC-AdjustmentStates | ENUMERATED {twoStates} |

```
OPTIONAL, -- Need S
  ...,
  [[
```

| | |
|---|---|
| pathlossReferenceRSs-v1610 | SetupRelease { PathlossReferenceRSs-v1610 } |

OPTIONAL -- Need M
]]
}

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |
| PathlossReferenceRSs-v1610 ::= | SEQUENCE (SIZE (1..maxNrofPUCCH- |

PathlossReferenceRSsDiff-r16)) OF PUCCH-PathlossReferenceRS-r16

| | |
|---|---|
| PUCCH-PathlossReferenceRS ::= | SEQUENCE { |
| pucch-PathlossReferenceRS-Id | PUCCH-PathlossReferenceRS-Id, |
| referenceSignal | CHOICE { |
| ssb-Index | SSB-Index, |
| csi-RS-Index | NZP-CSI-RS-ResourceId |

}
}

| | |
|---|---|
| PUCCH-PathlossReferenceRS-r16 ::= | SEQUENCE { |
| pucch-PathlossReferenceRS-Id-r16 | PUCCH- |

PathlossReferenceRS-Id-v1610,

| | |
|---|---|
| referenceSignal-r16 | CHOICE { |
| ssb-Index-r16 | SSB-Index, |
| csi-RS-Index-r16 | NZP-CSI-RS- |

ResourceId
}
}

[PUCCH: In Relation to Group-Based Spatial Relation Activation]

When a UE receives a configuration of multiple pucch-spatialRelationInfoID in Rel-15, a spatial relation of the corresponding PUCCH resource may be determined by receiving a MAC CE for activating spatial relations for each PUCCH resource. However, such method is disadvantageous in that large signaling overhead is required for activation of the spatial relation of multiple PUCCH resources. Therefore, Rel-16 has adopted a new MAC CE for addition of a PUCCH resource group and relation activation in units of PUCCH resource group. For the PUCCH resource groups, up to 4 PUCCH resource groups may be configured through resourceGroupToAddModList of Table 24, and for each PUCCH resource group, multiple PUCCH resource IDs in one PUCCH resource group may be configured as a list as shown in Table 32 below.

TABLE 32

| PUCCH-ResourceGroup-r16 ::= | SEQUENCE { |
|---|---|
| pucch-ResourceGroupId-r16 | PUCCH-ResourceGroupId-r16, |
| resourcePerGroupList-r16 | SEQUENCE (SIZE |
| (1..maxNrofPUCCH-ResourcesPerGroup-r16)) OF PUCCH-ResourceId | |
| } | |
| PUCCH-ResourceGroupId-r16 ::= | INTEGER (0..maxNrofPUCCH- |

ResourceGroups-1-r16)

In Rel-16, the BS may configure each PUCCH resource group for the UE through resourceGroupToAddModList in Table 24 and the higher layer configuration of Table 32, and may configure a MAC CE for simultaneous activation of spatial relations of all PUCCH resources in one PUCCH resource group.

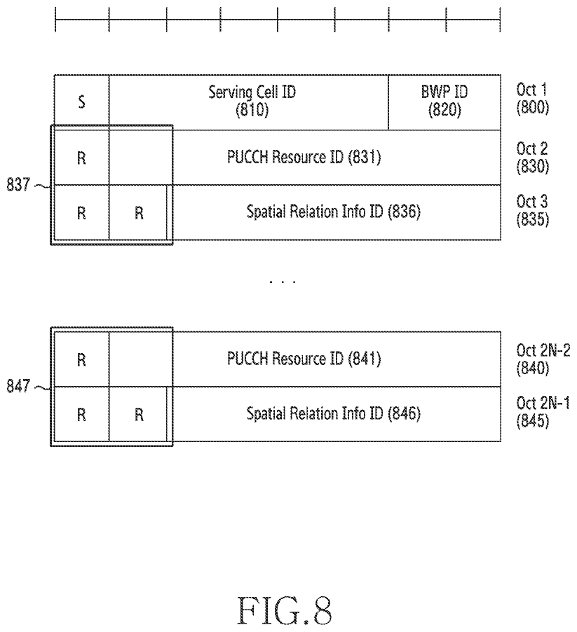

FIG. 8 illustrates a MAC CE for PUCCH resource group-based spatial relation activation in a wireless communication system according to an embodiment.

Referring to FIG. 8, a supported cell ID 810 and a BWP ID 820 configured with PUCCH resources, to which the corresponding MAC CE is to be applied, are indicated by Oct 1 800. PUCCH Resource IDs 831 and 841 indicate IDs of PUCCH resources, and if the indicated PUCCH resources are included in a PUCCH resource group according to resourceGroupToAddModList, another PUCCH resource ID in the same PUCCH resource group is not indicated in the same MAC CE, and all PUCCH resources in the same PUCCH resource group are activated with the same Spatial Relation Info IDs 836 and 846. Here, Spatial Relation Info IDs 836 and 846 include a value corresponding to PUCCH-SpatialRelationInfold−1 to be applied to the PUCCH resource group of Table 30.

[In Relation to SRS]

A BS may configure at least one SRS configuration for each UL BWP to transfer configuration information for SRS transmission to the UE, and may also configure at least one SRS resource set for each SRS configuration. For example, the BS and the UE may transmit and receive higher signaling information, e.g., as follows, to transfer information on the SRS resource set.
srs-ResourceSetId: an SRS resource set index
srs-ResourceldList: a set of SRS resource indexes referenced by an SRS resource set
resourceType: a time axis transmission configuration of an SRS resource referenced by an SRS resource set, wherein resourceType may be configured to be one of “periodic”, “semi-persistent”, and “aperiodic”. If resourceType is configured to be “periodic” or “semi-persistent”, associated CSI-RS information may be provided according to a usage of the SRS resource set. If resourceType is configured to be “aperiodic”, an aperiodic SRS resource trigger list and slot offset information may be provided, and associated CSI-RS information may be provided according to a usage of the SRS resource set.
usage: a configuration for a usage of an SRS resource referenced by an SRS resource set, wherein the usage may be configured to be one of “beamManagement”, “codebook”, “nonCodebook”, and “antennaSwitching”.
alpha, p0, pathlossReferenceRS, srs-PowerControlAdjustmentStates: providing parameter configurations for transmission power adjustment of an SRS resource referenced by an SRS resource set.

The UE may understand that an SRS resource included in a set of SRS resource indexes referenced by an SRS resource set follows information included in the SRS resource set.

In addition, the BS and the UE may transmit or receive higher layer signaling information in order to transfer individual configuration information for the SRS resource. For example, the individual configuration information for the SRS resource may include time-frequency axis mapping information within a slot of the SRS resource, which may include information on frequency hopping within a slot or between slots of the SRS resource. In addition, the individual configuration information for the SRS resource may include a time axis transmission configuration of the SRS resource, and may be configured to be one of “periodic”, “semi-persistent”, and “aperiodic”. This may be limited to having the time axis transmission configuration, such as the SRS resource set including the SRS resource. If the time axis transmission configuration of the SRS resource is configured to be “periodic” or “semi-persistent”, an SRS resource transmission period and slot offset (e.g., periodicityAndOffset) may be additionally included in the time axis transmission configuration.

The BS may activate, deactivate, or trigger an SRS transmission to the UE through L1 signaling (e.g., DCI) or higher layer signaling including MAC CE signaling or RRC signaling. For example, the BS may activate or deactivate periodic SRS transmission for the UE through higher layer signaling. The BS may indicate to activate an SRS resource set in which resourceType is configured to be periodic through higher layer signaling, and the UE may transmit an SRS resource referenced by the activated SRS resource set. Time-frequency axis resource mapping within a slot of the transmitted SRS resource follows resource mapping information configured in the SRS resource, and slot mapping including a transmission period and a slot offset follows periodicityAndOffset configured in the SRS resource. Furthermore, a spatial domain transmission filter applied to the transmitted SRS resource may refer to spatial relation info configured in the SRS resource, or may refer to associated CSI-RS information configured in the SRS resource set including the SRS resource. The UE may transmit the SRS resource in an UL BWP activated for the periodic SRS resource activated through higher layer signaling.

The BS may activate or deactivate semi-persistent SRS transmission for the UE through higher layer signaling. The BS may indicate to activate an SRS resource set through MAC CE signaling, and the UE may transmit an SRS resource referenced by the activated SRS resource set. The SRS resource set activated through MAC CE signaling may be limited to the SRS resource set in which resourceType is configured to be semi-persistent. Time-frequency axis resource mapping within a slot of the transmitted SRS resource follows resource mapping information configured in the SRS resource, and slot mapping including a transmission period and a slot offset follows to periodicityAndOffset configured in the SRS resource. Furthermore, a spatial domain transmission filter applied to the transmitted SRS resource may refer to spatial relation info configured in the SRS resource, or may refer to associated CSI-RS information configured in the SRS resource set including the SRS resource. If spatial relation info is configured in the SRS resource, instead of following same, the spatial domain transmission filter may be determined by referring to configuration information on spatial relation info transferred through MAC CE signaling for activation of semi-persistent SRS transmission. The UE may transmit the SRS resource in a UL BWP activated for the semi-persistent SRS resource activated through higher layer signaling.

For example, the BS may trigger aperiodic SRS transmission to the UE through DCI. The BS may indicate one of aperiodic SRS resource triggers (aperiodicSRS-ResourceTrigger) through an SRS request field of the DCI. The UE may understand that an SRS resource set has been triggered, the SRS resource set including an aperiodic SRS resource trigger indicated through the DCI in an aperiodic SRS resource trigger list in configuration information of the SRS resource set. The UE may transmit an SRS resource referenced by the triggered SRS resource set. Time-frequency axis resource mapping within a slot of the transmitted SRS resource follows resource mapping information configured in the SRS resource. In addition, slot mapping of the transmitted SRS resource may be determined through a slot offset between a PDCCH including the DCI and the SRS resource, which may refer to a value (or values) included in a slot offset set configured in the SRS resource set. Specifically, the slot offset between the PDCCH including the DCI and the SRS resource, a value indicated by a time domain resource assignment field of the DCI from among offset value(s) included in the slot offset set configured in the SRS resource set may be applied. Furthermore, a spatial domain transmission filter applied to the transmitted SRS resource may refer to spatial relation info configured in the SRS resource, or may refer to associated CSI-RS information configured in the SRS resource set including the SRS resource. The UE may transmit the SRS resource in an UL BWP activated for the aperiodic SRS resource triggered through the DCI.

In case that the BS triggers aperiodic SRS transmission to the UE through the DCI, in order for the UE to transmit an SRS by applying configuration information for the SRS resource, a minimum time interval between a PDCCH including the DCI triggering aperiodic SRS transmission and the transmitted SRS may be required. A time interval for SRS transmission of the UE may be defined to be the number of symbols between the last symbol of the PDCCH including the DCI triggering aperiodic SRS transmission and the first symbol to which a first transmitted SRS resource among the transmitted SRS resource(s) is mapped. The minimum time interval may be determined by referring to a PUSCH preparation procedure time required for the UE to prepare for PUSCH transmission. In addition, the minimum time interval may have a different value depending on a usage of the SRS resource set including the transmitted SRS resource. For example, the minimum time interval may be determined to be N2 symbols defined in consideration of UE processing capability according to the capability of the UE by referring to the PUSCH preparation procedure time of the UE. In addition, if the usage of the SRS resource set is configured to be “codebook” or “antennaSwitching” in consideration of the usage of the SRS resource set including the transmitted SRS resource, the minimum time interval may be determined to be N2 symbols, and if the usage of the SRS resource set is configured to be “nonCodebook” or “beamManagement”, the minimum time interval may be determined to be N2+14 symbols. If the time interval for aperiodic SRS transmission is greater than or equal to the minimum time interval, the UE may transmit an aperiodic SRS, and if the time interval for aperiodic SRS transmission is less than the minimum time interval, the UE may ignore the DCI triggering an aperiodic SRS.

TABLE 33

| SRS-Resource ::= | SEQUENCE { |
|---|---|
| srs-ResourceId | SRS-ResourceId, |
| nrofSRS-Ports | ENUMERATED {port1, ports2, |
| ports4}, | |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, |
| n4}, | |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, |
| groupHopping, sequenceHopping }, | |
| resourceType | CHOICE { |
| aperiodic | SEQUENCE { |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE { |
| periodicityAndOffset-p | SRS- |
| PeriodicityAndOffset, | |
| ... | |
| } | |
| }, | |
| sequenceId | INTEGER (0..1023), |
| spatialRelationInfo | SRS-SpatialRelationInfo |

OPTIONAL, -- Need R
...
}

The spatialRelationInfo configuration information in Table 33 above refers to one reference signal and applies beam information of the reference signal to a beam used for corresponding SRS transmission. The configuration of spatialRelationInfo may include information as shown in Table 34 below.

TABLE 34

| SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, an SS/PBCH block index, a CSI-RS index, or an SRS index may be configured as an index of a reference signal to be referenced in order to use beam information of a specific reference signal. Higher signaling referenceSignal is configuration information indicating beam information of which reference signal is to be referenced for corresponding SRS transmission, ssb-Index refers to an SS/PBCH block index, csi-RS-Index refers to a CSI-RS index, and srs refers to an SRS index. If a value of higher signaling referenceSignal is configured to be “ssb-Index”, the UE may apply, as a transmission beam of the SRS transmission, a reception beam used when receiving an SS/PBCH block corresponding to ssb-Index. If the value of higher signaling referenceSignal is configured to be “csi-RS-Index”, the UE may apply, as a transmission beam of the SRS transmission, a reception beam used when receiving a CSI-RS corresponding to csi-RS-Index. If the value of higher signaling referenceSignal is configured to be “srs”, the UE may apply, as a transmission beam of the SRS transmission, a transmission beam used when transmitting an SRS corresponding to srs.

[PUSCH: In Relation to Transmission Scheme]

PUSCH transmission may be dynamically scheduled by a UL grant in DCI, or may be operated by configured grant Type 1 or Type 2. The indication of the dynamic scheduling for the PUSCH transmission may be by DCI format 0_0 or 0_1.

Configured grant Type 1 PUSCH transmission may be semi-statically configured through reception of configuredGrantConfig including rrc-ConfiguredUplinkGrant in Table 35 through higher signaling, without reception of the UL grant in the DCI. Configured grant Type 2 PUSCH transmission may be semi-persistently scheduled by the UL grant in the DCI after the reception of configuredGrantConfig not including rrc-ConfiguredUplinkGrant in Table 35, through higher signaling. When the PUSCH transmission is operated by a configured grant, parameters to be applied to the PUSCH transmission are applied through higher signaling configuredGrantConfig in Table 38, except dataScramblingIdentityPUSCH, txConfig, codebookSub set, maxRank, and scaling of UCI-OnPUSCH provided through higher signaling pusch-Config in Table 36. When the UE is provided with transformPrecoder in higher signaling configuredGrantConfig in Table 35, the UE applies tp-pi2BP2K in pusch-Config in Table 36 for the PUSCH transmission operated by the configured grant.

TABLE 35

| | |
|---|---|
| ConfiguredGrantConfig ::= | SEQUENCE |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, |

sym4x14, sym5x14, sym8x14, sym10x14, sym16x14, sym20x14,

sym32x14, sym40x14, sym64x14,

sym80x14, sym128x14, sym 160x14, sym256x14, sym320x14, sym512x14,

sym640x14, sym1024x14,

sym1280x14, sym2560x14, sym5120x14,

sym6, sym1x12, sym2x12,

sym4x12, sym5x12, sym8x12, sym10x12, sym16x12, sym20x12, sym32x12,

sym40x12, sym64x12, sym80x12,

sym128x12, sym 160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

```
PathlossReferenceRSs−1),
    ...
  }
OPTIONAL, -- Need R
  ...
}
```

A DMRS antenna port for PUSCH transmission is identical to an antenna port for SRS transmission. The PUSCH transmission may follow a codebook-based transmission method or a non-codebook-based transmission method according to whether a value of txConfig in higher signaling pusch-Config in Table 36 is “codebook” or “nonCodebook”.

As described above, the PUSCH transmission may be dynamically scheduled through DCI format 0_0 or 0_1, and may be semi-statically configured by the configured grant. If the scheduling for the PUSCH transmission is indicated to the UE through DCI format 0_0, the UE may perform beam configuration for PUSCH transmission by using pucch-spatialRelationInfoID corresponding to a UE-specific PUCCH resource corresponding to a minimum ID in an activated

UL BWP in a serving cell, wherein the PUSCH transmission is based on a single antenna port. The UE does not expect scheduling for PUSCH transmission through DCI format 0_0 in a BWP in which a PUCCH resource including pucch-spatialRelationInfo is not configured. If txConfig in pusch-Config in Table 36 is not configured for the UE, the UE does not expect to be scheduled by DCI format 0_1.

TABLE 36

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, |
| nonCodebook} | OPTIONAL, -- Need S |
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER |

(1.. maxNrofPhysicalResourceBlocks−1)
OPTIONAL, -- Need M

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, |
| qam64LowSE} | OPTIONAL, -- Need S |
| mcs-TableTransformPrecoder | ENUMERATED {qam256, |
| qam64LowSE} | OPTIONAL, -- Need S |
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}

| | |
|---|---|
| OPTIONAL, -- Cond codebookBased | INTEGER (1..4) |

maxRank

| | |
|---|---|
| OPTIONAL, -- Cond codebookBased | ENUMERATED { config2} |

rbg-Size

| | |
|---|---|
| OPTIONAL, -- Need S | SetupRelease { UCI-OnPUSCH} |

uci-OnPUSCH

| | |
|---|---|
| OPTIONAL, -- Need M | ENUMERATED {enabled} |

```
  tp-pi2BPSK
OPTIONAL, -- Need S
  ...
}
```

A codebook-based PUSCH transmission may be dynamically scheduled by DCI format 0_0 or 0_1, and may be semi-statically operated by the configured grant. When the codebook-based PUSCH is dynamically scheduled by DCI format 0_1 or semi-statically configured by the configured grant, the UE may determine a precoder for PUSCH transmission, based on an SRS resource indicator (SRI), a transmission precoding matrix indicator (TPMI), and a transmission rank (i.e., the number of PUSCH transmission layers).

The SRI may be given through an SRI field in the DCI, or may be configured through higher signaling srs-ResourceIndicator. When the codebook-based PUSCH transmission is performed, at least one SRS resource is configured for the UE, and maximum two SRS resources may be configured. When the SRI is provided to the UE through the DCI, the SRS resource indicated by the corresponding SRI refers to an SRS resource corresponding to the SRI, among SRS resources transmitted earlier than a PDCCH including the corresponding SRI. In addition, the TPMI and the transmission rank may be given through a precoding information and number of layers field in the DCI, or may be configured through higher signaling precodingAndNumberOfLayers. The TPMI is used to indicate a precoder applied to the PUSCH transmission. When one SRS resource is configured for the UE, the TPMI is used to indicate a precoder to be applied to the one configured SRS resource. When multiple SRS resources are configured for the UE, the TPMI is used to indicate a precoder to be applied to an SRS resource indicated through the SRI.

The precoder to be used for the PUSCH transmission is selected from an UL codebook having the number of antenna ports, which is identical to a nrorSRS-Ports value in the higher signaling SRS-ConFIG. In the codebook-based PUSCH transmission, the UE determines a codebook subset, based on the TPMI and codebookSubset in the higher signaling pusch-ConFIG. The codebookSubset in the higher signaling pusch-Config may be configured as one of “′fullyAndPartialAndNonCoherent”, “partialAndNonCoherent”, or “nonCoherent”, based on the UE capability reported to the BS by the UE. If the UE has reported “partialAndNonCoherent” as UE capability, the UE does not expect that a value of the higher singling codebookSubset is to be configured as “fullyAndPartialAndNonCoherent”. In addition, when the UE has reported “nonCoherent” as UE capability, the UE does not expect that a value of the higher signaling codebookSubset is to be configured as “fullyAndPartialAndNonCoherent” or “partialAndNonCoherent”. When nrofSRS-Ports in the higher signaling SRS-ResourceSet indicates two SRS antenna ports, the UE does not expect that a value of the higher signaling codebookSubset is to be configured as “partialAndNonCoherent”.

One SRS resource set having the usage value configured as “codebook” within the higher signaling SRS-ResourceSet, may be configured for the UE, and one SRS resource in the corresponding SRS resource set may be indicated through the SRI. When there are several SRS resources configured in the SRS resource set having the usage value configured as “codebook” within the higher signaling SRS-ResourceSet, the UE expects that, as the value of nrofSRS-Ports in the higher signaling SRS-Resource, the same value is to be configured for all SRS resources.

The UE transmits one or multiple SRS resources included in the SRS resource set having the usage value configured as “codebook” according to the higher signaling, and the BS selects one of the SRS resources transmitted by the UE, and indicates the UE to perform PUSCH transmission, by using transmission beam information of the corresponding SRS resource. In this case, in the codebook-based PUSCH transmission, the SRI is used as information for selecting an index of the SRS resource, and is included in the DCI. Additionally, the BS includes information indicating the rank and the TPMI to be used when the UE performs PUSCH transmission, in the DCI. The UE performs the PUSCH transmission by applying a precoder indicated by the rank and the TPMI indicated based on the transmission beam of the corresponding SRS resource, by using the SRS resource indicated by the SRI.

A non-codebook-based PUSCH transmission may be dynamically scheduled through DCI format 0_0 or 0_1, and may be semi-statically operated by the configured grant. When at least one SRS resource is configured in the SRS resource set having the usage value configured as “nonCodebook” within the higher signaling SRS-ResourceSet, the non-codebook-based PUSCH transmission may be scheduled to the UE through DCI format 0_1.

For the SRS resource set having the usage value configured as “nonCodebook” within the higher signaling SRS-ResourceSet, one connected NZP CSI-RS resource may be configured for the UE. The UE may calculate a precoder for SRS transmission through measurement for an NZP CSI-RS resource connected to the SRS resource set. When the interval between the last reception symbol of the aperiodic NZP CSI-RS resource connected to the SRS resource set and the first symbol of the aperiodic SRS transmission has a value greater than 42, the UE does not expect that information on the precoder for the SRS transmission is to be updated.

When the value of resourceType in the higher-layer signaling SRS-ResourceSet is configured as “aperiodic”, the connected NZP CSI-RS is indicated by an SRS request corresponding to a field in DCI format 0_1 or 1_1. In this case, when the connected NZP CSI-RS resource corresponds to an aperiodic NZP CSI-RS resource, it is indicated that the connected NZP CSI-RS exists for a case where a value of the SRS request field in DCI format 0_1 or 1_1 does not correspond to “00”. In this case, the corresponding DCI should not indicate cross-carrier or cross-BWP scheduling. In addition, when the value of the SRS request indicates the existence of the NZP CSI-RS, the corresponding NZP CSI-RS is positioned in a slot in which a PDCCH including the SRS request field is transmitted. In this case, TCI states configured for the scheduled subcarrier are not configured as QCL-TypeD.

When the periodic or semi-persistent SRS resource set is configured, the connected NZP CSI-RS may be indicated through associatedCSI-RS in the higher signaling SRS-ResourceSet. For the non-codebook-based transmission, the UE does not expect that higher signaling spatialRelationInfo for the SRS resource and the associatedCSI-RS in the higher signaling SRS-ResourceSet are configured together.

When multiple SRS resources are configured for the UE, the UE may determine the transmission rank and the precoder to be applied for the PUSCH transmission, based on the SRI indicated by the BS. In this case, the SRI may be indicated through an SRI field in the DCI, or may be configured through higher signaling srs-ResourceIndicator. Similar to the above-described codebook-based PUSCH transmission, when the SRI is provided to the UE through the DCI, the SRS resource indicated by the corresponding SRI may mean an SRS resource corresponding to the SRI, among the SRS resources transmitted earlier than the PDCCH including the corresponding SRI. The UE may use one or multiple SRS resources for the SRS transmission, and the maximum number of SRS resources and the maximum number of SRS resources which may be simultaneously transmitted in the same symbol within one SRS resource set are determined by UE capability reported to the BS. In this case, the SRS resources simultaneously transmitted by the UE occupy the same RB. The UE configures one SRS port for each SRS resource. Only one SRS resource set having the usage value being configured as “nonCodebook” within the higher-layer signaling SRS-ResourceSet may be configured, and maximum four SRS resources for non-codebook-based PUSCH transmission may be configured.

The BS transmits one NZP-CSI-RS connected to the SRS resource set to the UE, and the UE calculates a precoder to be used during transmission of one or multiple SRS resources in the corresponding SRS resource set, based on the result of measurement during reception of the corresponding NZP-CSI-RS. The UE applies the calculated precoder when transmitting, to the BS, one or multiple SRS resources in the SRS resource set having the usage configured as “nonCodebook”, and the BS selects one or multiple SRS resources from among the received one or multiple SRS resources. In this case, the SRI in the non-codebook-based PUSCH transmission indicates an index which may represent one or a combination of multiple SRS resources, and the SRI is included in the DCI. Here, the number of SRS resources indicated by the SRI transmitted by the BS may correspond to the number of transmission layers of the PUSCH, and the UE applies the precoder, applied to the SRS resource transmission, to each layer to transmit the PUSCH.

[PUSCH: Preparation Procedure Time]

When the BS performs scheduling so that the UE transmits the PUSCH, by using DCI format 0_0, 0_1, or 0_2, the UE may require a PUSCH preparation procedure time to apply a transmission method (e.g., a transmission precoding method of the SRS resource, the number of transmission layers, and a spatial domain transmission filter) indicated through the DCI and transmit the PUSCH. In NR, the PUSCH preparation procedure time is defined in consideration of the description above. The PUSCH preparation procedure time of the UE may follow Equation (2) below:

T_{proc,2}=max((N₂+d_{2,1}+d₂)(2048+144)κ2^{-μ}T_{c}+Tₑₓₜ+T_{switch},d_{2,2} (2)

In Equation 2:
N₂: indicates a number of symbols determined according to numerology μ and UE processing capability 1 or 2 according to UE capability. When UE processing capability 1 is reported according to UE capability reporting, N1 may have values in Table 37, and when UE processing capability 2 is reported and the availability of UE processing capability 2 is configured through higher-layer signaling, N1 may have values in Table 38.

TABLE 37

| | PUSCH preparation time N₂ |
|---|---|
| μ | [symbols] |
| 0 | 10 |
| 1 | 12 |
| 2 | 23 |
| 3 | 36 |

TABLE 38

| | PUSCH preparation time N₂ |
|---|---|
| μ | [symbols] |
| 0 | 5 |
| 1 | 5.5 |
| 2 | 11 for frequency range 1 |

d_{2,1}: corresponds to the number of symbols, and determined as 0, if REs of the first OFDM symbol of the PUSCH transmission is configured with only DM-RSs. Otherwise, d_{2,1} is determined as 1.
κ:64
μ: This follows a value which makes T_{proc,2} bigger, among μ_{DL} and μ_{DL}. μ_{DL} indicates numerology of a DL through which a PDCCH including DCI for scheduling a PUSCH is transmitted, and μ_{DL} indicates numerology of an UL through which a PUSCH s transmitted.
T_{c}: T_{c} has 1/(Δfₘₐₓ·N_{f}), Δfₘₐₓ=480·10³ Hz, N_{f}=4096.
d_{2,2}: If DCI for scheduling a PUSCH indicates BWP switching, d_{2,2} follows a BWP switching time. Otherwise, d_{2,2} has a value of 0.
d₂: If OFDM symbols of a PUCCH, a PUSCH having a higher priority index, and PUCCH having a lower priority index overlap on the time domain, a d₂ value of the PUSCH having the higher priority index is used. Otherwise, d₂ is 0.
Tₑₓₜ: If the UE uses a shared spectrum channel access scheme, the UE may calculate a value of Tₑₓₜ and apply the same to the PDSCH preparation procedure time. Otherwise, the value of Tₑₓₜ is assumed as 0.
T_{switch}: If an UL switching spacing is triggered, T_{switch} is assumed as a switching spacing time. Otherwise, T_{switch} is assumed as 0.

Considering the time axis resource mapping information of the PUSCH scheduled through the DCI and an UL-DL timing advance effect, the BS and the UE determine that a PUSCH preparation procedure time is not enough if the first symbol of the PUSCH starts earlier than the first UL symbol in which a CP starts after a T_{proc,2} time later from the last symbol of the PDCCH including the DCI which has scheduled the PUSCH. Otherwise, the BS and the UE determine that the PUSCH preparation procedure time is enough.

The UE may transmit the PUSCH only when the PUSCH preparation procedure time is enough, and may ignore the DCI for scheduling the PUSCH when the PUSCH preparation procedure time is not enough.

[PUSCH: In Relation to Repetitive Transmission]

In a 5G system, two types of UL data channel repetitive transmission schemes are supported, i.e., PUSCH repetitive transmission type A and PUSCH repetitive transmission type B. One of PUSCH repetitive transmission type A and PUSCH repetitive transmission type B may be configured for the UE through higher layer signaling.

1. PUSCH repetitive transmission type A
As described above, in one slot, a symbol length of an UL data channel and a position of a start symbol are determined according to a TDRA method, and the BS may notify the UE of the number of repetitive transmissions through higher-layer signaling (e.g., RRC signaling) or L1 signaling (e.g., DCI).
The UE repeatedly transmits, in consecutive slots, a UL data channel having the same length and start symbol as those of the configured UL data channel, based on the number of repetitive transmissions, received from the BS. Here, when a slot configured via a DL for the UE by the BS or at least one of UL data channel symbols configured for the UE is configured via the DL, the UE may omit the UL data channel transmission, but count the number of repetitive UL data channel transmissions.

2. PUSCH repetitive transmission type B
As described above, in one slot, the length and a start symbol of an UL data channel are determined according to the TDRA method, and the BS may notify the UE of the number of repetitive transmissions (numberofrepetitions) through higher signaling (e.g., RRC signaling) or L1 signaling (e.g., DCI).
Nominal repetition of the UL data channel is determined based on the length and the start symbol of the configured UL data channel as follows. A slot in which the n-th nominal repetition starts is given by

$${K}_{s} + ⌊ \frac{s + n \cdot L}{{N}_{s y m b}^{slot}} ⌋ ,$$

and the symbol starts from the slot is given by mod (s+n·L, N_{symb}^{slot}). A slot in which the n-th nominal repetition ends is given by

$${K}_{s} + ⌊ \frac{S + ( n + 1 ) \cdot L - 1}{{N}_{s y m b}^{slot}} ⌋ ,$$

and a symbol ends in the slot is given by mod(s+(n+1)·L−1, N_{symb}^{slot}). Here, n=0, . . . , numberofrepetitions−1, S indicates the start symbol of the configured UL data, and L indicates the symbol length of the configured UL data channel. K s indicates a slot in which PUSCH transmission starts, and N_{symb}^{slot} indicates the number of symbols per slot.
The UE determines an invalid symbol for PUSCH repetitive transmission type B. A symbol configured via DL by tdd-UL-DL-ConfigurationCommon or tdd-UL-DL-ConfigurationDedicated is determined as the invalid symbol for PUSCH repetitive transmission type B. Additionally, the invalid symbol may be configured in a higher-layer parameter (e.g., InvalidSymbolPattern). The higher-layer parameter (e.g., InvalidSymbolPattern) may provide a symbol-level bitmap over one slot or two slots, and the invalid symbol may be configured therein. In the bitmap, 1 indicates the invalid symbol. Additionally, the periodicity and the pattern of the bitmap may be configured through the higher-layer parameter (e.g., periodicityAndPattern). If the higher-layer parameter (e.g., InvalidSymbolPattern) is configured and an InvalidSymbolPatternIndicator-ForDCIFormat0_1 or an InvalidSymbolPatternIndicator-ForDCIFormat0_2 parameter indicates 1, the UE applies an invalid symbol pattern. If the parameter indicates 0, the UE does not apply the invalid symbol pattern. If the higher-layer parameter (e.g., InvalidSymbolPattern) is configured and an InvalidSymbolPatternIndicator-ForDCIFormat0_1 or an InvalidSymbolPatternIndicator-ForDCIFormat0_2 parameter is not configured, the UE applies the invalid symbol pattern.

After the invalid symbol is determined, the UE may consider symbols other than the invalid symbol, as valid symbols, for each nominal repetition. When one or more valid symbols are included in each nominal repetition, the nominal repetition may include one or more actual repetitions. Here, each actual repetition includes consecutive sets of valid symbols usable for PUSCH repetitive transmission type B in one slot.

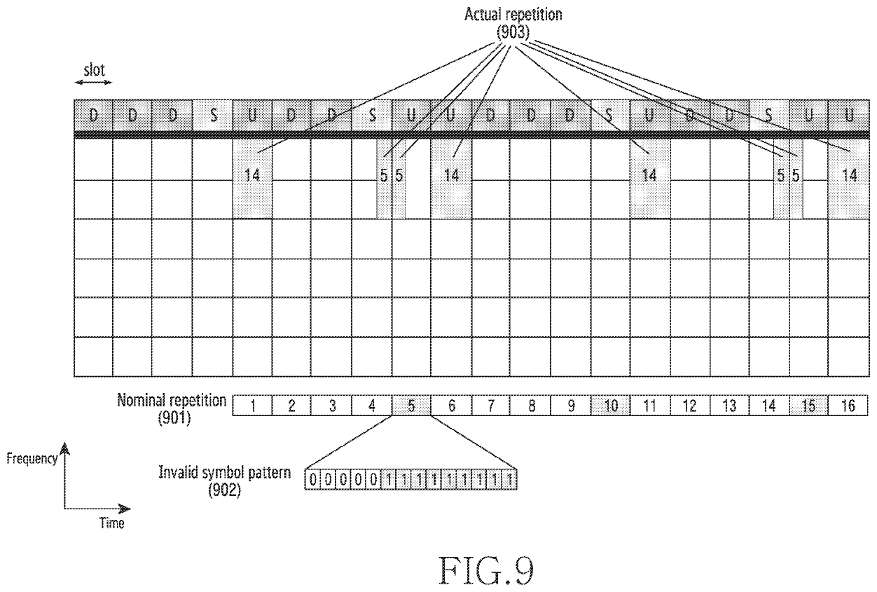

FIG. 9 illustrates a PUSCH repetitive transmission type-B in a wireless communication system according to an embodiment.

Referring to FIG. 9, a UE may receive a configuration of a start symbol S of an UL data channel as 0, a length L of the UL data channel as 14, and the number of repetitive transmissions as 16. In this case, a nominal repetition 901 is indicated in 16 consecutive slots. Thereafter, the UE may determine a symbol configured as a DL symbol in each nominal repetition 901 as an invalid symbol. In addition, the UE determines symbols configured as 1 in an invalid symbol pattern 902, as invalid symbols. When valid symbols, other than invalid symbols, are configured as one or more consecutive symbols in one slot, in each nominal repetition, the valid symbols are configured as actual repetition 903 and transmitted.

In addition, with respect to PUSCH repetitive transmission, in NR Release 16, additional methods below may be defined for UL grant-based PUSCH transmission and configured grant-based PUSCH transmission across a slot boundary.
Method 1 (mini-slot level repetition): Through one UL grant, two or more PUSCH repetitive transmissions are scheduled in one slot or across a slot boundary in consecutive available slots. In addition, in relation to method 1, TDRA information in the DCI indicates a resource of the first repetitive transmission. Furthermore, the time domain resource information of the remaining repetitive transmission may be determined according to the time domain resource information of the first repetitive transmission and the UL or DL direction determined for each symbol of each slot. Each repetitive transmission occupies consecutive symbols.
Method 2 (multi-segment transmission): Through one UL grant, two or more PUSCH repetitive transmissions are scheduled in consecutive slots. In this case, one transmission is designated for each slot, and transmissions may have different start points or different repetition lengths, respectively. In addition, in method 2, the TDRA information in the DCI indicates start points and repetition lengths of all repetitive transmissions. In addition, when the repetitive transmission is performed in a single slot through method 2 and there are several groups of consecutive UL symbols in the corresponding slot, each repetitive transmission is performed for each UL symbol group. If there is only one group of consecutive UL symbols in the corresponding slot, one PUSCH repetitive transmission is performed according to the method in NR Release 15.
Method 3: Through two or more UL grants, two or more PUSCH repetitive transmissions are scheduled in consecutive slots. Here, one transmission is designated for each slot, and the n-th UL grant may perform reception before the PUSCH transmission scheduled by the (n-1)th UL grant ends.
Method 4: Through one UL grant or one configured grant, one or several PUSCH repetitive transmissions may be supported in a single sot, or two or more PUSCH repetitive transmissions may be supported across the boundary of consecutive slots. The number of repetitions, indicated to the UE by the BS, is merely a nominal value, and the number of PUSCH repetitive transmissions actually performed by the UE may be greater than the nominal number of repetitions. The TDRA information in the DCI or the configured grant means a resource of the first repetitive transmission indicated by the BS. The time domain resource information of the remaining repetitive transmission may be determined with reference to the UL or DL direction of symbols and resource information of at least the first repetitive transmission. If the time domain resource information of the repetitive transmission, indicated by the BS, extends over a slot boundary or includes UL/DL transition point, the corresponding repetitive transmission may be divided into multiple repetitive transmissions. In this case, one slot may include one repetitive transmission for each UL period.

[PUSCH: Frequency Hopping Process]

In 5G, as an UL data channel frequency hopping method, two methods are supported for each PUSCH repetitive transmission type. First, in PUSCH repetitive transmission type A, intra-slot frequency hopping and inter-slot frequency hopping are supported, and in PUSCH repetitive transmission type B, inter-repetition frequency hopping and inter-slot frequency hopping are supported.

The intra-slot frequency hopping method supported in PUSCH repetitive transmission type A corresponds to a method in which the UE changes a frequency domain allocation resource by a configured frequency offset in two hops in one slot and performs transmission. In the intra-slot frequency hopping, a start RB of each hop may be represented by Equation (3) below.

$$R {B}_{start} = \{ \begin{matrix}R {B}_{start} & i = 0 \\ ( R {B}_{start} + R {B}_{offset} ) mod {N}_{B W P}^{s i z e} & i = 1\end{matrix} \qquad ( 3 )$$

In Equation (3), i=0 and i=1 indicate the first hop and the second hop, respectively, and RBₛₜₐᵣₜ indicates the start RB in the UL BWP, and is calculated from the frequency resource allocation method. RB_{offset} indicates a frequency offset between two hops through a higher-layer parameter. The number of symbols of the first hop may be represented by └N_{symb}^{PUSCH,s}/2┘, and the number of symbols of the second hop may be represented by N_{symb}^{PUSCH,s}−└N_{symb}^{PUSCH,s}/2┘. N_{symb}^{PUSCH,s} corresponds to the length of PUSCH transmission and is represented by the number of OFDM symbols in one slot.

The inter-slot frequency hopping method supported in PUSCH repetitive transmission types A and B corresponds to a method in which the UE changes a frequency domain allocation resource for each slot by a configured frequency offset and performs transmission. In the inter-slot frequency hopping, a start RB for nₛ^{μ} slots may be represented by Equation (4) below.

$$R {B}_{s t a r t} ( {n}_{s}^{μ} ) = \{ \begin{matrix}R {B}_{s t a r t} & {n}_{s}^{μ} mod 2 = 0 \\ ( R {B}_{s t a r t} + R {B}_{offset} ) mod {N}_{B W P}^{s i z e} & {n}_{s}^{μ} mod 2 = 1\end{matrix} \qquad ( 4 )$$

In Equation (4), nₛ^{μ} represents a current slot number in multi-slot PUSCH transmission, and RBₛₜₐᵣₜ indicates a start RB in the UL BWP and is calculated from the frequency resource allocation method. RB_{offset} presents a frequency offset between two hops through a higher-layer parameter.

The inter-repetition frequency hopping method supported in PUSCH repetitive transmission type B corresponds to a method for moving a frequency domain allocation resource for one or multiple actual repetitions in each nominal repetition by a configured frequency offset and performing transmission. RBₛₜₐᵣₜ(n) corresponding to an index of the start RB on the frequency domain for one or multiple actual repetitions in the n-th nominal repetition may follow Equation (5) below/

$$R {B}_{s t a r t} ( n ) = \{ \begin{matrix}R {B}_{s t a r t} & n mod 2 = 0 \\ ( R {B}_{s t a r t} + R {B}_{offset} ) mod {N}_{B W P}^{s i z e} & n mod 2 = 1\end{matrix} \qquad ( 5 )$$

In Equation (5), n represents an index of nominal repetition, and RB_{offset} indicates an RB offset between two hops through a higher-layer parameter.

[In Relation to PUSCH Transmission Power]

In a 5G system, the transmission power of the UL data channel may be determined using Equation (6) below.

$${P}_{PUSCH , b , f , c} ( i , j , {q}_{d} , l ) = min \{ \begin{matrix}{P}_{CMAX , f , c} ( i ) , \\ \begin{matrix}\begin{matrix}{P}_{O \_ PUSCH , b , f , c} ( j ) + \\ 10 {log}_{10} ( {2}^{μ} \cdot {M}_{RB , b , f , c}^{PUSCH} ( i ) ) +\end{matrix} \\ \begin{matrix}{α}_{b , f , c} ( j ) \cdot {PL}_{b , f , c} ( {q}_{d} ) + \\ {Δ}_{TPb , f , c} ( i ) + {f}_{b , f , c} ( i , l )\end{matrix}\end{matrix}\end{matrix} \} [ dBm ] \qquad ( 6 )$$

In Equation (6), j denotes a grant type of PUSCH. Specifically, j=0 denotes a PUSCH grant for an RAR, j=1 denotes a configured grant, and j∈{2, 3, . . . J−1} denotes dynamic grant. P_{CMAX,f,c}(i) denotes a maximum output power configured in the UE with respect to carrier f of a support cell c for the PUSCH transmission occasion i. P_{O_PUSCHb,f,c} is a parameter configured by the sum of P_{O_NOMINAL_PUSCH,f,c}(j) which is configured through a higher layer parameter, and P_{O_UE_PUSCH,b,f,c}(j), which may be determined through a higher layer configuration and SRI (in the case of dynamic grant PUSCH). M_{RB,b,f,c}^{PUSCH}(i) denotes a bandwidth for resource allocation expressed by the number of resource blocks for PUSCH transmission occasion i, and Δ_{TE,b,f,c}(i) denotes a value determined according to the type of information transmitted through a PUSCH and a modulation and coding scheme (MCS) (e.g., whether or not UL-SCH is included or CSI is included, of the like). α_{b,f,c}(j) is a value for compensating for pathloss and denotes a value that may be determined through the higher layer configuration and SRI (in the case of dynamic grant PUSCH). PL_{b,f,c}(q_{d}) denotes a DL path loss estimation value, which is estimated by the UE through a reference signal having the reference signal index q_{d}, and the reference signal index q_{d} may be determined by the UE through higher layer configuration and SRI (in the case of dynamic grant PUSCH or ConfiguredGrantConfig-based configured grant PUSCH (type 2 configured grant PUSCH) that does not include higher layer configuration rrc-ConfiguredUplinkGrant) or through higher layer configuration. f_{b,f,c}(i,l) is a closed loop power adjustment value and may be supported by an accumulation method and an absolute method. If the higher layer parameter tpc-Accumulation is not configured in the UE, the closed-loop power adjustment value may be determined using the accumulation method. Here, f_{b,f,c}(i,l) is determined by

$${f}_{b , f , c} ( i - {i}_{0} , I ) + {\sum }_{m = 0}^{c ( {D}_{i} ) - 1} {δ}_{PUSCH , b , f , c} ( m , l ) ,$$

which is a sum obtained by adding TPC command values for closed-loop index 1 received through DCI between K_{PUSCH}(i-i₀)−1 symbol for transmitting PUSCH transmission occasion i-i0 and K_{PUSCH}(i) symbol for transmitting PUSCH transmission occasion i to the closed-loop power adjustment value for the previous PUSCH transmission occasion i-i0. If the higher layer parameter tpc-Accumulation is configured in the UE, f_{b,f,c}(i,l) is determined to be the TPC command value δ_{PUSCHb,f,c}(i,l) for the closed loop index 1 received through DCI. The closed loop index 1 may be configured to be the value of 0 or 1 if the higher layer parameter twoPUSCH-PC-AdjustementStates is configured in the UE, and the value may be determined through the higher layer configuration and SRI (in the case of dynamic grant PUSCH). The mapping relationship between the TPC command field and the TPC value δ_{PUSCH,b,f,c} in DCI according to the accumulation method and the absolute method may be defined as shown in Table 39 below.

TABLE 39

| | Accumulated | Absolute |
|---|---|---|
| | δ_{PUSCH, b, f, c} | δ_{PUSCH, b, f, c} |
| TPC command | [dB] | [dB] |
| 0 | −1 | −4 |
| 1 | 0 | −1 |
| 2 | 1 | 1 |
| 3 | 3 | 4 |

[In Relation to UL PTRS]

For the UE, a higher layer parameter for PTRS, phaseTrackingRS, may be configured on the higher layer parameter DMRS-UplinkConFIG. When transmitting the PUSCH to the BS, the UE may transmit a PT-RS for phase tracking of the UL channel. A procedure of transmitting a UL PTRS by the UE may be determined according to whether transform precoding is performed when transmitting the PUSCH. In case that Transform precoding is performed and transformPrecoderEnabled region is configured within higher layer parameter PTRS-UplinkConfig, sampleDensity within the transformPrecoderEnabled region may indicate sample density threshold denoted by N_{RB0} or N_{RB4} in a table below. In case that Transform precoding is performed and transformPrecoderEnabled region is configured within higher layer parameter PTRS-UplinkConfig, the UE may determine a PT-RS group pattern for a scheduled resource N_{RB} according to Table 40. Additionally, if the transform precoder is applied to PUSCH transmission, the number of bits of a PTRS-DMRS association region for indicating association between PTRS and DMRS within DCI format 0_1 or 0_2 may be 0.

TABLE 40

| | Number of | Number of samples per PT- |
|---|---|---|
| Scheduled bandwidth | PT-RS groups | RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

In case that transform precoding is not applied to PUSCH transmission and phase trackingRS which is a higher layer parameter is configured, the UE may indicate, in a transformPrecoderDisabled area of the higher layer parameter PTRS-UplinkConfig, N_{RB0} to N_{RB1} for frequencyDensity and ptrs-MCS₁ to ptrs-MCS₃ for timeDensity. As described in Tables 41-1 and 41-2, according to the MCS (I_{MCS}) and RB (N_{RB}) of the scheduled PUSCH, the UE may determine PT-RS density in a time domain (L_{PT-RS}) and PT-RS density (K_{PT-RS}) in a frequency domain. In Table 41-1, ptrs-MCS₄ is not specified as a higher layer parameter, but the BS and the UE may know that ptrs-MCS₄ is 29 or 28 according to the configured MCS table.

TABLE 41-1

| Scheduled MCS | Time Density (LPT-RS) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 41-2

| Scheduled bandwidth | Frequency density (KPT-RS) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

In case that transform precoder is not applied to PUSCH transmission and PTRS-UplinkConfig is configured, the BS may indicate a 2-bit ‘PTRS-DMRS association’ region to the UE to indicate association between PTRS and DMRS in DCI format 0_1 or 0_2. The indicated 2-bit PTRS-DMRS association region may be applied to Table 42-1 or 42-2 according to the maximum number of PTRS ports configured as maxNrofPorts in the higher layer parameter PTRS-UplinkConFIG. If the maximum number of PTRS ports is 1, the UE may determine the association between the PTRS and DMRS as 2 bits indicated in Table 42-1 and the PTRS-DMRS association region, and transmit the PTRS according to the determined association. In case that the maximum number of PTRS ports is 2, the UE may determine the association between the PTRS and DMRS as 2 bits indicated in Table 42-2 and the PTRS-DMRS association region, and transmit the PTRS according to the determined association.

TABLE 42-1

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 42-2

| Value of MSB | DMRS port | Value of LSB | DMRS port |
|---|---|---|---|
| 0 | 1^{st} DMRS port | 0 | 1^{st} DMRS port |
| | which shares | | which shares |
| | PTRS port 0 | | PTRS port 1 |
| 1 | 2^{nd} DMRS port | 1 | 2^{nd} DMRS port |
| | which shares | | which shares |
| | PTRS port 0 | | PTRS port 1 |

The DMRS ports in Tables 42-1 and 42-2 may be determined through a table determined by the “Antenna ports” region indicated by the same DCI as the DCI indicating the PTRS-DMRS association and the higher layer parameter configuration. In case that the transform precoder is not configured as the higher layer configuration of PUSCH, dmrs-Type 1 and maxLength of 2 are configured with respect to DMRS, and the rank of PUSCH is 2, the UE may determine a DMRS port through the table for “Antenna port(s)” as shown in Table 43 and bits indicated through the antenna port region.

In the case of supporting Noncodebook-based PUSCH, the UE may determine the rank value by referring to an SRI region indicated by the same DCI as the DCI including the “Antenna ports” region (i.e., if the SRI region does not exist, rank may be considered as 1). In the case of supporting codebook-based PUSCH, the UE may determine the rank value by referring to the TPMI region indicated by the same DCI as the DCI including the “Antenna ports” region.

Table 43 is an example of the antenna port table referred to when configuring the PUSCH described above, and if the PUSCH is configured with other parameters, the DMRS port may be determined according to the Antenna port table according to the configuration and bits of the “Antenna ports” region indicated by DCI.

TABLE 43

| | Number of DMRS CDM | | Number of front-load |
|---|---|---|---|
| Value | group(s) without data | DMRS port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

The 1^{st} scheduled DMRS to 4^{th} scheduled DMRS in Table 42-1 may be defined as values obtained by sequentially mapping the bits of the “Antenna ports” region of DCI and the DMRS ports indicated through the antenna port table according to the higher layer configuration. For example, in case that the bits of the “Antenna ports” region of the DCI are 0001 and the DMRS port is determined by referring to Table 43, the scheduled DMRS ports may be 0 and 1, DMRS port 0 may be defined as 1^{st} scheduled DMRS, and DMRS port 1 may be defined as 2^{nd} scheduled DMRS. The DMRS port determined by referring to the antenna port table according to the bits of another “Antenna ports” region and another higher layer configuration may be similarly applied. The UE may determine, among the DMRS ports as defined above, one DMRS port to be associated with the PTRS port by referring to the bit indicated by the PTRS-DMRS association in the DCI, and may transmit the PTRS according to the determined DMRS port.

In Table 42-2, a DMRS port that shares PTRS port 0 and a DMRS port that shares PTRS port 1 may be defined according to codebook-based PUSCH transmission or non-codebook-based PUSCH transmission. If a UE transmits PUSCH based on partial-coherent or non-coherent codebook, UL layers transmitted through PUSCH antenna ports 1000 and 1002 may be associated with PTRS port 0, and UL layers transmitted through PUSCH antenna ports 1001 and 1003 may be associated with PTRS port 1. More specifically, when layer 3: TPMI=2 is selected for codebook-based PUSCH transmission, a first layer is associated with PTRS port 0 because the first layer is transmitted through PUSCH antenna ports 1000 and 1002, a second layer may be transmitted through the PUSCH antenna port 1001, a third layer is transmitted through PUSCH antenna port 1002, and thus the second and third layers are associated with PTRS port 1. Each of the three layers indicates a DMRS port, and the DMRS port for the first layer corresponds to “1st DMRS port which shares PTRS port 0” in Table 42-2, the DMRS port for the second layer corresponds to “1st DMRS port which shares PTRS port 1” in Table 42-2, and the DMRS port for the third layer corresponds to “2nd DMRS port which shares PTRS port 1” in Table 42-2. Similarly, the DMRS port associated with PTRS port 0 and the DMRS port associated with PTRS port 1 may be determined according to different numbers of layers and TPMI.

In case that a UE performs non-codebook-based PUSCH transmission, a DMRS port associated with PTRS port 0 and a DMRS port associated with PTRS port 1 may be distinguished according to antenna ports and SRI indicated by DCI. More specifically, it may be configured whether an SRS resource, which is included in an SRS resource set and for which usage is ‘nonCodebook’, is associated with PTRS port 0 or PTRS port 1 through the higher layer parameter ptrs-PortIndex. The BS may indicate, via an SRI, an SRS resource for non-codebook-based PUSCH transmission. Here, ports of indicated SRS resources are mapped one-to-one to the respective PUSCH DMRS ports. The association between the PUSCH DMRS port and the PTRS port is determined according to the higher layer parameter ptrs-PortIndex of the SRS resource mapped to the DMRS port. More specifically, it is assumed that ptrs-PortIndex of n0, n0, n1, and n1 are configured to SRS resources 1 to 4 included in the SRS resource set having a usage of nonCodebook, respectively. Furthermore, it is assumed that the PUSCH is indicated, via an SRI, to be transmitted through SRS resources 1, 2, and 4, and DMRS ports 0, 1, and 2 are indicated as the “Antenna ports” region. In this case, the ports of SRS resources 1, 2, and 4 are mapped to DMRS ports 0, 1, and 2, respectively. In addition, according to the ptrs-PortIndex in the SRS resource, DMRS ports 0 and 1 are associated with PTRS port 0, and DMRS port 2 is associated with PTRS port 1. Therefore, in Table 42-2, DMRS port 0 corresponds to ‘1st DMRS port which shares PTRS port 0’, DMRS port 1 corresponds to ‘2nd DMRS port which shares PTRS port 0’, and DMRS port 2 corresponds to ‘1st DMRS port which shares PTRS port 1’. Similarly, the DMRS port associated with PTRS port 0 and the DMRS port associated with PTRS port 1 may be determined according to a different SRI value and a method of configuring ptrs-PortIndex in an SRS resource having a different pattern. The UE determines an association between the DMRS port and the PTRS port with respect to the two PTRS ports, as described above. Thereafter, the UE determines a DMRS port to be associated with PTRS port 0 by referring to an MSB bit of the PTRS-DMRS association among multiple DMRS ports associated with the respective PTRS ports, and transmits PTRS by determining a DMRS port to be associated with PTRS port 1 by referring to a least significant bit (LSB).

[In Relation to UE Capability Report]

In LTE and NR, a UE may perform a procedure of reporting a capability supported by the UE to the corresponding BS in a state in which the UE is connected to a serving BS. In the following description, this is referred to as a UE capability report.

The BS may transmit a UE capability enquiry message that corresponds to a request for a capability report to the UE in the connected state. The message may include a UE capability request for each radio access technology (RAT) type of the BS. The request for each RAT type may include supported frequency band combination (BC) information and the like. Furthermore, in the case of the UE capability enquiry message, UE capabilities for each of multiple RAT types may be requested through one RRC message container transmitted by the BS or the BS may insert the UE capability enquiry message including the UE capability request for each RAT type multiple times and transmit same to the UE. That is, the UE capability enquiry is repeated multiple times within one message and the UE may configure a UE capability information message corresponding thereto and report same multiple times.

In a next-generation mobile communication system, a UE capability request for NR, LTE, E-UTRA—NR DC (EN-DC), and multi-RAT DC (MR-DC) may be made. In addition, the UE capability enquiry message is generally transmitted initially after the UE is connected to the BS, but may be requested at any time when the BS needs the same.

The UE receiving the UE capability report request from the BS in the above operation configures a UE capability according to RAT type and band information requested by the BS. A method by which the UE configures the UE capability in the NR system will is described below.

1. In case that the UE receives a list of LTE and/or NR bands from the BS through a UE capability request, the UE configures a BC for EN-DC and NR standalone (SA). That is, the UE configures a candidate list of BCs for EN-DC and NR SA, based on requested bands through FreqBandList to the BS. The bands sequentially have priorities as stated in FreqBandList.

2. In case that the BS sets a “eutra-nr-only” flag or a “eutra” flag and makes a request for the UE capability report, the UE completely removes NR SA BCs from the configured candidate list of BCs. Such an operation may occur only when the LTE BS (e.g., an eNB) makes a request for a “eutra” capability.

3. Thereafter, the UE removes fallback BCs from the candidate list of BCs configured in the above operation. Here, the fallback BC is a BC which may be obtained by removing a band corresponding to at least one secondary cell (SCell) from a predetermined BC, and a BC before the removal of the band corresponding at least one SCell may cover the fallback BC and thus the fallback BC may be omitted. This operation is applied to MR-DC, i.e., LTE bands. BCs left after this operation correspond to a final “candidate BC list”.

4. The UE selects BCs suitable for a requested RAT type in the final “candidate BC list” and selects BCs to be reported. In this operation, the UE configures supportedBandCombinationList according to a determined order. That is, the UE configures BCs and UE capability to be reported according to an order of a preconfigured rat-Type. (nr->eutra-nr->eutra). Further, the UE configures featureSetCombination for the configured supportedBandCombinationList and configures a list of “candidate feature set combination” in a candidate BC list from which a list for fallback BCs (including capability at the same or lower level) is received. The “candidate feature set combination” may include all feature set combinations for NR and EUTRA-NR BCs, and may be acquired from a feature set combination of UE-NR-Capabilities and UE-MRDC-Capabilities containers.

5. In case that the requested RAT Type is eutra-nr and has influences, featureSetCombinations are included in all of the two containers of UE-MRDC-Capabilities and UE-NR-Capabilities. However, the NR feature set includes only UE-NR-Capabilities.

After the UE capability is configured, the UE transfers a UE capability information message including the UE capability to the BS. The BS performs scheduling and transmission/reception management suitable for the corresponding UE based on the UE capability received from the UE.

[In Relation to CA/DC]

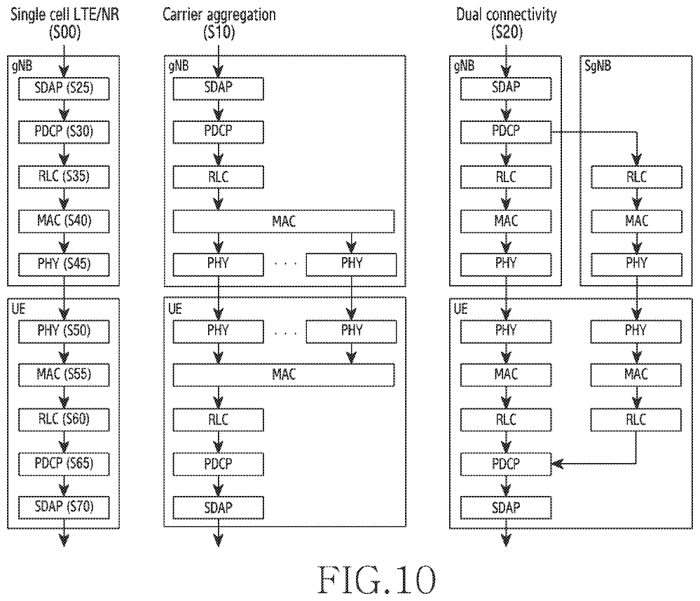

FIG. 10 illustrates a radio protocol structure of a BS and a UE in a single cell, CA, and DC situation according to an embodiment.

Referring to FIG. 10, radio protocols of a next-generation mobile communication system include NR service data adaptation protocols (SDAPs) S25 and S70, NR packet data convergence protocols (PDCPs) S30 and S65, NR radio link controls (RLCs) S35 and S60, and NR MACs S40 and S55 in a UE and an NR BS, respectively.

Functions of the NR SDAPs S25 and S70 may include at least one of:
User data transfer function (transfer of user plane data)
Function of mapping a quality of service (QoS) flow and a data bearer for a UL and a DL (mapping between a QoS flow and a DRB for both DL and UL)
Function of marking a QoS flow ID in an UL and a DL (marking QoS flow ID in both DL and UL packets)
Function of mapping reflective QoS flows to data bearers for UL SDAP packet data units (PDUs) (e.g., a reflective QoS flow to data radio bearer (DRB) mapping for the UL SDAP PDUs)

With respect to an SDAP layer device, the UE may be configured with, via an RRC message, whether to use a header of the SDAP layer device or whether to use a function of the SDAP layer device for each PDCP layer device, for each bearer, or for each logical channel, and if the SDAP header is configured, a non-access stratum (NAS) QoS reflection configuration 1-bit indicator (NAS reflective QoS) and an access stratum (AS) QoS reflection configuration 1-bit indicator (AS reflective QoS) of the SDAP header may be indicated to cause the UE to update or reconfigure mapping information for data bearers and QoS flows in an UL and a DL. The SDAP header may include QoS flow ID information indicating QoS. The QoS information may be used as a data processing priority, scheduling information, and the like to support a smooth service.

Functions of the NR PDCPs S30 and S65 may include at least one of:
Header compression and decompression function (Robust header compression (ROHC) only)
User data transmission function (transfer of user data)
Sequential delivery function (in-sequence delivery of upper layer PDUs)
Non-sequential delivery function (out-of-sequence delivery of upper layer PDUs)
Reordering function (PDCP PDU reordering for reception)
Duplicate detection function (duplicate detection of lower layer service data units (SDUs))
Retransmission function (retransmission of PDCP SDUs)
Encryption and decryption function (ciphering and deciphering)
Timer-based SDU discard function (timer-based SDU discard in UL)

In the above, the reordering function of the NR PDCP device refers to a function of reordering PDCP PDUs received from a lower layer in order based on a PDCP sequence number (SN), and may include a function of transferring data to a higher layer according to the reordered sequence. Alternatively, the reordering function of the NR PDCP device may include a function of direct transfer regardless of a sequence, may include a function of reordering the sequence to record lost PDCP PDUs, may include a function of reporting states of the lost PDCP PDUs to a transmission side, and may include a function of requesting retransmission of the lost PDCP PDUs.

Functions of the NR RLCs S35 and S60 may include at least one of:
Data transmission function (transfer of upper layer PDUs)
Sequential delivery function (in-sequence delivery of upper layer PDUs)
Non-sequential delivery function (out-of-sequence delivery of upper layer PDUs)
ARQ function (error correction through ARQ)
Concatenation, segmentation, and reassembly function (concatenation, segmentation, and reassembly of RLC SDUs)
Re-segmentation function (re-segmentation of RLC data PDUs)
Reordering function (reordering of RLC data PDUs)
Duplicate detection function
Error detection function (protocol error detection)
RLC SDU discard function
RLC re-establishment function

In the above, the in-sequence delivery function of the NR RLC device refers to a function of sequentially transferring, to a higher layer, RLC SDUs received from a lower layer. The in-sequence delivery function of the NR RLC device may include a function of, when originally one RLC SDU is segmented into multiple RLC SDUs and then received, reassembling and transferring the received RLC SDUs, may include a function of reordering the received RLC PDUs according to an RLC SN or a PDCP SN, may include a function of reordering a sequence and recording lost RLC PDUs, may include a function of reporting states of the lost RLC PDUs to a transmission side, and may include a function of requesting retransmission of the lost RLC PDUs. The in-sequence delivery function of the NR RLC device may include a function of, when there is a lost RLC SDU, sequentially transferring only RLC SDUs before the lost RLC SDU to a higher layer, or may include a function of, even if there is a lost RLC SDU, if a predetermined timer expires, sequentially transferring, to the higher layer, all the RLC SDUs received before the timer starts. Alternatively, the in-sequence delivery function of the NR RLC device may include a function of, even if there is a lost RLC SDU, if a predetermined timer expires, sequentially transferring, to the higher layer, all RLC SDUs received up to the current time point. In the above, the RLC PDUs may be processed in the order of reception thereof (in the order of arrival regardless of the order of the SNs) and may be delivered to the PDCP device regardless of the order (out-of-sequence delivery), and in the case of segments, segments stored in a buffer or to be received at a later time may be received, reconfigured into one complete RLC PDU, processed, and then may be delivered to the PDCP device. The NR RLC layer may not include a concatenation function, and the function may be performed in an NR MAC layer or may be replaced with a multiplexing function of the NR MAC layer.

In the above, the out-of-sequence delivery function of the NR RLC device refers to a function of directly delivering the RLC SDUs received from the lower layer to a higher layer regardless of order, and may include a function of, when originally one RLC SDU is divided into multiple RLC SDUs and then received, reassembling the divided RLC SDUs and then delivering the same, and may include a function of storing the RLC SN or the PDCP SN of the received RLC PDUs and arranging same so as to record the lost RLC PDUs.

The NR MACs S40 and S55 may be connected to multiple NR RLC layer devices included in one UE, and main functions of the NR MACs may include some of the following functions.
Mapping function (mapping between logical channels and transport channels)
Multiplexing and demultiplexing function (multiplexing/demultiplexing of MAC SDUs)
Scheduling information reporting function
HARQ function (error correction through HARQ)
Function of priority handling between logical channels (priority handling between logical channels of one UE)
Function of priority handling between UEs (priority handling between UEs through dynamic scheduling)
Multimedia broadcast multicast services (MBMS) service identification function
Transport format selection function
Padding function

The NR physical (PHY) layers S45 and S50 may perform channel-coding and modulation of higher layer data, make the channel-coded and modulated higher layer data into OFDM symbols, and transmit the OFDM symbols through a radio channel, or may perform demodulation and channel-decoding of the OFDM symbols received through the radio channel and transfer same to the higher layer.

The detailed structure of the radio protocol structure may be variously changed according to a carrier (or cell) operating method. For example, when the BS transmits, based on a single carrier (or cell), data to the UE, the BS and the UE use a protocol structure having a single structure for each layer, as shown in S00. However, when the BS transmits data to the UE, based on CA using multiple carriers in a single transmission and reception point (TRP), the BS and the UE use a protocol structure in which up to the RLC layer has a single structure but the PHY layer is multiplexed through the MAC layer, as shown in S10.

As another example, when the BS transmits data to the UE, based on DC using multiple carriers in multiple TRPs, the BS and the UE use a protocol structure in which up to the RLC has a single structure but the PHY layer is multiplexed via the MAC layer, as shown in S20.

[In Relation to Non-Coherent Joint Transmission (NC-JT)]

According to an embodiment of the disclosure, NC-JT may be used for a UE to receive a PDSCH from multiple TRPs.

Unlike a conventional system, a 5G wireless communication system supports a service requiring a high transmission rate and also a service having a very short transmission delay as well as a service requiring a high connection density. In a wireless communication network including multiple cells, TRPs, or beams, cooperative communication (coordinated transmission) between respective cells, TRPs, or/and beams may satisfy various service requirements by increasing the strength of a signal received by the UE or efficiently controlling interference between the cells, TRPs, or/and beams.

Joint transmission (JT) is one of representative transmission technologies for the above-described cooperative communication, and may be used for increasing the strength or throughput of signal received by the UE, by transmitting the signal to one UE through multiple different cells, TRPs, and/or beams. Characteristics of channels between the UE and each cell, TRP, and/or beam may largely vary, and in particular, NC-JT supporting non-coherent precoding between cells, TRPs and/or beams may require individual precoding, MCS, resource allocation, TCI indication, etc., according to channel characteristics for each link between the UE and cell, TRP, and or beam.

The aforementioned NC-JT transmission may be applied to at least one of DL data channel (e.g., a PDSCH), DL control channel (e.g., a PDCCH), UL data channel (e.g., a PUSCH), and UL control channel (e.g., a PUCCH). In PDSCH transmission, transmission information such as precoding, MCS, resource allocation, and TCI may be indicated through DL DCI, and should be independently indicated for each cell, TRP, or/and beam for the NC-JT. This is a factor that increases payload required for DL DCI transmission, which may have a bad influence on reception performance of a PDCCH for transmitting the DCI. Accordingly, in order to support JT of the PDSCH, it is required to carefully design a tradeoff between an amount of DCI information and reception performance of control information.

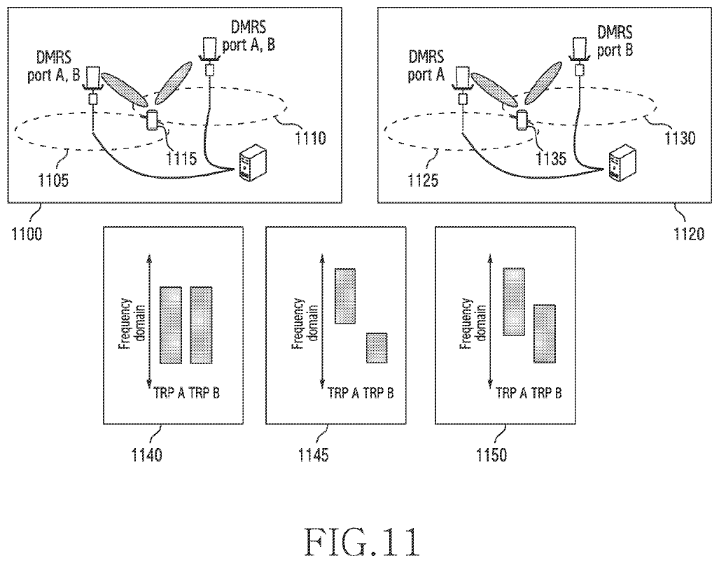

FIG. 11 illustrates an antenna port configuration and resource allocation for transmitting a PDSCH by using cooperative communication in a wireless communication system according to an embodiment.

Referring to FIG. 11, an example 1100 of coherent JT (C-JT) supporting coherent precoding between respective cells, TRPs, or/and beams is provided.

In the case of C-JT, a TRP A 1105 and a TRP B 1110 transmit single data (e.g., a PDSCH) to a UE 1115, and joint precoding may be performed in the multiple TRPs. As such, DMRSs may be transmitted through the same DMRS ports so that the TRP A 1105 and the TPR B 1110 transmit the same PDSCH. For example, the TRP A 1105 and the TPR B 1110 may transmit DMRSs to the UE through a DMRS port A and a DMRS port B, respectively. In this case, the UE may receive one piece of DCI information for receiving one PDSCH demodulated based on the DMRSs transmitted through the DMRS port A and the DMRS port B.

FIG. 11 also illustrates an example 1120 of NC-JT supporting non-coherent precoding between respective cells, TRPs, or/and beams for PDSCH transmission.

In the case of NC-JT, the PDSCH is transmitted to a UE 1135 for each cell, TPR, or/and beam, and individual precoding may be applied to each PDSCH. Respective cells, TRPs, or/and beams may transmit different PDSCHs or different PDSCH layers to the UE, thereby improving throughput compared to single cell, TRP, or/and beam transmission. Furthermore, respective cells, TRPs, or/and beams may repeatedly transmit the same PDSCH to the UE, thereby improving reliability compared to single cell, TRP, or/and beam transmission. For convenience of description, the cell, TRP, or/and beam are collectively called a TRP.

Here, for the PDSCH transmission, various wireless resource allocations such as the case 1140 in which frequency and time resources used by multiple TRPs for PDSCH transmission are all the same, the case 1145 in which frequency and time resources used by multiple TRPs do not overlap at all, and the case 1150 in which some of the frequency and time resources used by multiple TRPs overlap each other may be considered.

In order to support NC-JT, DCI in various forms, structures, and relations may be considered to simultaneously allocate multiple PDSCHs to one UE.

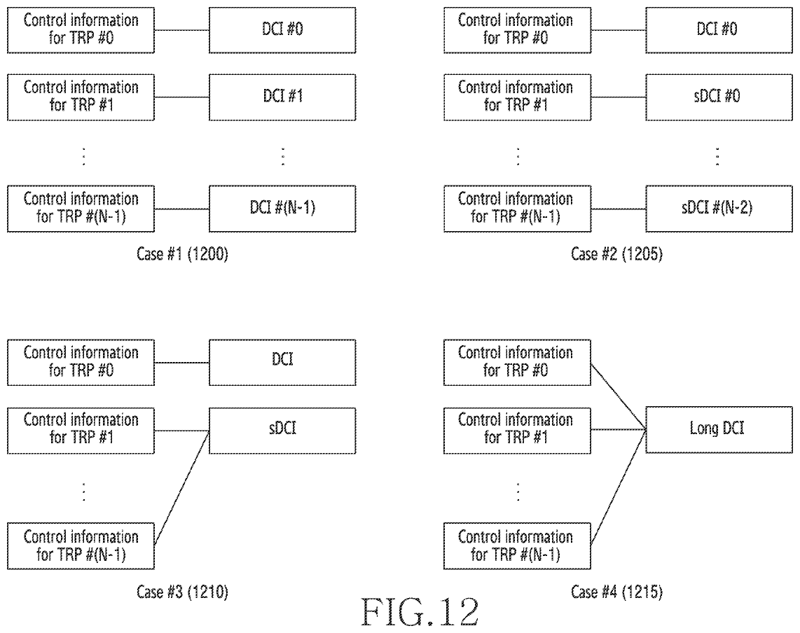

FIG. 12 illustrates a configuration of DCI for cooperative communication in a wireless communication system according to an embodiment. More specifically, FIG. 12 illustrates a configuration of DCI for NC-JT in which respective TRPs transmit different PDSCHs or different PDSCH layers to a UE in a wireless communication system according to an embodiment.

Referring to FIG. 12, case #1 1200 is an example in which control information for PDSCHs transmitted from (N−1) additional TRPs is transmitted independently from control information for a PDSCH transmitted by a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCI (DCI #0 to DCI #(N−1)). Formats between the independent DCI may be identical to or different from each other, and payload between the DCI may also be identical to or different from each other. In case #1, a degree of freedom of PDSCH control or allocation may be completely guaranteed, but when respective pieces of DCI are transmitted by different TRPs, a difference between DCI coverages may be generated and reception performance may deteriorate.

Case #2 1205 is an example in which pieces of control information for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCI (sDCI) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus may include reserved bits compared to the nDCI.

In case #2, a degree of freedom of each PDSCH control or allocation may be limited according to content of information elements included in the sDCI, but reception performance of the sDCI becomes better than the nDCI, and thus a probability of the generation of difference between DCI coverages may become lower.

Case #3 1210 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information such as frequency domain resource assignment, time domain resource assignment, and the MCS of the cooperative TRPs. In addition, information that is not included in the sDCI, such as a BWP indicator and a carrier indicator may follow DCI (DCI #0, normal DCI, or nDCI) of the serving TRP.

In case #3 1210, a degree of freedom of PDSCH control or allocation may be limited according to content of the information elements included in the sDCI but reception performance of the sDCI may be controlled, and case #3 may have smaller complexity of DCI blind decoding of the UE compared to case #1 1200 or case #2 1205.

Case #4 1215 is an example in which control information for PDSCHs transmitted from (N−1) additional TRPs is transmitted in DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1215, complexity of DCI blind decoding of the UE may not be increased, but a degree of freedom of PDSCH control or allocation may be low since the number of cooperative TRPs is limited according to long DCI payload restriction.

In the following description and embodiments, the sDCI may refer to various pieces of supplementary DCI such as shortened DCI, secondary DCI, or normal DCI (DCI formats 1_0 and 1_1 described above) including PDSCH control information transmitted in the cooperative TRP, and unless a specific restriction is mentioned, the corresponding description may be similarly applied to the various pieces of supplementary DCI.

In the following description and embodiments, case #1 1200, case #2 1205, and case #3 1210 in which one or more pieces of DCI (e.g., PDCCHs) are used to support NC-JT may be classified as multiple PDCCH-based NC-JT and case #4 1215 in which single DCI (e.g., a PDCCH) is used to support NC-JT may be classified as single PDCCH-based NC-JT. In multiple PDCCH-based PDSCH transmission, a CORESET for scheduling DCI of the serving TRP (TRP #0) may be separated from CORESETs for scheduling DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Furthermore, in single PDCCH-based NC-JT, single DCI schedules a single PDSCH having multiple layers instead of scheduling multiple PDSCHs, and the multiple layers may be transmitted from multiple TRPs. Here, the correlation between the layer and the TRP transmitting the corresponding layer may be indicated through a TCI indication for the layer.

The “cooperative TRP” of embodiments of the disclosure may be replaced with various terms such as a “cooperative panel” or a “cooperative beam” when actually applied.

In embodiments of the disclosure, “the case in which NC-JT is applied” may be variously interpreted as “the case in which the UE simultaneously receives one or more PDSCHs in one BWP”, “the case in which the UE simultaneously receives PDSCHs based on two or more TCI indications in one BWP”, and “the case in which the PDSCHs received by the UE are associated with one or more DMRS port groups” in consideration of circumstances, but is used by one expression for convenience of description.

Herein, the wireless protocol structure for NC-JT may be variously used according to a TRP development scenario. For example, in case that there is a small backhaul delay or no backhaul delay between cooperative TRPs, a method (e.g., a CA-like method) using a structure based on MAC layer multiplexing may be used similarly to S10 of FIG. 10. However, in case that the backhaul delay between cooperative TRPs is too large to be ignored (e.g., when a time of 2 ms or longer is needed to exchange information such as CSI, scheduling, and HARQ-ACK between cooperative TRPs), a method (e.g., a DC-like method) of securing a characteristic robust against a delay may be used through an independent structure for each TRP from an RLC layer similarly to S20 of FIG. 10.

The UE supporting C-JT/NC-JT may receive a C-JT/NC-JT-related parameter or setting value from a higher-layer configuration and set an RRC parameter of the UE based on the parameter or setting value. For the higher-layer configuration, the UE may use a UE capability parameter, e.g., tci-StatePDSCH. The UE capability parameter, e.g., tci-StatePDSCH may define TCI states for the purpose of PDSCH transmission, the number of TCI states may be configured as 4, 8, 16, 32, 64, and 128 in FR1 and as 64 and 128 in FR2, and a maximum of 8 states which may be indicated by 3 bits of a TCI field of the DCI may be configured through a MAC CE message among the configured numbers. A maximum value 128 means a value indicated by maxNumberConfiguredTCIstatesPerCC within the parameter tci-StatePDSCH which is included in capability signaling of the UE. As described above, a series of configuration procedures from the higher-layer configuration to the MAC CE configuration may be applied to a beamforming indication or a beamforming change command for at least one PDSCH in one TRP.

[Multi-DCI-Based Multi-TRP]

In accordance with an embodiment of the disclosure, a multi-DCI-based multi-TRP transmission method may configure a DL control channel for NC-JT based on multiple PDCCHs.

NC-JT based on multiple PDCCHs may include CORESETs or search spaces distinguished according to TRPs, when DCI for scheduling a PDSCH of each TRP is transmitted. The CORESET or search space for each TRP may be configured as at least one of following cases.
Higher-layer index configuration for each CORESET: CORESET configuration information configured through a higher layer may include an index value, and a TRP transmitting a PDCCH from a corresponding CORESET may be distinguished by the configured index value for each CORESET. In other words, in a group of CORESETs having an identical higher layer index value, it may be considered that an identical TRP transmits a PDCCH or a PDCCH scheduling a PDSCH of an identical TRP is transmitted. The above-described index for each CORESET may be referred to as CORESETPoolIndex, and it may be considered that a PDCCH is transmitted from an identical TRP for CORESETs in which an identical value of CORESETPoolIndex is configured. With respect to a CORESET in which a CORESETPoolIndex value is not configured, it may be considered that a basic value is configured for CORESETPoolIndex, and the basic value may be 0.
   In the disclosure, when types of CORESETPoolIndex of multiple CORESETs included in PDCCH-Config that is higher layer signaling exceed 1, that is, when the CORESETs have different CORESETPoolIndex, a UE may determine that a BS may use the multi-DCI-based multi-TRP transmission method.
   One the contrary, in the disclosure, when types of CORESETPoolIndex included of multiple CORESETs included in PDCCH-Config that is higher layer signaling is 1, that is, when all CORESETs have CORESETPoolIndex of 0 or 1, the UE may determine that the BS does not use the multi-DCI-based multi-TRP transmission method, but uses a single TRP for transmission.
Configuration of multiple PDCCH-Config: Multiple PDCCH-Config may be configured in one BWP, and each PDCCH-Config may include a PDCCH configuration for each TRP. In other words, it may be considered that a list of CORESETs for each TRP and/or a list of search spaces for each TRP is configured in one PDCCH-Config, and one or more CORESETs and one or more search spaces included in one PDCCH-Config correspond to a specific TRP.
CORESET beam/beam group configuration: A TRP corresponding to the corresponding CORESET may be identified through a beam or a beam group configured for each CORESET. For example, when an identical TCI state is configured in multiple CORESETs, it may be considered that the corresponding CORESETs are transmitted through an identical TRP or a PDCCH for scheduling a PDSCH of an identical TRP is transmitted in the corresponding CORESET.
Search space beam/beam group configuration: A beam or a beam group may be configured for each search space, and a TRP for each search space may be identified therethrough. For example, when an identical beam/beam group or TCI state is configured in multiple search spaces, it may be considered that an identical TRP transmits the PDCCH in the corresponding search space or a PDCCH for scheduling a PDSCH of an identical TRP is transmitted in the corresponding search space.

By distinguishing the CORESET or search space for each TRP as described above, it is possible to classify PDSCH and HARQ-ACK information for each TRP, and accordingly, it is possible to generate an independent HARQ-ACK codebook for each TRP and use an independent PUCCH resource.

The above-described configuration may be independent for each cell or BWP. For example, two different CORESETPoolIndex values may be configured for a primary cell (PCell), while a CORESETPoolIndex value may not be configured for a specific SCell. In this case, it is considered that NC-JT is configured in the PCell, while NC-JT is not configured in the SCell in which the CORESETPoolIndex value is not configured.

A PDSCH TCI state activation/deactivation MAC-CE applicable to the multi-DCI-based multi-TRP transmission method may be as described in FIG. 7. If the UE does not receive a configuration of CORESETPoolIndex for each of all CORESETs in higher layer PDCCH-Config, the UE may ignore a CORESET Pool ID field 755 in the corresponding MAC-CE 750. If the UE is capable of supporting the multi-DCI-based multi-TRP transmission method, that is, the UE has a different CORESETPoolIndex for each CORESET within higher layer signaling PDCCH-Config, the UE may activate a TCI state in DCI including a PDCCH transmitted from CORESETs having a CORESETPoolIndex value identical to a value of the CORESET Pool ID field 755 in the corresponding MAC-CE 750. For example, when a value of the CORESET Pool ID field 755 in the MAC CE 750 is 0, the TCI state in the DCI included in the PDCCH transmitted from the CORESETs having CORESETPoolIndex of 0 may follow activation information of the corresponding MAC CE.

When a BS configures the UE to use the multi-DCI-based multi-TRP transmission method, that is, when types of CORESETPoolIndex of the multiple CORESETs included in the higher layer signaling PDCCH-Config exceed 1, or when the CORESETs have different CORESETPoolIndex, the UE may consider that following restrictions exist for PDSCHs scheduled by the PDCCHs in two CORESETs having different CORESETPoolIndex.
1) When the PDSCHs indicated from the PDCCHs in the two CORESETs having different CORESETPoolIndex completely or partially overlap, the UE may apply TCI states indicated from the PDCCHs to different code division multiplexing (CDM) groups. That is, two or more TCI states may not be applied to one CDM group.
2) When the PDSCHs indicated from the PDCCHs in the two CORESETs having different CORESETPoolIndex completely or partially overlap, the UE may expect that the actual numbers of front loaded DMRS symbols of each PDSCH, the actual numbers of additional DMRS symbols, actual locations of DMRS symbols, and DMRS types are not different from each other.
3) The UE may expect that BWPs indicated from the PDCCHs in the two CORESETs having different CORESETPoolIndex are identical, and that SCSs are also identical.
4) The UE may expect pieces of information on the PDSCHs scheduled from the PDCCHs in the two CORESETs having different CORESETPoolIndex are completely included in the respective PDCCHs.

[Single-DCI-Based Multi-TRP]

In accordance with an embodiment of the disclosure, a single-DCI-based multi-TRP transmission method may configure a DL control channel for NC-JT based on a single PDCCH.

In the single-DCI-based multi-TRP transmission method, a PDSCH transmitted by multiple TRPs may be scheduled by one piece of DCI. Here, the number of TCI states may be used for a method of indicating the number of TRPs transmitting the corresponding PDSCH. That is, single PDCCH-based NC-JT may be considered when the number of TCI states indicated by DCI for scheduling the PDSCHs is 2, and single-TRP transmission may be considered when the number of TCI states is 1. The TCI states indicated by the DCI may correspond to one or two TCI states among TCI states activated by the MAC CE. When the TCI states of DCI correspond to two TCI states activated by the MAC CE, a TCI codepoint indicated by the DCI may be in a corresponding relation with the TCI states activated by the MAC CE wherein the number of TCI states activated by the MAC CE, corresponding to the TCI codepoint, may be 2.

As another example, at least one of all codepoints in a TCI state field in the DCI indicates two TCI states, the UE may consider that the BS may perform transmission based on the single-DCI-based multi-TRP transmission method. Here, the at least one codepoint indicating the two TCI states within the TCI state field may be activated through an enhanced PDSCH TCI state activation/deactivation MAC CE.

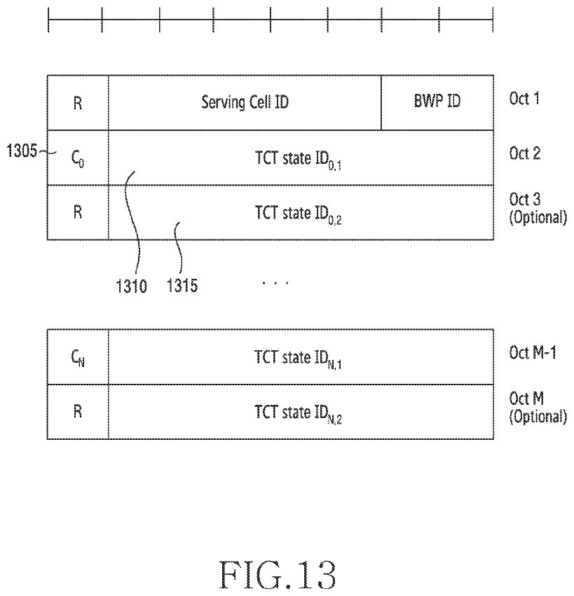

FIG. 13 illustrates an enhanced PDSCH TCI state activation/deactivation MAC-CE structure according to an embodiment. The meaning of each field in the corresponding MAC CE and values configurable for each field are as shown in Table 44 below.

```
TABLE 44
  - Serving Cell ID: This field indicates the identity of the Serving Cell for which the MAC
CE applies. The length of the field is 5 bits. If the indicated Serving Cell is configured as part
of a simultaneousTCI-UpdateList1 or simultaneousTCI-UpdateList2 as specified in TS 38.331
[5], this MAC CE applies to all the Serving Cells configured in the set simultaneousTCI-
UpdateList1 or simultaneousTCI-UpdateList2, respectively;
  - BWP ID: This field indicates a DL BWP for which the MAC CE applies as the codepoint
of the DCI bandwidth part indicator field as specified in TS 38.212 [9]. The length of the BWP
ID field is 2 bits;
  - Cᵢ: This field indicates whether the octet containing TCI state ID_{i,2} is present. If this field
is set to “1”, the octet containing TCI state ID_{i,2} is present. If this field is set to “0”, the octet
containing TCI state ID_{i,2} is not present;
  - TCI state ID_{i,j}: This field indicates the TCI state identified by TCI-StateId as specified
in TS 38.331 [5], where i is the index of the codepoint of the DCI Transmission configuration
indication field as specified in TS 38.212 [9] and TCI state ID_{i,j} denotes the j-th TCI state
indicated for the i-th codepoint in the DCI Transmission Configuration Indication field. The TCI
codepoint to which the TCI States are mapped is determined by its ordinal position among all
the TCI codepoints with sets of TCI state ID_{i,j} fields, i.e. the first TCI codepoint with TCI state
ID_{0,1} and TCI state ID_{0,2} shall be mapped to the codepoint value 0, the second TCI codepoint
with TCI state ID_{1,1} and TCI state ID_{1,2} shall be mapped to the codepoint value 1 and so on. The
TCI state ID_{i,2} is optional based on the indication of the Ci field. The maximum number of
activated TCI codepoint is 8 and the maximum number of TCI states mapped to a TCI codepoint
is 2.
  - R: Reserved bit, set to “0”.
```

Referring to FIG. 13, when a value of a C₀ field 1305 is 1, a corresponding MAC CE may include, in addition to a TCI state ID_{0,1} field 1310, a TCI state ID_{0,2} 1315. This indicates that a TCI state ID_{0,1} and a TCI state ID_{0,2} are activated for a 0th codepoint of a TCI state field included in DCI, and when a BS indicates the corresponding codepoint to a UE, the UE may receive an indication of two TCI states. If the value of the C₀ field 1305 is 0, the corresponding MAC-CE is unable to include the TCI state ID_{0,2} field 1315, and this indicates that one TCI state corresponding to the TCI state ID_{0,1} is activated for the 0th codepoint of the TCI state field included in the DCI.

The above-described configuration may be independent for each cell or BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT is configured in the PCell but NC-JT is not configured in the SCell.

[Single-DCI-Based Multi-TRP PDSCH Repetitive Transmission Scheme (TDM/FDM/SDM) Distinguishing Method]

A UE may receive, from a BS, an instruction of different single-DCI-based multi-TRP PDSCH repetitive transmission schemes (e.g., time division multiplexing (TDM), FDM, and space division multiplexing or (SDM)), according to a value indicated by a DCI field and a higher layer signaling configuration.

Table 45 below shows a method of distinguishing between single or multi-TRP-based schemes indicated to the UE, according to a value of a specific DCI field and a higher layer signaling configuration.

TABLE 45

| | | | repetitionNumber | | |
|---|---|---|---|---|---|
| | | | configuration | | Transmission |
| | | | and | Relating to | scheme |
| | TCI state | CDM group | indication | repetitionScheme | indicated to |
| Combination | Number | Number | condition | configuration | UE |
| 1 | 1 | ≥1 | Condition 2 | Not | Single-TRP |
| | | | | configured | |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured | Single-TRP |
| | | | | or not | TDM |
| | | | | configured | scheme B |
| 5 | 2 | 2 | Condition 2 | Not | Multi-TRP |
| | | | | configured | SDM |
| 6 | 2 | 2 | Condition 3 | Not | Multi-TRP |
| | | | | configured | SDM |
| 7 | 2 | 2 | Condition 3 | Configured | Multi-TRP |
| | | | | | SDM |
| 8 | 2 | 2 | Condition 3 | Configured | Multi-TRP |
| | | | | | FDM |
| | | | | | scheme |
| | | | | | A/FDM |
| | | | | | scheme |
| | | | | | B/TDM |
| | | | | | scheme A |
| 9 | 2 | 2 | Condition 1 | Not | Multi-TRP |
| | | | | configured | TDM |
| | | | | | scheme B |

Each column in Table 45 may be described as follows:
Number of TCI states (second column): denotes the number of TCI states indicated by a TCI state field in DCI, and may be one or two.
Number of CDM groups (third column): denotes the number of different CDM groups of DMRS ports indicated by an antenna port field in the DCI. The number may be 1, 2, or 3.
repetitionNumber configuration and indication condition (fourth column): may have three conditions depending on whether repetitionNumber is configured for all TDRA entries indicated by TDRA field in the DCI, and whether an actually indicated TDRA entry includes a repetitionNumber configuration.
   Condition 1: When at least one of all TDRA entries which may be indicated by the TDRA field includes the configuration for repetitionNumber, and the TDRA entry indicated by the TDRA field in the DCI includes the configuration for repetitionNumber greater than 1.
   Condition 2: When at least one of all TDRA entries which may be indicated by the TDRA field includes the configuration for repetitionNumber, and the TDRA entry indicated by the TDRA field in the DCI does not include the configuration for repetitionNumber.
   Condition 3: When any of TDRA entries which may be indicated by the TDRA field do not include the configuration for repetitionNumber.
Regarding repetitionScheme configuration (fifth column): denotes whether higher layer signaling repetitionScheme is configured. The higher layer signaling repetitionScheme may be configured with one of “tdmSchemeA”, “fdmSchemeA”, and “fdmSchemeB”.
Transmission scheme indicated to UE (sixth column): denotes single or multi-TRP schemes indicated according to combinations (first column) in Table 45.
   Single-TRP: denotes single TRP-based PDSCH transmission. If the UE is configured with pdsch-AggegationFactor in a higher layer signaling PDSCH-config, the UE may be scheduled with single TRP-based PDSCH repetitive transmission by a configured number of times. Otherwise, the UE may be scheduled with single TRP-based PDSCH single transmission.
   Single-TRP TDM scheme B: denotes PDSCH repetitive transmission based on time resource division single-TRP-based slots. According to Condition 1 above regarding repetitionNumber, the UE repeatedly transmits a PDSCH on a time resource by the number of slots of the number of times of repetitionNumber greater than 1 configured in the TDRA entry indicated by the TDRA field. Here, a starting symbol and symbol length of the PDSCH indicated by the TDRA entry are equally applied for each slot by the number of times of repetitionNumber, and an identical TCI state is applied for each PDSCH repetitive transmission. This scheme is similar to a slot aggregation scheme in that the PDSCH repetitive transmission is performed between slots on a time resource, but is different from the slot aggregation scheme in that whether to indicate repetitive transmission is dynamically determined based on the TDRA field in the DCI.
   Multi-TRP SDM: denotes a multi-TRP-based spatial resource division PDSCH transmission scheme. This is a method of dividing and receiving a layer from each TRP, and although the multi-TRP SDM is not a repetitive transmission scheme, reliability of PDSCH transmission may be increased as the number of layers is increased to decrease a coding rate. The UE may apply two TCI states indicated through the TCI state field in the DCI respectively to two CDM groups indicated by the BS to receive the PDSCH.
   Multi-TRP FDM scheme A: denotes a multi-TRP-based frequency resource division PDSCH transmission scheme, and although this scheme is not repetitive transmission like the multi-TRP SDM because there is one PDSCH transmission location (occasion), a frequency resource amount is increased to decrease a coding rate, and thus transmission reliability may be high. In the multi-TRP FDM scheme A, two TCI states indicated through the TCI state field in the DCI may be respectively applied to frequency resources that do not overlap each other. When the PRB bundling size is determined as a wideband and the number of RBs indicated by the frequency domain resource allocation (FDRA) field is N, the UE may receive first ceil (N/2) RBs by applying a first TC state and receive the remaining floor (N/2) RBs by applying a second TCI state. Here, ceil(.) and floor(.) are each an operator indicating rounding up or rounding down of a first decimal point. When the PRB bundling size is determined as 2 or 4, even-numbered PRB groups (PRGs) are received by applying a first TCI state and odd-numbered PRGs are received by applying a second TCI state.
   Multi-TRP FDM scheme B: denotes a multi-TRP-based frequency resource division PDSCH repetitive transmission scheme, and a PDSCH may be repeatedly transmitted at each of two PDSCH transmission locations (occasions). In the multi-TRP FDM scheme B, like the multi-TRP FDM scheme A, two TCI states indicated through the TCI state field in the DCI may be respectively applied to frequency resources that do not overlap each other. When the PRB bundling size is determined as a wideband and the number of RBs indicated by the FDRA field is N, the UE may receive first ceil (N/2) RBs by applying a first TC state and receive the remaining floor(N/2) RBs by applying a second TCI state. Here, ceil(.) and floor(.) are each an operator indicating rounding up or rounding down of a first decimal point. When the PRB bundling size is determined as 2 or 4, even-numbered PRGs are received by applying a first TCI state and odd-numbered PRGs are received by applying a second TCI state.
   Multi-TRP TDM scheme A: denotes a PDSCH repetitive transmission scheme in a multi-TRP-based time resource division slot. The UE has two PDSCH transmission locations (occasions) within one slot, and a first reception location may be determined based on a start symbol and a symbol length of the PDSCH indicated through the TDRA field within DCI. A start symbol of a second reception location of the PDSCH may be a location to which a symbol offset by higher-layer signaling StartingSymbolOffsetK from the last symbol of the first transmission location, and the transmission location corresponding to the symbol length indicated therefrom may be determined. If higher-layer signaling StartingSymbolOffsetK is not configured, the symbol offset may be considered as 0.
   Multi-TRP TDM scheme B: denotes a PDSCH repetitive transmission scheme between multi-TRP-based time resource division slots. The UE has one PDSCH transmission location (occasion) within one slot and may receive repetitive transmission based on a start symbol and a symbol length of the same PDSCH during slots corresponding to repetitionNumber indicated by the TDRA field within DCI. In case that repetitionNumber is 2, the UE may receive PDSCH repetitive transmission of first and second slots by applying first and second TCI states, respectively. In case that repetitionNumber is larger than 2, the UE may use different TCI state application methods depending on how higher layer signaling tciMapping is configured. When tciMapping is configured as cyclicMapping, first and second TCI states may be applied to first and second PDSCH transmission locations, respectively, and the same TCI state application method is equally applied to the remaining PDSCH transmission locations. When tciMapping is configured as sequentialMapping, a first TCI state may be applied to first and second PDSCH transmission locations, a second TCI state may be applied to third and fourth PDSCH transmission locations, and the same TCI state application method may be equally applied to the remaining PDSCH transmission locations.

[In Relation to RLM RS]

In accordance with an embodiment of the disclosure, a method for selecting or determining an RLM RS when the RLM RS is configured or is not configured is provided. The UE may be configured with a set of RLM RSs from the BS through RadioLinkMonitoringRS in RadioLinkMonitoringConfig, which is higher-layer signaling, for each DL BWP of a special cell (SPCell), and a specific higher-layer signaling structure may follow Table 46 below.

```
TABLE 46
RadioLinkMonitoringConfig ::= SEQUENCE {
  failureDetectionResourcesToAddModList SEQUENCE (SIZE(1..maxNrofFailureDetectionResources)) OF
RadioLinkMonitoringRS OPTIONAL, -- Need N
  failureDetectionResourcesToReleaseList SEQUENCE (SIZE(1..maxNrofFailureDetectionResources)) OF
RadioLinkMonitoringRS-Id OPTIONAL, -- Need N
  beamFailureInstanceMaxCount ENUMERATED {n1, n2, n3, n4, n5, n6, n8, n10}
OPTIONAL -- Need B
  beamFailureDetectionTimer ENUMERATED {pbfd1, pbfd2, pbfd3, pbfd4, pbfds, pbfd6, pbfd8, pbfd10}
      OPTIONAL, -- Need R
...
}
RadioLinkMonitoringRS ::= SEQUENCE {
  radioLinkMonitoringRS-Id RadioLinkMonitoringRS-Id,
  purpose ENUMERATED {beamfailure, rif, both},
  detectionResource CHOICE {
    ssb-Index SSB-Index,
    csi-RS-Index NZP-CSI-RS-ResourceId
},
...
}
```

Table 47 below indicates a configurable or selectable number of RLM RSs for each specific use according to the maximum number (Lₘₐₓ) of SSBs per half frame. As shown in Table 47 below, according to the Lₘₐₓ value, N_{LR-RLM} RSs may be used for link recovery or RLM, and N_{RLM} RSs among N_{LR-RLM} RSs may be used for RLM.

TABLE 47

| Lₘₐₓ | N_{LR-RLM} | N_{RLM} |
|---|---|---|
| 4 | 2 | 2 |
| 8 | 6 | 4 |
| 64 | 8 | 8 |

If the UE is not configured with RadioLinkMonitoringRS that is higher-layer signaling, and the UE is configured with a TCI state for receiving a PDCCH in a CORESET, and if at least one CSI-RS is included in the corresponding TCI state, the RLM RS may be selected according to following RLM RS selection methods.
RLM RS selection method 1) If an activated TCI state to be used for PDCCH reception has one reference RS (i.e., one activated TCI state has only one of QCL-TypeA, B, or C), the UE may select, as the RLM RS, a reference RS of the activated TCI state to be used for PDCCH reception.
RLM RS selection method 2) If an activated TCI state to be used for PDCCH reception has two reference RSs (i.e., one activated TCI state has one of QCL-TypeA, B, or C, and further has QCL-TypeD), the UE may select a reference RS of QCL-TypeD as the RLM-RS. The UE does not expect that two QCL-TypeDs are configured in one activated TCI state.
RLM RS selection method 3) The UE does not expect that an aperiodic or semi-persistent RS is selected as the RLM RS.
RLM RS selection method 4) If Lₘₐₓ=4, the UE may select N_{RLM} RSs (since Lₘₐₓ is 4, two may be selected). The RLM RS is selected from among the reference RSs of the TCI state configured in the CORESET for PDCCH reception, based on RLM RS selection methods 1 to 3, wherein a search space, to which the CORESET is linked, having a short period is determined to have a high priority, and the RLM RS is selected from the reference RSs of the TCI state configured in the CORESET linked to a search space of a shortest period. If there are multiple CORESETs linked to multiple search spaces having the same period, the RLM RS is selected from the reference RS of the TCI state configured in a high CORESET index.

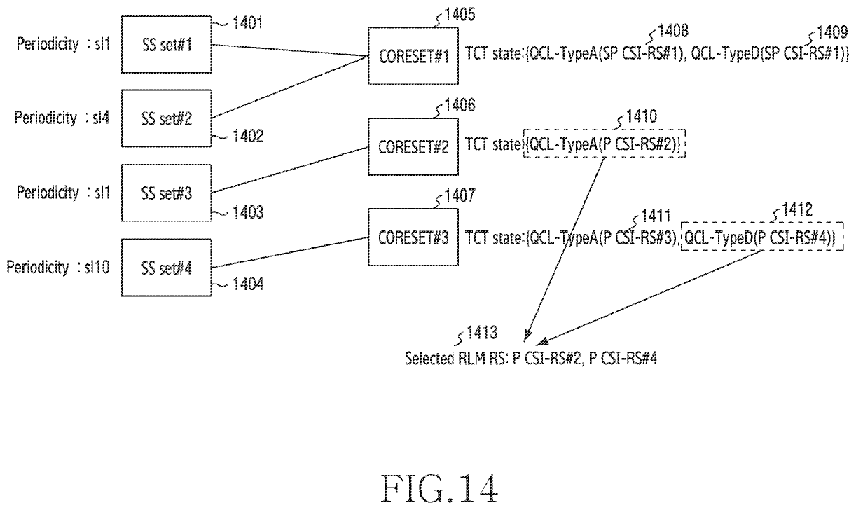

FIG. 14 illustrates an RLM RS selection process according to an embodiment.

Referring to FIG. 14, a CORESET #1 is provided to CORESET #3 1405 to 1407 linked to search space #1 to search space #4 1401 to 1404 having different periods within an activated DL BWP, and a reference RS of a TCI state configured in each CORESET. Based on RLM RS selection method 4 described above, RLM RS selection uses a TCI state configured in a CORESET linked to a search space with a shortest period, but since search space #1 1401 and search space #3 1403 have the same period, a reference RS of a TCI state configured in CORESET #2 having a higher index between CORESET #1 1405 and CORESET #2 1406 linked to respective search spaces may be used as a reference RS as a highest priority in the RLM RS selection. In addition, since the TCI state configured in CORESET #2 has only QCL-TypeA, and the corresponding reference RS is a periodic RS, P CSI-RS #2 1410 may be first selected as the RLM RS according to RLM RS selection methods 1 and 3. From among reference RSs of the TCI state configured in CORESET #1 having a subsequent priority, the reference RS of QCL-TypeD may be a selection candidate by RLM RS selection method 2, but the corresponding RS is a semi-persistent RS 1409 and, thus, is not selected as the RLM RS by RLM RS selection method 3. Therefore, RSs of the TCI state configured in CORESET #3 may be considered as having the subsequent priority, and the RS of QCL-TypeD may be a selection candidate by RLM RS selection method 2, and since the corresponding RS is a periodic RS, P CSI-RS #4 1412 may be selected as a second RLM RS by RLM RS selection method 3. Therefore, finally selected RLM RSs may be P CSI-RS #2 and P CSI-RS #4 (1413).

[Single TCI State Activation and Indication Method Based on Unified TCI Scheme]

In accordance with an embodiment of the disclosure, a method for indicating and activating a single TCI state based on a unified TCI scheme is provided. The unified TCI scheme may refer to a scheme of unifying and managing a transmission/reception BM scheme which is distinguished by a spatial relation info scheme used in UL transmission and a TCI state scheme used in DL reception by the UE in existing Rel-15 and Rel-16. Therefore, in case that the UE is indicated with a TCI state from the BS, based on the unified TCI scheme, BM may be performed using the TCI state even for UL transmission. If the UE is configured with TCI-State that is higher-layer signaling having tci-stateId-r17 that is higher-layer signaling from the BS, the UE may perform an operation based on the unified TCI scheme by using the corresponding TCI-State. TCI-State may exist in two types of a joint TCI state or a separate TCI state.

The first type is a joint TCI state, and the UE may be indicated, by the BS through one TCI-State, with TCI-State to be applied to both UL transmission and DL reception. If the UE is indicated with joint TCI state-based TCI-State, the UE may be indicated with a parameter to be used for DL channel estimation by using an RS corresponding to qcl-Type1 in the joint TCI state-based TCI-State and a parameter to be used as a DL reception beam or reception filter by using an RS corresponding to qcl-Type2. If the UE is indicated with joint TCI state-based TCI-State, the UE may be indicated with a parameter to be used as an UL transmission beam or transmission filter by using an RS corresponding to qcl-Type2 in corresponding joint DL/UL TCI state-based TCI-State. In this case, if the UE is indicated with joint TCI state-based TCI-State, the UE may apply the same beam to both UL transmission and DL reception.

The second type is a separate TCI state, and the UE may be individually indicated, by the BS, with UL TCI-State to be applied to UL transmission and DL TCI-State to be applied to DL reception. If the UE is indicated with a UL TCI state, the UE may be indicated with a parameter to be used as an UL transmission beam or transmission filter by using a reference RS or a source RS configured within the UL TCI state. If the UE is indicated with a DL TCI state, the UE may be indicated with a parameter to be used for DL channel estimation by using an RS corresponding to qcl-Type1 and a parameter to be used as a DL reception beam or reception filter by using an RS corresponding to qcl-Type2, the parameters being configured in the DL TCI state.

If the UE is indicated with DL TCI state and UL TCI state together, the UE may be indicated with a parameter to be used as an UL transmission beam or transmission filter by using a reference RS or a source RS configured within the UL TCI state, and may be indicated with a parameter to be used for DL channel estimation by using an RS corresponding to qcl-Type1 and a parameter to be used as a DL reception beam or reception filter by using an RS corresponding to qcl-Type2, the parameters being configured in the DL TCI state. In this case, if the DL TCI state indicated to the UE and the reference RS or source RS configured within the UL TCI state are different, the UE may apply an UL transmission beam based on the indicated UL TCI state and apply a DL reception beam based on the DL TCI state.

The UE may be configured with up to 128 joint TCI states for each specific BWP in a specific cell via higher-layer signaling from the BS, up to 64 or 128 DL TCI states among separate TCI states may be configured for each specific BWP in a specific cell, based on a UE capability report, via higher-layer signaling, and the DL TCI states and the joint TCI states among the separate TCI states may use the same higher-layer signaling structure. For example, if 128 joint TCI states are configured, and 64 DL TCI states are configured among separate TCI states, the 64 DL TCI states may be included in the 128 joint TCI states.

Up to 32 or 64 UL TCI states among the separate TCI states may be configured for each specific BWP in a specific cell, based on the UE capability report, via higher-layer signaling, and like the relationship between the joint TCI states and the DL TCI states among the separate TCI states, the joint TCI states and the UL TCI states among the separate TCI states may also use the same higher-layer signaling structure, or the UL TCI states among the separate TCI states may use a higher-layer signaling structure different from that of the DL TCI states among the joint TCI states and the separate TCI states. As such, using different higher-layer signaling structures or using the same higher-layer signaling structure may be defined in the standards, and based on the UE capability report including information on whether there is a use scheme supportable by the UE among the two types, the use of the scheme may be distinguished through another higher-layer signaling configured by the BS.

The UE may receive a transmission/reception beam-related indication in a unified TCI scheme by using one scheme among the joint TCI state and the separate TCI state configured from the BS. The UE may be configured with whether to use one of the joint TCI state and the separate TCI state, by the BS through higher layer signaling.

The UE may receive a transmission/reception beam-related indication by using one scheme selected from among the joint TCI state and the separate TCI state through higher-layer signaling, and in this case, a method of transmission/reception beam indication from the BS may include two methods of a MAC-CE-based indication method and a MAC-CE-based activation and DCI-based indication method.

If the UE is configured, through higher layer signaling, to receive a transmission/reception beam-related indication by using the joint TCI state scheme, the UE may receive a MAC-CE indicating the joint TCI state from the BS and perform a transmission/reception beam application operation, and the BS may schedule, for the UE, reception of a PDSCH including the MAC-CE through a PDCCH. If there is one joint TCI state included in the MAC-CE, the UE may transmit, to the BS, a PUCCH including HARQ-ACK information indicating whether reception of the PDSCH including the corresponding MAC-CE is successful, and may determine an UL transmission beam or transmission filter and a DL reception beam or reception filter by using the indicated joint TCI state from 3 ms after transmission of the PUCCH. If there are two or more joint TCI states included in the MAC-CE, the UE may transmit, to the BS, the PUCCH including HARQ-ACK information indicating whether reception of the PDSCH including the corresponding MAC-CE is successful, identify, from 3 ms after transmission of the PUCCH, that multiple joint TCI states indicated by the MAC-CE correspond to each codepoint of a TCI state field of DCI format 1_1 or 1_2, and activate the joint TCI states indicated by the MAC-CE. Thereafter, the UE may receive DCI format 1_1 or 1_2 and apply one joint TCI state indicated by a TCI state field in the corresponding DCI to UL transmission and DL reception beams. Here, DCI format 1_1 or 1_2 may include DL data channel scheduling information (with DL assignment) or may not include same (without DL assignment).

If the UE is configured, through higher layer signaling, to receive a transmission/reception beam-related indication by using the separate TCI state scheme, the UE may receive a MAC-CE indicating the separate TCI state from the BS and perform a transmission/reception beam application operation, and the BS may schedule, for the UE, a PDSCH including the corresponding MAC-CE through a PDCCH. If there is one separate TCI state set included in the MAC-CE, the UE may transmit, to the BS, a PUCCH including HARQ-ACK information indicating whether reception of the PDSCH is successful, and may determine an UL transmission beam or transmission filter and a DL reception beam or reception filter by using separate TCI states included in the indicated separate TCI state set from 3 ms after transmission of the PUCCH. In this case, the separate TCI state set may refer to a single separate TCI state or multiple separate TCI states that one codepoint of the TCI state field in DCI format 1_1 or 1_2 may have, and one separate TCI state set may include one DL TCI state, include one UL TCI state, or include one DL TCI state and one UL TCI state. If there are two or more separate TCI state sets included in the MAC-CE, the UE may transmit, to the BS, the PUCCH including HARQ-ACK information indicating whether reception of the PDSCH is successful, identify, from 3 ms after transmission of the PUCCH, that multiple separate TCI state sets indicated by the MAC-CE correspond to each codepoint of the TCI state field of DCI format 1_1 or 1_2, and activate the indicated separate TCI state sets. In this case, each codepoint of the TCI state field of DCI format 1_1 or 1_2 may indicate one DL TCI state, indicate one UL TCI state, or indicate one DL TCI state and one UL TCI state. The UE may receive DCI format 1_1 or 1_2 and apply a separate TCI state set indicated by a TCI state field in the corresponding DCI to UL transmission and DL reception beams. Here, DCI format 1_1 or 1_2 may include DL data channel scheduling information, (i.e., with DL assignment) or may not include same (i.e., without DL assignment).

The MAC-CE used to activate or indicate the single joint TCI state and the separate TCI state described above may exist for each of the joint and separate TCI state schemes, and a TCI state may be activated or indicated based on one of the joint TCI state scheme or the separate TCI state scheme by using one MAC-CE. Based on drawings to be described later, various MAC-CE structures for activation and indication of the joint or separate TCI state may be considered.

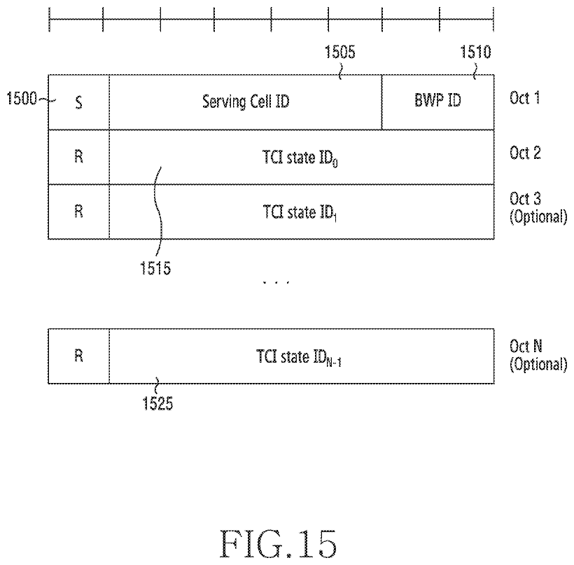

FIG. 15 illustrates a MAC-CE structure for activation and indication of a joint TCI state in a wireless communication system according to an embodiment.

Referring to FIG. 15, an S field 1500 may indicate the number of pieces of joint TCI state information included in an MAC-CE. If the S field 1500 has a value of 1, the corresponding MAC-CE may indicate one joint TCI state and may have a length of only up to a second octet. If the S field 1500 has a value 0, the corresponding MAC-CE may include two or more pieces of joint TCI state information, each joint TCI state may be activated at each codepoint of a TCI state field of DCI format 1_1 or 1_2, and up to 8 joint TCI states may be activated. Configuring the values of 0 and 1 of the S field 1500 is not limited to the configuration method, value 0 may indicate to include one joint TCI state, and value 1 may indicate to include two or more pieces of joint TCI state information. This interpretation of the S field may also be applied to other embodiments of the disclosure. TCI states indicated through a TCI state ID₀ field 1515 to a TCI state ID_{N-1} field 1525 may correspond to a zeroth codepoint to an (N−1)th codepoint of the TCI state field of DCI format 1_1 or 1_2, respectively. A serving cell ID field 1505 may indicate a serving cell ID, and a BWP ID field 1510 may indicate a BWP ID. An R field may be a 1-bit reserve field that does not include indication information.

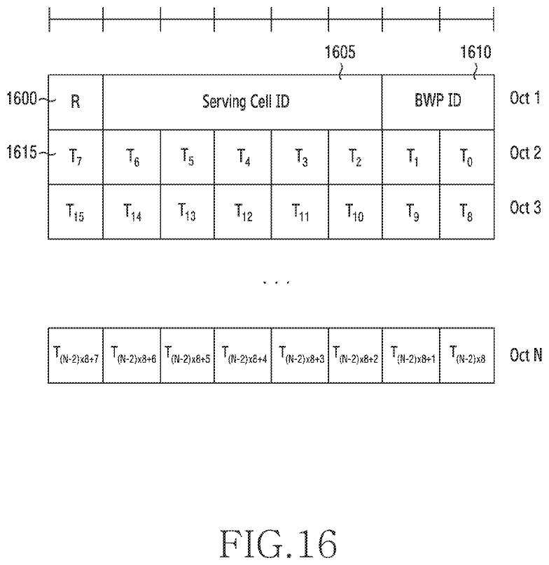

FIG. 16 illustrates a MAC-CE structure for activation and indication of a joint TCI state in a wireless communication system according to an embodiment.

Referring to FIG. 16, a serving cell ID field 1605 may indicate a serving cell ID and a BWP ID field 1610 may indicate a BWP ID. An R field 1600 may be a 1-bit reserve field that does not include indication information. Each field existing in a second octet to an Nth octet is a bitmap indicating each joint TCI state configured via higher-layer signaling. For example, T₇ 1615 may be a field indicating whether an eighth joint TCI state configured via higher-layer signaling is indicated. If a T_{N} value is 1, it may be interpreted that a corresponding joint TCI state is indicated or activated, and if the TN value is 0, it may be interpreted that a corresponding joint TCI state is not indicated or activated. Configuring values 0 and 1 is not limited to the above configuration method. If there is one joint TCI state transmitted through the MAC-CE structure of FIG. 16, the UE may apply the joint TCI state indicated via the MAC-CE to UL transmission and DL reception beams. If there are two or more joint TCI states transferred through the MAC-CE structure, the UE may identify that each joint TCI state indicated via the MAC-CE corresponds to each codepoint of a TCI state field of DCI format 1_1 or 1_2, and may activate each joint TCI state, and starting from a joint TCI state having the lowest index from among the indicated joint TCI states, the joint TCI states sequentially corresponding to codepoints with low indexes of the TCI state field of DCI format 1_1 or 1_2 may be activated in order.

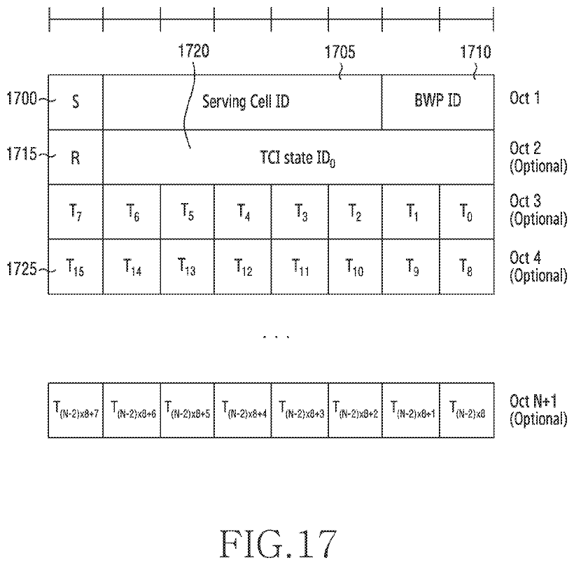

FIG. 17 illustrates a MAC-CE structure for activation and indication of a joint TCI state in a wireless communication system according to an embodiment.

Referring to FIG. 17, a serving cell ID field 1705 may indicate a serving cell ID and a BWP ID field 1710 may indicate a BWP ID. An S field 1700 may indicate the number of pieces of joint TCI state information included in an MAC-CE. If the S field 1700 has a value of 1, the MAC-CE may indicate one joint TCI state and may include only up to a second octet, and the joint TCI state may be indicated to a UE through a TCI state ID₀ field 1720. If the S field 1700 has a value of 0, the corresponding MAC-CE may include two or more pieces of joint TCI state information, each codepoint of a TCI state field of DCI format 1_1 or 1_2 may activate each joint TCI state, up to 8 joint TCI states may be activated, no second octet may exist, and there may be a first octet and a third octet to an (N+1)th octet on the MAC-CE structure of FIG. 17.

Each field existing in the third octet to an (N+1)th octet is a bitmap indicating each joint TCI state configured via higher-layer signaling. For example, T₁₅ 1725 may be a field indicating whether a 16th joint TCI state configured via higher-layer signaling is indicated. An R field 1715 may be a 1-bit reserve field that does not include indication information.

If there is one joint TCI state transmitted through the MAC-CE structure of FIG. 17, the UE may apply the joint TCI state indicated via the MAC-CE to UL transmission and DL reception beams.

If there are two or more joint TCI states transferred through the MAC-CE structure in FIG. 17, the UE may identify that each joint TCI state indicated via the MAC-CE corresponds to each codepoint of a TCI state field of DCI format 1_1 or 1_2, and may activate each joint TCI state, and starting from a joint TCI state having the lowest index from among the indicated joint TCI states, the joint TCI states sequentially corresponding to codepoints with low indexes of the TCI state field of DCI format 1_1 or 1_2 may be activated in order.

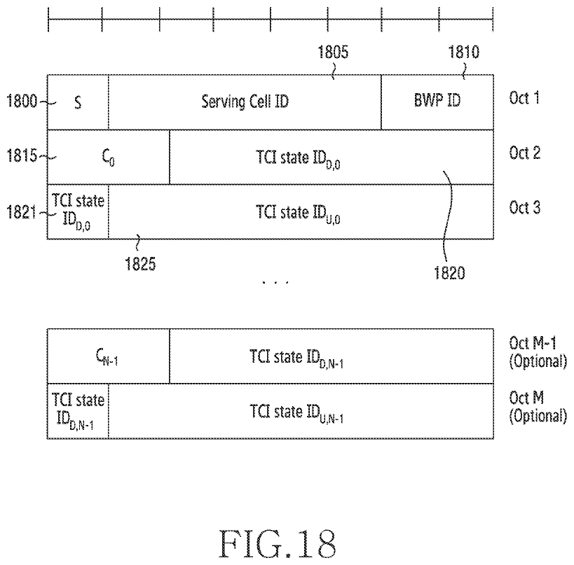

FIG. 18 illustrates a MAC-CE structure for activation and indication of a separate TCI state in a wireless communication system according to an embodiment.

Referring to FIG. 18, a serving cell ID field 1805 may indicate a serving cell ID a BWP ID field 1810 may indicate a BWP ID. An S field 1800 may indicate the number of pieces of separate TCI state set information included in an MAC-CE. If the S field 1800 has a value of 1, the corresponding MAC-CE may indicate one separate TCI state set and may include only up to a third octet. If the S field 1800 has a value 0, the MAC-CE may include two or more pieces of separate TCI state set information, each codepoint of a TCI state field of DCI format 1_1 or 1_2 may activate each separate TCI state set, and up to 8 separate TCI state sets may be activated.

A C₀ field 1815 may be a field indicating which separate TCI states are included in an indicated separate TCI state set. For example, a C₀ field value of “00” may indicate reserve, the C₀ field value of “01” may indicate one DL TCI state, the C₀ field value of “10” may indicate one UL TCI state, and the C₀ field value of “11” may indicate one DL TCI state and one UL TCI state, but this is merely an example of interpretation of C₀ field 1815, and the interpretation of C₀ field 1815 is not limited thereto.

A TCI state ID_{D,0} field 1820 and a TCI state ID_{U,0} field 1825 may refer to a DL TCI state and a UL TCI state which may be included in a zeroth separate TCI state set so as to be indicated, respectively. If the value of the C₀ field is “01”, the TCI state ID_{D,0} field 1820 may indicate the DL TCI state, and the TCI state ID_{U,0} field 1825 may be ignored. If the C₀ field has a value of “10”, the TCI state ID_{D,0} field 1820 may be ignored, and the TCI state ID_{U,0} field 1825 may indicate the UL TCI state. If the C₀ field has a value of “11”, the TCI state ID_{D,0} field 1820 may indicate the DL TCI state, and the TCI state ID_{U,0} field 1825 may indicate the UL TCI state.

FIG. 18 may illustrate an example of an MAC-CE in case that a UL TCI state among separate TCI states uses the same higher-layer signaling structure as those of a DL TCI state and a joint TCI state among the separate TCI states, as described above. Accordingly, lengths of the TCI state ID_{U,0} field 1820 and the TCI state ID_{U,0} field 1825 may have 7 bits to express up to 128 TCI states. Therefore, in order to use 7 bits for the TCI state ID_{U,0} field 1820, 6 bits 1820 may be assigned to a second octet and 1 bit 1821 may be assigned to a third octet.

In addition, FIG. 18 may indicate a case in which a UL TCI state among separate TCI states uses a higher-layer signaling structure different from a DL TCI state and a joint TCI state among the separate TCI states, as described above. Accordingly, since the UL TCI state requires 6 bits used to enable expression up to 64 UL TCI states, a first bit of the TCI state ID_{U,0} field 1825 may be fixed to 0 or 1, and bits expressing an actual UL TCI state may correspond to only a total of 6 bits from a second bit to a seventh bit.

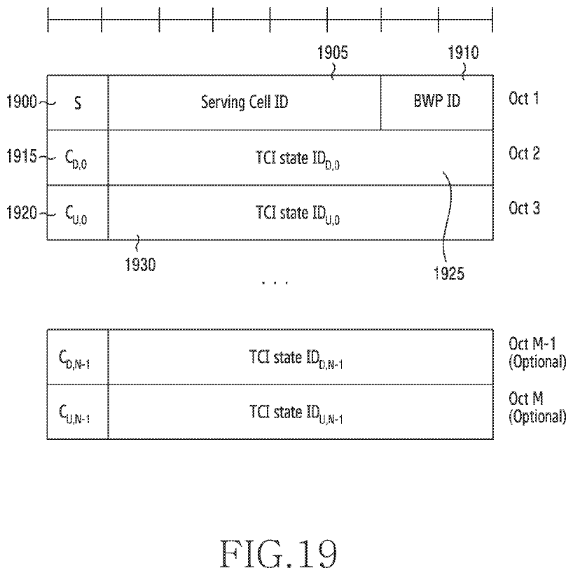

FIG. 19 illustrates a MAC-CE structure for activation and indication of a separate TCI state in a wireless communication system according to an embodiment.

Referring to FIG. 19, a serving cell ID field 1905 may indicate a serving cell ID and a BWP ID field 1910 may indicate a BWP ID. An S field 1900 may indicate the number of pieces of separate TCI state set information included in an MAC-CE. If the S field 1900 has a value of 1, the corresponding MAC-CE may indicate one separate TCI state set and may include only up to a third octet. If the S field 1900 has a value 0, the corresponding MAC-CE may include two or more pieces of separate TCI state set information, each codepoint of a TCI state field of DCI format 1_1 or 1_2 corresponds to each separate TCI state set so as to activate each separate TCI state set, and up to 8 separate TCI state sets may be activated.

A C_{D,0} field 1915 may be a field indicating whether an indicated separate TCI state set includes a DL TCI state, wherein if the C_{D,0} field 1915 has a value of 1, a DL TCI state may be included and the DL TCI state may be indicated through a TCI state ID_{U,0} field 1925, and if the C_{D,0} field 1915 has a value of 0, no DL TCI state is included and the TCI state ID_{U,0} field 1925 may be ignored. Similarly, a C_{D,0} field 1920 may be a field indicating whether an indicated separate TCI state set includes a UL TCI state, wherein if the C_{U,0} field 1920 has a value of 1, a UL TCI state may be included and the UL TCI state may be indicated through a TCI state ID_{U,0} field 1930, and if the C_{U,0} field 1920 has a value of 0, no UL TCI state is included and the TCI state ID_{U,0} field 1930 may be ignored.

FIG. 19 may illustrate an example of an MAC CE in case that a UL TCI state among separate TCI states uses the same higher-layer signaling structure as those of a DL TCI state and a joint TCI state among the separate TCI states, as described above. Accordingly, lengths of the TCI state ID_{D,0} field 1925 and the TCI state ID_{U,0} field 1930 may have 7 bits to express up to 128 TCI states.

In addition, FIG. 19 may illustrate an example of an MAC CE in case that a UL TCI state among separate TCI states uses a higher-layer signaling structure different from a DL TCI state and a joint TCI state among the separate TCI states, as described above. Accordingly, since the UL TCI state requires 6 bits used to enable expression up to 64 UL TCI states, a first bit of the TCI state ID_{U,0} field 1925 may be fixed to 0 or 1, and bits expressing an actual UL TCI state may correspond to only a total of 6 bits from a second bit to a seventh bit.

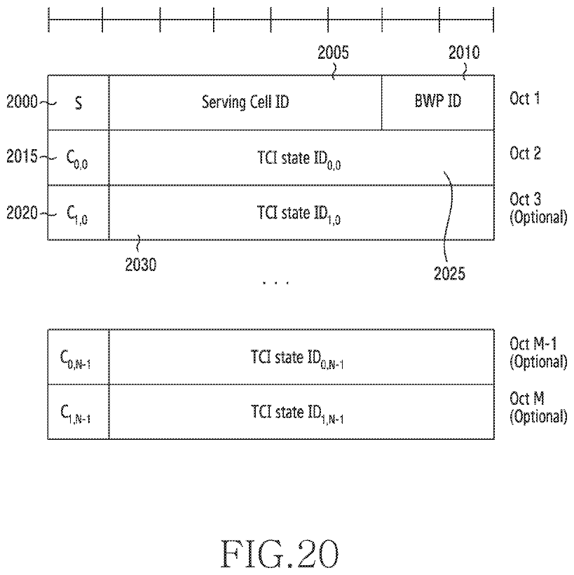

FIG. 20 illustrates a MAC-CE structure for activation and indication of a separate TCI state in a wireless communication system according to an embodiment.

Referring to FIG. 20, a serving cell ID field 2005 may indicate a serving cell ID and a BWP ID field 2010 may indicate a BWP ID. An S field 2000 may indicate the number of pieces of separate TCI state set information included in an MAC-CE. If the S field 2000 has a value of 1, the corresponding MAC-CE may indicate one separate TCI state set and may include only up to a third octet. The MAC-CE structure of FIG. 20 may indicate one separate TCI state set by using two octets, if the corresponding separate TCI state set includes a DL TCI state, a first octet of the two octets may indicate the DL TCI state, and a second octet may indicate a UL TCI state. Alternatively, this order may be changed.

If the S field 2000 has a value 0, the MAC-CE may include two or more pieces of separate TCI state set information, each codepoint of a TCI state field of DCI format 1_1 or 1_2 may activate each separate TCI state set, and up to 8 separate TCI state sets may be activated.

A C_{0,0} field 2015 may have a meaning for distinguishing whether a TCI state indicated by a TCI state ID_{0,0} field 2025 is a DL TCI state or a UL TCI state. A C_{0,0} field 2015 value of 1 may indicate a DL TCI state, the DL TCI state may be indicated through the TCI state ID_{0,0} field 2025, and a third octet may exist. In this case, if a C_{1,0} field 2020 has a value of 1, a UL TCI state may be indicated through a TCI state ID_{1,0} field 2030, and if the C_{1,0} field 2020 has a value of 0, the TCI state ID_{1,0} field 2030 may be ignored. If a C_{0,0} field 2015 has a value of 0, a UL TCI state may be indicated through the TCI state ID_{0,0} field 2025, and the third octet may not exist. This interpretation of the C_{0,0} field 2015 field and the C_{1,0} field 2020 is merely an example, and opposite interpretation of the C_{0,0} field 2015 field values of 0 and 1, or opposite interpretation of the DL TCI state and UL TCI state values is not excluded.

FIG. 20 may illustrate an example of an MAC-CE in case that a UL TCI state among separate TCI states uses the same higher-layer signaling structure as those of a DL TCI state and a joint TCI state among the separate TCI states, as described above, and accordingly, the TCI state ID_{0,0} field 2025 and the TCI state ID_{1,0} field 2030 may have a length of 7 bits to express up to 120 TCI states.

In addition, FIG. 20 may illustrate an example of an MAC CE in case that a UL TCI state among separate TCI states uses a higher-layer signaling structure different from those of a DL TCI state and a joint TCI state among the separate TCI states, as described above. Accordingly, the TCI state ID_{0,0} field 2025 may be 7 bits enabling expression of both 6 bits to express up to 64 possible UL TCI states and 7 bits to express up to 120 possible DL TCI states. If the C_{1,0} field 2015 has a value of 1 and thus the TCI state ID_{0,0} field 2025 indicates a UL TCI state, a first bit of the TCI state ID_{0,0} field 2025 may be fixed to 0 or 1, and bits expressing an actual UL TCI state may correspond to only a total of 6 bits from a second bit to a seventh bit.

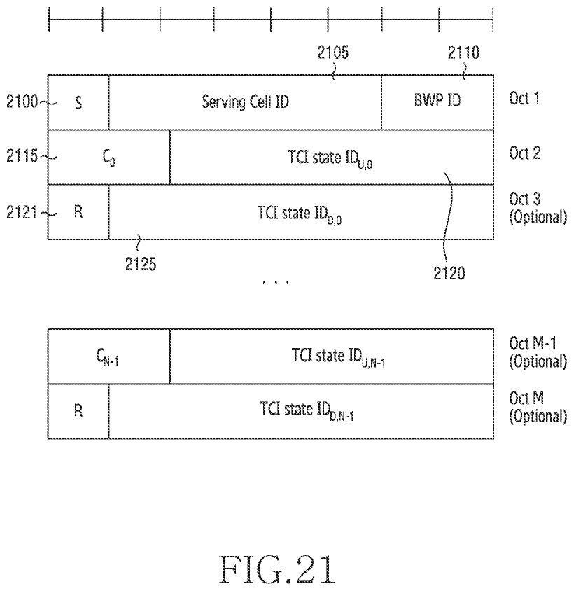

FIG. 21 illustrates a MAC-CE structure for activation and indication of a separate TCI state in a wireless communication system according to an embodiment.

Referring to FIG. 21, a serving cell ID field 2105 may indicate a serving cell ID, and a BWP ID field 2110 may indicate each of a serving cell ID and a BWP ID. An S field 2100 may indicate the number of pieces of separate TCI state set information included in an MAC-CE. If the S field 2100 has a value of 1, the corresponding MAC-CE may indicate one separate TCI state set and may include only up to a third octet. If the S field 2100 has a value 0, the MAC-CE may include two or more pieces of separate TCI state set information, each codepoint of a TCI state field of DCI format 1_1 or 1_2 may activate each separate TCI state set, and up to 8 separate TCI state sets may be activated.

A C₀ field 2115 may be a field indicating which separate TCI states are included in an indicated separate TCI state set, a C₀ field 2115 value of “00” may indicate reserve, the C₀ field 2115 value of “01” may indicate one DL TCI state, the C₀ field 2115 value of “10” may indicate one UL TCI state, and the C₀ field 2115 value of “11” may indicate one DL TCI state and one UL TCI state, but this is merely an example of interpretation of the C₀ field 2115, and the interpretation of C₀ field 2115 is not limited thereto. A TCI state ID_{U,0} field 2120 and a TCI state ID_{D,0} field 2125 may refer to a UL TCI state and a DL TCI state which may be included in a zeroth separate TCI state set so as to be indicated, respectively. If the C₀ field 2115 has a value of “01”, the TCI state ID_{D,0} field 2125 may indicate the DL TCI state, and the TCI state ID_{U,0} field 2120 may be ignored. If the C₀ field 2115 has a value of “10”, a third octet may be ignored and the TCI state ID_{U,0} field 2120 may indicate the UL TCI state. If the C₀ field 2115 has a value of “11”, the TCI state ID_{D,0} field 2125 may indicate the DL TCI state, and the TCI state ID_{U,0} field 2120 may indicate the UL TCI state. An R field 2121 may be a 1-bit reserve field that does not include indication information.

FIG. 21 may illustrate an example of an MAC CE used when a UL TCI state among separate TCI states uses a higher-layer signaling structure different from a DL TCI state and a joint TCI state among the separate TCI as described above. Accordingly, the TCI state ID_{D,0} field 2125 may use a length of 7 bits to express up to 128 TCI states, and the TCI state ID_{U,0} field 2120 may use a length of 6 bits to express up to 64 TCI states.

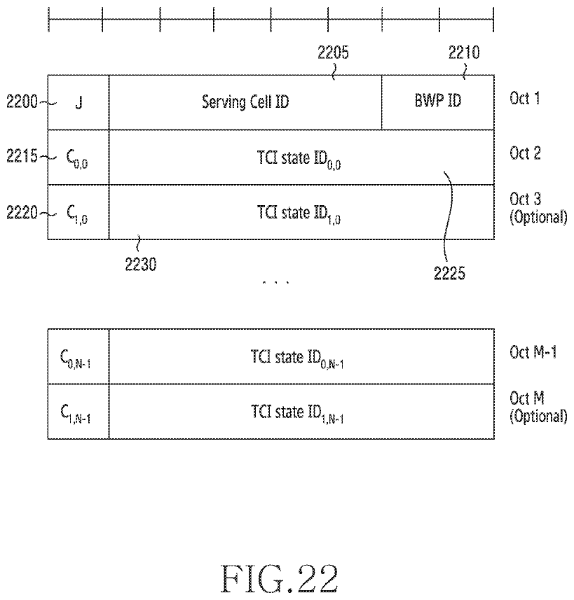

FIG. 22 illustrates a MAC-CE structure for activation and indication of a joint and separate TCI state in a wireless communication system according to an embodiment.

Referring to FIG. 22, a serving cell ID field 2205 may indicate a serving cell ID and a BWP ID field 2210 may indicate a BWP ID. A J field 2200 may indicate whether a TCI state indicated through a MAC CE is a joint TCI state or a separate TCI state set. For example, if the J field 2200 has a value of 1, the corresponding MAC-CE may indicate a joint TCI state and if the J field 2200 has a value of 0, the MAC-CE may indicate a separate TCI state set. The above-described interpretation of the J field 2200 is merely an example, and opposite interpretation is not excluded.
If the corresponding MAC-CE indicates the joint TCI state, all odd-numbered octets (a third octet, a fifth octet, . . . ) other than a first octet may be ignored. A C_{0,0} field 2215 may indicate whether the MAC-CE indicates one joint TCI state or includes two or more pieces of TCI state information, and may indicate whether each codepoint of a TCI state field of DCI format 1_1 or 1_2 activates each TCI state. If the C_{0,0} field 2215 has a value of 1, the MAC-CE may indicate one joint TCI state, and a third octet and subsequent octets may not exist. If the C_{0,0} field 2215 has a value of 0, two or more joint TCI states indicated by the MAC-CE may correspond to each codepoint of the TCI state field of DCI format 1_1 or 1_2 and may be activated. A TCI state ID_{0,0} may refer to a first indicated joint TCI state.
If the MAC-CE indicates a separate TCI state set, e.g., the C_{0,0} field 2215 may have a meaning of distinguishing whether a TCI state indicated by the TCI state ID_{0,0} field 2225 is a DL TCI state or a UL TCI state, a value of 1 thereof may indicate a DL TCI state, the DL TCI state may be indicated through the TCI state ID_{D,0} field 2225, and the third octet may exist. In this case, if a C_{1,0} field 2220 has a value of 1, a UL TCI state may be indicated through a TCI state ID_{1,0} field 2230, and if the C_{1,0} field 2220 has a value of 0, the TCI state ID_{1,0} field 2230 may be ignored. If a C_{0,0} field 2215 has a value of 0, a UL TCI state may be indicated through the TCI state ID_{0,0} field 2225, and the third octet may not exist.

FIG. 22 may illustrate an example of an MAC-CE used when a UL TCI state among separate TCI states uses the same higher-layer signaling structure as those of a DL TCI state and a joint TCI state among the separate TCI states, as described above. Accordingly, lengths of the TCI state ID_{0,0} field 2225 and the TCI state ID_{1,0} field 2230 may have 7 bits to express up to 128 TCI states.

Furthermore, FIG. 22 may illustrate an example of an MAC CE used when a UL TCI state among separate TCI states uses a higher-layer signaling structure different from a DL TCI state and a joint TCI state among the separate TCI as described above. Accordingly, the TCI state ID_{0,0} field 2225 may use 7 bits enabling expression of both 6 bits to express up to 64 possible UL TCI states and 7 bits to express up to 128 possible DL TCI states. If the C_{0,0} field 2215 has a value of 1 and thus the TCI state ID_{0,0} field 2225 indicates a UL TCI state, a first bit of the TCI state ID_{0,0} field 2225 may be fixed to 0 or 1, and bits expressing an actual UL TCI state may correspond to only a total of 6 bits from a second bit to a seventh bit.

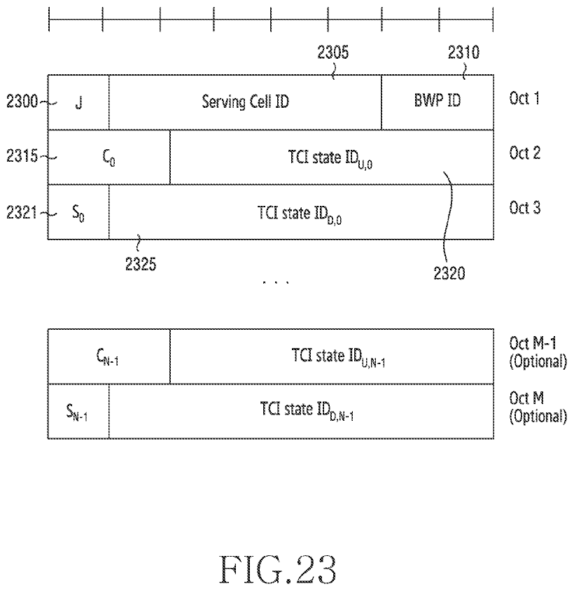

FIG. 23 illustrates a MAC-CE structure for activation and indication of a joint and separate TCI state in a wireless communication system according to an embodiment.

Referring to FIG. 23, a serving cell ID field 2305 and a BWP ID field 2310 may indicate a serving cell ID and a BWP ID, respectively. A J field 2300 may indicate whether a TCI state indicated through a MAC CE is a joint TCI state or a separate TCI state set. For example, if the J field 2300 has a value of 1, the corresponding MAC-CE may indicate a joint TCI state and if the J field 2200 has a value of 0, the MAC-CE may indicate a separate TCI state set. The above-described interpretation of the J field 2300 is merely an example, and opposite interpretation is not excluded.
If the corresponding MAC-CE indicates the joint TCI state, all even-numbered octets (a second octet, a fourth octet, . . . ) other than a first octet may be ignored. An S₀ field 2321 may indicate whether the corresponding MAC-CE indicates one joint TCI state or whether two or more TCI states correspond to each codepoint of a TCI state field of DCI format 1_1 or 1_2 and are activated. If the S₀ field 2321 has a value of 1, the MAC-CE may indicate one joint TCI state, and a third octet and subsequent octets may not exist. If the S field 2321 has a value 0, the corresponding MAC-CE may include two or more pieces of joint TCI state information, and each codepoint of the TCI state field of DCI format 1_1 or 1_2 may activate each joint TCI state. A TCI state ID_{D,0} may refer to a first indicated joint TCI state.

If the corresponding MAC-CE indicates a separate TCI state set, a C₀ field 2315 may be a field indicating which separate TCI states are included in the indicated separate TCI state set. The C₀ field 2315 values of “00”, “01”, “10”, and “11” may indicate reserve, one DL TCI state, one UL TCI state, and one DL TCI state and one UL TCI state, respectively. These values are merely examples and the disclosure is not limited by these examples. A TCI state ID_{U,0} field 2320 and a TCI state ID_{D,0} field 2325 may refer to a UL TCI state and a DL TCI state which may be included in a zeroth separate TCI state set so as to be indicated, respectively. If the C₀ field 2315 has a value of “01”, the TCI state ID_{D,0} field 2325 may indicate the DL TCI state and the TCI state ID_{U,0} field 2320 may be ignored, if the C₀ field 2315 has a value of “10”, the TCI state ID_{U,0} field 2320 may indicate the UL TCI state, and if the C0 field 2315 has a value of “11”, the TCI state ID_{D,0} field 2325 may indicate the DL TCI state, and the TCI state ID_{U,0} field 2320 may indicate the UL TCI state. If the S₀ field 2321 has a value of 1, the MAC-CE may indicate one separate TCI state set, and a fourth octet and subsequent octets may not exist. If the S₀ field 2321 has a value 0, the MAC-CE may include two or more pieces of separate TCI state set information, each codepoint of a TCI state field of DCI format 1_1 or 1_2 may activate each separate TCI state set, and up to 8 separate TCI state sets may be activated. In case that, e.g., the S₀ field 2321 has a value of 0, if C₁, . . . , C_{N-1} fields have a value of “10”, this indicates that only UL TCI states are indicated, so that a fifth octet, a seventh octet, . . . , an Mth octet may be ignored.

Alternatively, an S₀ field may indicate whether an octet for a subsequent separate TCI state set exists. For example, if the Sn field has a value of 1, a subsequent octet may not exist, and if the Sn field has a value of 0, subsequent octets including Cₙ₊₁ and TCI state ID_{U,n+1} may exist. These values of the Sn field are merely examples and the disclosure is not limited by these examples.

FIG. 23 may illustrate an example of an MAC CE in case that a UL TCI state among separate TCI states uses a higher-layer signaling structure different from a DL TCI state and a joint TCI state among the separate TCI, as described above. Accordingly, the TCI state ID_{D,0} field 2325 may use a length of 7 bits to express up to 128 TCI states, and the TCI state Duo field 2320 may use a length of 6 bits to express up to 64 TCI states.

If a UE receives a transmission/reception beam-related indication by using a joint TCI state scheme or a separate TCI state scheme through higher-layer signaling, the UE may receive a PDSCH including a MAC-CE indicating the joint TCI state or the separate TCI state from a BS so as to perform application to a transmission/reception beam. If there are two or more joint TCI states or separate TCI state sets included in the MAC-CE, as described above, from 3 ms after transmission of a PUCCH including HARQ-ACK information indicating the success or failure in reception of a corresponding PDSCH, the UE may identify that multiple joint TCI states or separate TCI state sets indicated via the MAC-CE correspond to each codepoint of the TCI state field of DCI format 1_1 or 1_2, and may activate the indicated joint TCI states or separate TCI state sets. Thereafter, the UE may receive DCI format 1_1 or 1_2 and apply one joint TCI state or separate TCI state set indicated via a corresponding TCI state field in DCI to UL transmission and DL reception beams. Here, DCI format 1_1 or 1_2 may include DL data channel scheduling information (with DL assignment) or may not include same (without DL assignment).

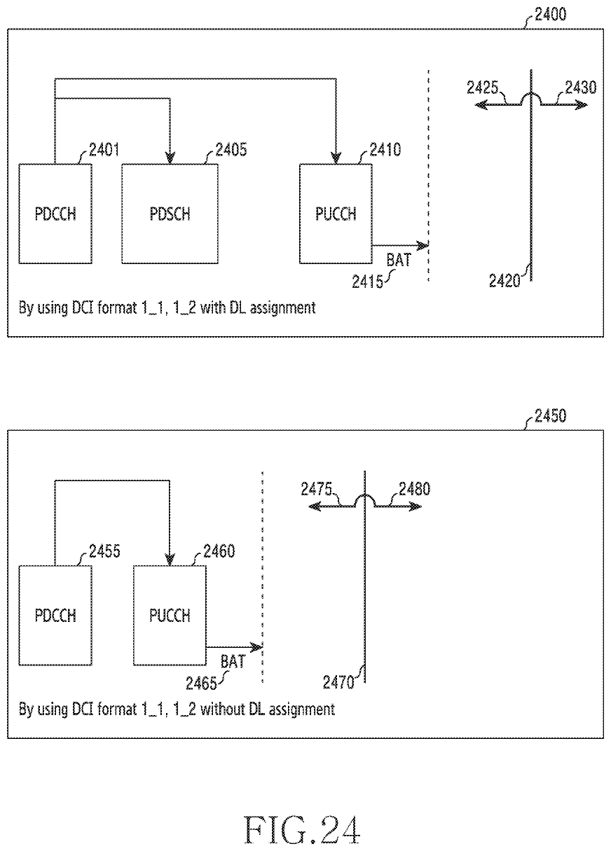

FIG. 24 illustrates a BAT using a unified TCI scheme in a wireless communication system according to an embodiment.

Referring to FIG. 24, a UE may receive DCI format 1_1 or 1_2 which includes DL data channel scheduling information (with DL assignment) or does not include DL data channel scheduling information (without DL assignment) from a BS, and apply one joint TCI state or separate TCI state set indicated via a TCI state field in corresponding DCI to UL transmission and DL reception beams.
DCI format 1_1 or 1_2 with DL assignment 2400: If the UE receives DCI format 1_1 or 1_2 including DL data channel scheduling information from the BS (2401) and indicates one joint TCI state or separate TCI state set based on a unified TCI scheme, the UE may receive a PDSCH scheduled based on the received DCI (2405), and transmit, to the BS, a PUCCH including HARQ-ACK indicating the success or failure in reception of the DCI and the PDSCH (2410). Here, the HARQ-ACK may include a meaning of the success or failure in reception of both the DCI and the PDSCH, the UE may transmit NACK if at least one of the DCI and the PDSCH cannot be received, and the UE may transmit ACK if both have been successfully received.
DCI format 1_1 or 1_2 without DL assignment 2450: If the UE receives DCI format 1_1 or 1_2 including no DL data channel scheduling information from the BS (2455) and indicates one joint TCI state or separate TCI state set based on the unified TCI scheme, the UE may assume the following for the corresponding DCI.
   CRC scrambled using CS-RNTI is included.
   Values of all bits assigned to all fields used as a redundancy version (RV) field are 1.
   Values of all bits assigned to all fields used as an MCS field are 1.
   Values of all bits assigned to all fields used as a new data indication (NDI) field are 0.
   Values of all bits assigned to an FDRA field are 0 for FDRA type 0, values of all bits assigned to the FDRA field are 1 for FDRA type 1, and if an FDRA scheme is dynamicSwitch, values of all bits assigned to the FDRA field are 0.

The UE may transmit, to the BS, a PUCCH including HARQ-ACK indicating the success or failure in reception of DCI format 1_1 or 1_2 for which the above matters have been assumed (2460).
With respect to both DCI format 1_1 or 1_2 with DL assignment 2400 and without DL assignment 2450, if a new TCI state indicated through the DCI 2401 or 2455 is the same as the TCI state previously indicated and applied to UL transmission and DL reception beams, the UE may maintain the previously applied TCI state. If the new TCI state is different from the previously indicated TCI state, the UE may determine that a time point of applying the joint TCI state or separate TCI state set, which may be indicated from the TCI state field included in the DCI, is applied (interval of 2430 or 2480) from a start point 2420 or 2470 of a first slot after a BAT 2415 or 2465 subsequent to PUCCH transmission, and may use the previously indicated TCI-state until the interval 2425 or 2475 before the start point 2420 or 2470 of the slot.
With respect to both DCI format 1_1 or 1_2 with DL assignment 2400 and without DL assignment 2450, a BAT is a specific number of OFDM symbols and may be configured via higher-layer signaling based on UE capability report information. The BAT and a numerology for the first slot after the BAT may be determined based on a smallest numerology among all cells to which the joint TCI state or separate TCI state set indicated through the DCI is applied.

The UE may apply one joint TCI state indicated through the MAC-CE or DCI to reception of CORESETs linked to all UE-specific search spaces, reception of a PDSCH scheduled via a PDCCH transmitted from a corresponding CORESET, transmission of a PUSCH, and transmission of all PUCCH resources.

If one separate TCI state set indicated through the MAC-CE or DCI includes one DL TCI state, the UE may apply the one separate TCI state set to reception of CORESETs linked to all UE-specific search spaces and reception of a PDSCH scheduled via a PDCCH transmitted from a corresponding CORESET, and based on a previously indicated UL TCI state, may apply same to all PUSCH and PUCCH resources.

In case that one separate TCI state set indicated via the MAC-CE or DCI includes one UL TCI state, the UE may apply the separate TCI state set to all PUSCH and PUCCH resources, and based on the previously indicated DL TCI state, may apply same to reception of CORESETs linked to all UE-specific search spaces and reception of a PDSCH scheduled via a PDCCH transmitted from a corresponding CORESET.

If one separate TCI state set indicated through the MAC-CE or DCI includes one DL TCI state and one UL TCI state, the UE may apply the DL TCI state to reception of CORESETs linked to UE-specific search spaces and reception of a PDSCH scheduled via a PDCCH transmitted from a corresponding CORESET, and may apply the UL TCI state to all PUSCH and PUCCH resources.

A portion or the entirety of the MAC CE according to the aforementioned embodiments in FIGS. 15 to 23 may be combined with a portion or the entirety of one or more embodiments and performed.

In the following description of the disclosure, for convenience of description, a cell, a transmission point, a panel, a beam, a transmission direction, or/and the like, which may be distinguishable through a higher layer/L1 parameter, such as TCI state or spatial relation information, or an indicator, such as a cell ID, a TRP ID, and a panel ID, may be described as a TRP, a beam, or a TCI state in a unified manner. Therefore, in actual application, a TRP, a beam, or a TCI state may be appropriately replaced with one of the above terms.

Hereinafter, in case of determining whether to apply cooperative communication, the UE may use various methods by which PDCCH(s) allocating PDSCHs to which cooperative communication is applied have specific formats, PDCCH(s) allocating PDSCHs to which cooperative communication is applied include a specific indicator informing of whether cooperative communication is applied, PDCCH(s) allocating PDSCHs to which cooperative communication is applied are scrambled by a specific RNTI, or the application of cooperative communication to a specific section indicated by a higher layer is assumed. Hereinafter, for convenience of description, reception of, by the UE, a PDSCH to which cooperative communication is applied based on conditions similar to the above conditions is referred to as an NC-JT case.

In the following description, a higher-layer signaling may be signaling corresponding to at least one or a combination of one or multiple of signalings below.
MIB
SIB or SIB X (X=1, 2, . . . )
RRC
MAC CE

In addition, L1 signaling may be signaling corresponding to at least one of signaling methods using the physical layer channels or signalings below or a combination of one or multiple of the methods.
PDCCH
DCI
UE-specific DCI
Group common DCI
Common DCI
Scheduling DCI (e.g., DCI used for scheduling DL or UL data)
Non-scheduling DCI (e.g., DCI not for scheduling DL or UL data)
PUCCH
UCI

Herein, determining the priority between A and B may refer to selecting the one having a higher priority according to a predetermined priority rule and performing an operation corresponding thereto, or omitting or dropping an operation corresponding to the one having a lower priority, etc.

Hereinafter, the term “slot” is a general term that may refer to a specific time unit corresponding to a TTI, and specifically, a slot may refer to a slot used in a 5G NR system and a slot or subframe used in a 4G LTE system, as well.

### First Embodiment: Multi-TCI State Activation and Indication Method Based on Unified TCI Scheme

In accordance with an embodiment of the disclosure, a method for indicating and activating a multi-TCI state based on a unified TCI scheme is provided. A multi-TCI state indication and activation method may refer to a case in which the number of indicated joint TCI states is extended to two or more and a case in which each of a DL TCI state and a UL TCI state included in one separate TCI state set is expanded to two or more. If one separate TCI state set may include up to two DL TCI states and up to two UL TCI states, a total of 8 combinations of DL TCI states and UL TCI states that one separate TCI state set may have may be possible ({DL,UL}={0,1}, {0,2}, {1,0}, {1,1}, {1,2}, {2,0}, {2,1}, {2,2}, wherein numbers indicate the number of TCI states).

If the UE is indicated with the multi-TCI state based on the MAC-CE from the BS, the UE may receive two or more joint TCI states or one separate TCI state set from the BS through the corresponding MAC-CE. The BS may schedule reception of a PDSCH including the MAC-CE for the UE through a PDCCH, and from 3 ms after transmission of a PUCCH including HARQ-ACK information indicating the success or failure of reception of the PDSCH including the MAC-CE, the UE may determine an UL transmission beam or transmission filter and a DL reception beam or reception filter, based on the indicated two or more joint TCI states or one separate TCI state set.

If the UE is indicated with the multi-TCI state based on DCI format 1_1 or 1_2 from the BS, each codepoint of one TCI state field in corresponding DCI format 1_1 or 1_2 may indicate two or more joint TCI states or two or more separate TCI state sets. In this case, the UE may receive the MAC-CE from the BS and activate two or more joint TCI states or two or more separate TCI state sets corresponding to each codepoint of one TCI state field in corresponding DCI format 1_1 or 1_2. The BS may schedule reception of a PDSCH including the corresponding MAC-CE for the UE through a PDCCH, and the UE may activate TCI state information included in the MAC-CE from 3 ms after transmission of a PUCCH including HARQ-ACK information indicating the success or failure of reception of the PDSCH including the corresponding MAC-CE.

If the UE is indicated with the multi-TCI state based on DCI format 1_1 or 1_2 from the BS, two or more TCI state fields may exist in corresponding DCI format 1_1 or 1_2, and one of two or more joint TCI states or two or more separate TCI state sets may be indicated based on each TCI state field. Here, the UE may receive the MAC-CE from the BS and activate a joint TCI state or a TCI state set corresponding to each codepoint of two or more TCI state fields in corresponding DCI format 1_1 or 1_2. The BS may schedule reception of the PDSCH including the MAC-CE for the UE through the PDCCH. The UE may activate TCI state information included in the MAC-CE from 3 ms after transmission of the PUCCH including HARQ-ACK information indicating the success or failure of reception of the PDSCH including the corresponding MAC-CE. The UE may be configured for the presence or absence of one or more additional TCI state fields through higher-layer signaling, the bit length of the additional TCI state fields may be the same as that of an existing TCI state field, or the length may be adjusted based on higher-layer signaling.

The UE may receive a transmission/reception beam-related indication in a unified TCI scheme by using one scheme among the joint TCI state and the separate TCI state configured from the BS. The UE may be configured for using one of the joint TCI state or the separate TCI state, from the BS through higher layer signaling. With respect to the separate TCI state indication, the UE may be configured through higher-layer signaling so that a bit length of the TCI state field in DCI format 1_1 or 1_2 is up to 4.

The MAC-CE used to activate or indicate the multiple joint TCI state and the separate TCI state described above may exist for each of the joint and separate TCI state schemes, and a TCI state may be activated or indicated based on one of the joint TCI state scheme or the separate TCI state scheme by using one MAC-CE and the MAC-CE used for a MAC-CE-based indication scheme and a MAC-CE-based activation scheme may share one MAC-CE structure and may use an individual MAC-CE structure. Based on drawings to be described later, various MAC-CE structures for activation and indication of multiple joint or separate TCI states may be considered. In the drawings to be described later, for convenience of explanation, a case in which two TCI states are activated or indicated is considered, but the disclosure may be applied to a case of three or more TCI states in a similar manner.

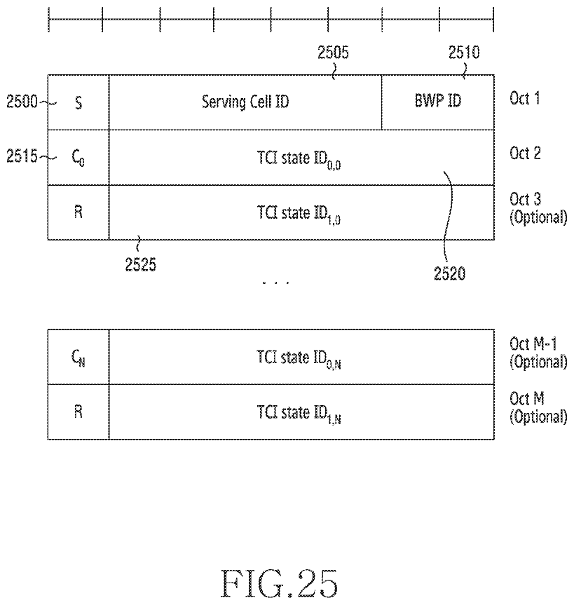

FIG. 25 illustrates a MAC-CE structure for activation and indication of multiple joint TCI states in a wireless communication system according to an embodiment.

Referring to FIG. 25, a serving cell ID field 2505 may indicate a serving cell ID and a BWP ID field 2510 may indicate a BWP ID. An R field may be a 1-bit reserve field that does not include indication information. An S field 2500 may indicate the number of pieces of joint TCI state set information included in an MAC-CE. If the S field 2500 has a value of 1, the corresponding MAC-CE may indicate one or two joint TCI states and may have a length of only up to a third octet. In this case, if a C₀ field 2515 has a value of 0, a third octet may not exist, and one joint TCI state may be indicated via a TCI state ID_{0,0} field 2520, and if the C0 field 2515 has a value of 1, the third octet may exist, and two joint TCI states may be indicated through the TCI state ID_{0,0} field 2520 and a TCI state ID_{1,0} field 2525, respectively.

If the S field 2500 has a value of 0, the MAC-CE may activate one or two joint TCI states corresponding to each codepoint of the TCI state field of DCI format 1_1 or 1_2, or may activate one joint TCI state corresponding to each codepoint of two TCI state fields of DCI format 1_1 or 1_2, and joint TCI states for up to 8 codepoints may be activated. If one or two joint TCI states are activated for one codepoint of one TCI state field, a TCI state ID_{0,Y} field and a TCI state ID_{1,Y} field may refer to first and second joint TCI states among two joint TCI states activated at a Y-th codepoint of the TCI state field, respectively. If one joint TCI state is activated for one codepoint of two TCI state fields, the TCI state ID_{0,Y} field and the TCI state IDLY field may refer to respective joint TCI states activated at the Y-th codepoint of the first and second TCI state fields.

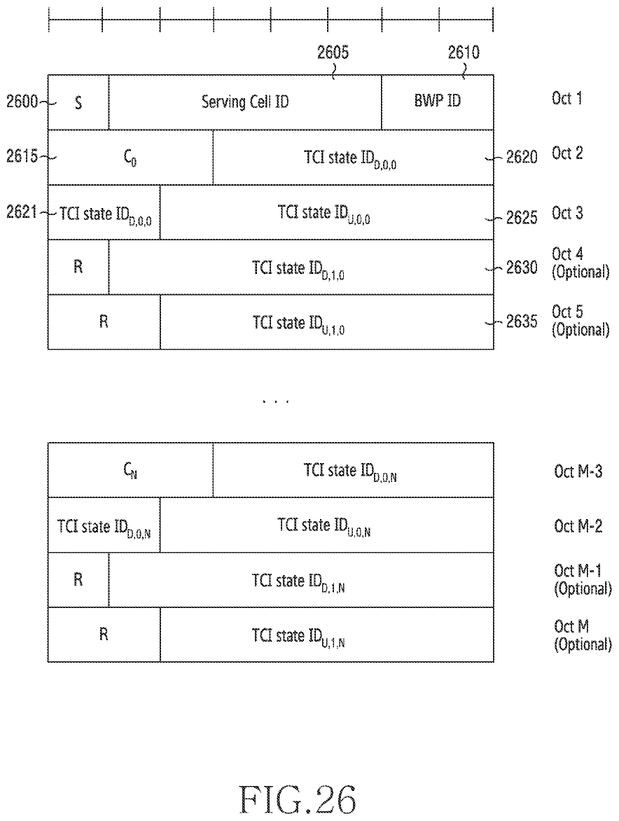

FIG. 26 illustrates a MAC-CE structure for activation and indication of multiple separate TCI states in a wireless communication system according to an embodiment.

Referring to FIG. 26, a serving cell ID field 2605 may indicate a serving cell ID and a BWP ID field 2610 may indicate a BWP ID. An R field may be a 1-bit reserve field that does not include indication information. An S field 2600 may indicate the number of pieces of separate TCI state set information included in an MAC-CE. If the S field 2600 has a value of 1, the corresponding MAC-CE may indicate one separate TCI state set and may include only up to a fifth octet. If the S field 2600 has a value of 0, the MAC-CE may include information on multiple separate TCI state sets, the MAC-CE may activate one separate TCI state set corresponding to each codepoint of a TCI state field of DCI format 1_1 or 1_2 or may activate one separate TCI state set corresponding to each codepoint of two TCI state fields of DCI format 1_1 or 1_2, and may activate, as described above, separate TCI states for up to 8 or 16 codepoints by higher-layer signaling.

In the MAC-CE structure of FIG. 26, every 4 octets, from a second octet, may correspond to one separate TCI state set. For example, a C₀ field 2615 may have a total of 8 values from “000” to “111”, and as described above, the values may correspond to 8 cases that one separate TCI state set may have, respectively.
The case in which the C₀ field has a value of “000” indicates that one separate TCI state set includes one UL TCI state, TCI state ID_{D,0,0} fields 2620 and 2621 may be ignored, and a TCI state ID_{U,0,0} field 2625 may include one piece of UL TCI state information. In addition, fourth and fifth octets may be ignored.
The case in which the C₀ field has a value of “001” indicates that one separate TCI state set includes two UL TCI states, the TCI state ID_{D,0,0} fields 2620 and 2621 may be ignored, and the TCI state ID_{U,0,0} field 2625 may include first UL TCI state information among the two UL TCI states. In addition, the fourth octet may be ignored, and a TCI state ID_{U,1,0} field 2635 may include second UL TCI state information among the two UL TCI states.
The case in which the C₀ field has a value of “010” indicates that one separate TCI state set includes one DL TCI state, the TCI state ID_{D,0,0} fields 2620 and 2621 may include one piece of DL TCI state information, and the TCI state ID_{U,0,0} fields 2625 and the fourth and fifth octets may be ignored.
The case in which the C₀ field has a value of “011” indicates that one separate TCI state set includes one DL TCI state and one UL TCI state, TCI state ID_{D,0,0} fields 2620 and 2621 may have one piece of DL TCI state information, and a TCI state ID_{U,0,0} field 2625 may include one piece of UL TCI state information. The fourth and fifth octets may be ignored.
The case in which the C₀ field has a value of “100” indicates that one separate TCI state set includes one DL TCI state and two UL TCI states, TCI state ID_{D,0,0} fields 2620 and 2621 may have one piece of DL TCI state information, and a TCI state ID_{U,0,0} field 2625 may include first UL TCI state information among the two UL TCI states. In addition, the fourth octet may be ignored, and a TCI state ID_{U,1,0} field 2635 may include information on a second UL TCI state among the two UL TCI states.
The case in which the C₀ field has a value of “101” indicates that one separate TCI state set includes two DL TCI states, the TCI state ID_{D,0,0} fields 2620 and 2621 may include first DL TCI state information among the two DL TCI states, and the TCI state ID_{U,0,0} fields 2625 and the fifth octets may be ignored. The TCI state ID_{D,1,0} field 2630 may include second DL TCI state information among the two DL TCI states.
The case in which the C₀ field has a value of “110” indicates that one separate TCI state set includes two DL TCI states and one UL TCI state, the TCI state ID_{D,0,0} fields 2620 and 2621 may include first DL TCI state information among the two DL TCI states, the TCI state ID_{U,0},o field 2625 may include one piece of UL TCI state information, the TCI state ID_{D,1,0} field 2630 may include second DL TCI state information among the two DL TCI states, and the fifth octet may be ignored.
The case in which the C₀ field has a value of “111” indicates that one separate TCI state set includes two DL TCI states and two UL TCI states, the TCI state ID_{D,0,0} fields 2620 and 2621 may include first DL TCI state information among the two DL TCI states, the TCI state ID_{U,0},o field 2625 may include first UL TCI state information among the two UL TCI states, the TCI state ID_{D,1,0} field 2630 may include second DL TCI state information among the two DL TCI states, and the TCI state ID_{U,1,0} field 2635 may include second UL TCI state information among the two UL TCI states.

FIG. 26 may illustrate an example of an MAC CE used when a UL TCI state among separate TCI states uses a higher-layer signaling structure different from those of a DL TCI state and a joint TCI state among the separate TCI as described above. Accordingly, since a UL TCI state requires 6 bits enabling expression of up to 64 UL TCI states, the TCI state ID_{D,0,0} to TCI state ID_{D,1,N} fields expressing a DL TCI state may be expressed using 7 bits, whereas the TCI state ID_{U,0,0} to TCI state ID_{U,1,N} fields expressing the UL TCI state may be expressed using 6 bits.

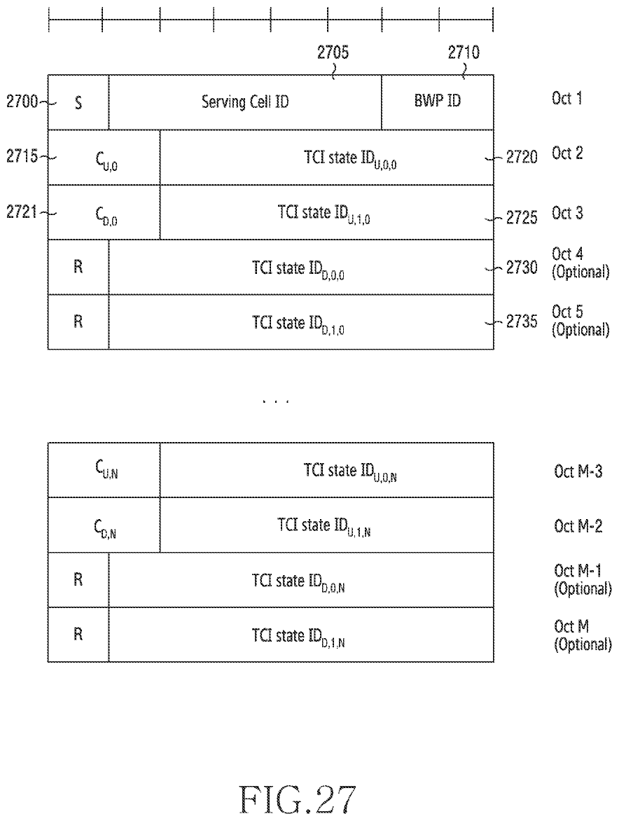

FIG. 27 illustrates a MAC-CE structure for activation and indication of multiple separate TCI states in a wireless communication system according to an embodiment.

Referring to FIG. 27, a serving cell ID field 2705 may indicate a serving cell ID and a BWP ID field 2710 may indicate a BWP ID. An R field may be a 1-bit reserve field that does not include indication information. An S field 2700 may indicate the number of pieces of separate TCI state set information included in an MAC-CE. If the S field 2700 has a value of 1, the corresponding MAC-CE may indicate one separate TCI state set and may have a length of only up to a fifth octet. If the S field 2700 has a value of 0, the MAC-CE may include information on multiple separate TCI state sets, the MAC-CE may activate one separate TCI state set corresponding to each codepoint of a TCI state field of DCI format 1_1 or 1_2 or may activate one separate TCI state set corresponding to each codepoint of two TCI state fields of DCI format 1_1 or 1_2, and may activate, as described above, separate TCI state sets corresponding to 8 or 16 codepoints by higher-layer signaling.

In the MAC-CE structure of FIG. 27, every 4 octets, from a second octet, may correspond to one separate TCI state set. A C_{U,0} field 2715 and a C_{D,0} field 2721 may refer to the number of UL TCI states and DL TCI states included in one separate TCI state set, respectively, and may have meanings for each codepoint as follows.
The C_{U,0} field having a value of “00” indicates including no UL TCI state, and thus a TCI state ID_{U,0,0} 2720 and a TCI state ID_{U,1,0} 2725 may be ignored.
The case in which the C_{U,0} field has a value of “01” indicates including one UL TCI state, and thus the TCI state ID_{U,0,0} 2720 may include one piece of UL TCI state information and the TCI state ID_{U,1,0} 2725 may be ignored.
The case in which the C_{U,0} field has a value of “10” indicates including two UL TCI states, and thus the TCI state ID_{U,0,0} 2720 may include first UL TCI state information among the two UL TCI states, and the TCI state ID_{U,1,0} 2725 may include second UL TCI state information among the two UL TCI states.
The case in which the C_{U,0} field has a value of “00” indicates including no DL TCI state, and thus fourth and fifth octets may be ignored.
The case in which the C_{U,0} field has a value of “01” indicates including one DL TCI state, and thus the TCI state ID_{U,0,0} 2730 may include one piece of DL TCI state information, and the fifth octet may be ignored.
The case in which the C_{U,0} field has a value of “10” indicates including two DL TCI states, and thus the TCI state ID_{D,0,0} 2730 may include first DL TCI state information among the two DL TCI states, and the TCI state ID_{D,1,0} 2735 may include second DL TCI state information among the two DL TCI states.

FIG. 27 may illustrates an example of the MAC-CE used when a UL TCI state among separate TCI states uses a higher-layer signaling structure different from that of a DL TCI state and of a joint TCI state among the separate TCI states, as described above, and accordingly, since a UL TCI state requires 6 bits enabling expression of up to 64 UL TCI states, the TCI state JIDDA® to TCI state ID_{D,1,N} fields expressing a DL TCI state may be expressed using 7 bits, whereas the TCI state ID_{U,0,0} to TCI state ID_{U,1,N} fields expressing the UL TCI state may be expressed using 6 bits.

A portion or the entirety of the MAC CE according to the aforementioned embodiments in FIG. 25 to FIG. 27 may be combined with a portion or the entirety of one or more embodiments and performed.

### Second Embodiment: Additional Single and Multi-TCI State Activation and Indication Method Based on Unified TCI Scheme

In accordance with an embodiment of the disclosure, an additional single and multi-TCI state activation and indication method based on the unified TCI scheme is provided.

A UE may be scheduled with a PDSCH including a MAC-CE which may include at least one combination of various MAC-CE structures described below from a BS, and may interpret each codepoint of a TCI state field in DCI format 1_1 or 1_2 after slot 3 for transmitting HARQ-ACK for the corresponding PDSCH, based on information in the MAC-CE received from the BS. That is, the UE may activate each entry of the MAC-CE received from the BS at each codepoint of the TCI state field in DCI format 1_1 or 1_2.

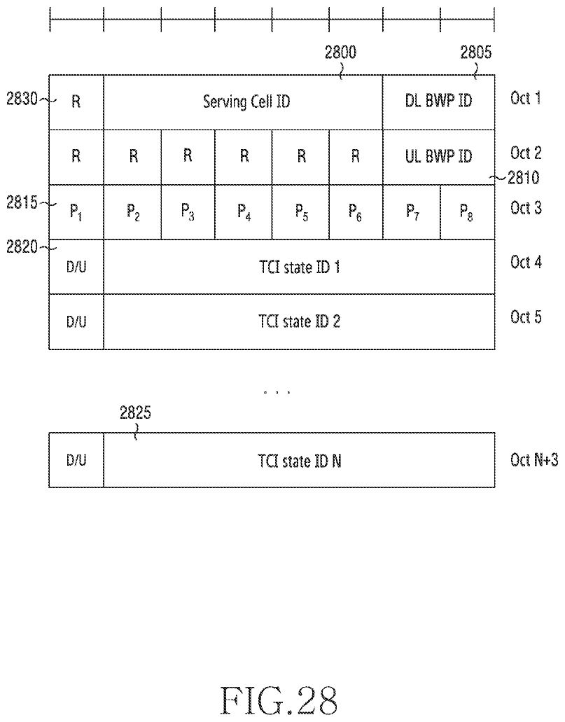

FIG. 28 illustrates a MAC-CE structure for activation and indication of a joint TCI state or separate DL or UL TCI state in a wireless communication system according to an embodiment.

Referring to FIG. 28, each field in the corresponding MAC-CE structure may be as follows:
Serving Cell ID 2800: This field may indicate a serving cell to which a corresponding MAC-CE is to be applied. This field may have a length of 5 bits. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which is higher layer signaling, the corresponding MAC-Ce may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4 including the serving cell indicated by this field.
DL BWP ID 2805: This field may indicate a DL BWP to which a corresponding MAC-CE is applied, and a meaning of each codepoint of this field may correspond to each codepoint of a BWP indicator in DCI. This field may have a length of 2 bits.
UL BWP ID 2810: This field may indicate a UL BWP to which a corresponding MAC-CE is applied, and a meaning of each codepoint of this field may correspond to each codepoint of a BWP indicator in DCI. This field may have a length of 2 bits.
Pᵢ 2815: This field may indicate whether each codepoint of a TCI state field in DCI format 1_1 or 1_2 has multiple TCI states or one TCI state. The case in which Pᵢ has a value of 1 indicates that a corresponding i-th codepoint has multiple TCI states, which may indicate that the corresponding codepoint may include a separate DL TCI state and a separate UL TCI state. The case in which Pᵢ has a value of 0 indicates that a corresponding i-th codepoint has a single TCI state, which may indicate that the corresponding codepoint may include one of a joint TCI state, or a separate DCI TCI state or separate UL TCI state.
D/U 2820: This field may indicate whether a TCI state ID field in the same octet is a joint TCI state or separate DL TCI state, or a separate UL TCI state. If this field is 1, TCI state ID fields in the same octet may be a joint TCI state or a separate DL TCI state, and if this field is 0, TCI state ID fields in the same octet may be a separate UL TCI state.
TCI state ID 2825: This field may indicate a TCI state which may be identified with higher layer signaling TCI-StateId. If the D/U field is configured to be 1, this field may be used for expressing TCI-StateId which may be expressed using 7 bits. If the D/U field is configured to be 0, an MSB of this field may be considered as a reserved bit and the remaining six bits may be used for expressing higher layer signaling UL-TCIState-Id. In case that a maximum number of TCI state which may be activated may be 8 for a joint TCI state, and 16 for a DL or UL TCI state.
R: This field indicates a reserved bit and may be configured to be 0.

With respect to the MAC-CE structure of FIG. 28 described above, regardless of configuring unifiedTCI-StateType-r17 in MIMOparam-r17 within higher layer signaling ServingCellConfig as joint or separate, the UE may include the third octet including Pᵢ, P₂, . . . , and P₈ fields in the corresponding MAC-CE structure. In this case, regardless of higher layer signaling configured from the BS, the UE may perform TCI state activation by using a fixed MAC-CE structure.

As another example, with respect to the MAC-CE structure of FIG. 28 described above, in case that unifiedTCI-StateType-r17 in MIMOparam-r17 in higher layer signaling ServingCellConfig is configured as joint, the UE may omit the third octet including Pᵢ, P2, . . . , and P₈ fields within FIG. 28. In this case, the UE may save a payload of a corresponding MAC-CE up to 8 bits according to higher layer configured from the BS. Furthermore, all D/U fields located in first bits from the fourth octet may be considered as R fields and the R fields may be configured to be 0 bits.

In case that the UE is configured with two different CORESETPoolIndex via higher layer signaling and configured with DLorJointTCIState or UL-TCIState, which is higher layer signaling, the UE and the BS may expect that an R field 2830 existing in the first octet is interpreted as a field indicating CORESET Pool ID in FIG. 28 which corresponds to one of MAC-CE structures indicating unified TCI state activation. In case that corresponding CORESET Pool ID is configured to be 0, the UE may consider that a corresponding MAC-CE can be applied to each codepoint of TCI state fields in a PDCCH transmitted in CORESET corresponding to CORESETPoolIndex 0. In case that corresponding CORESET Pool ID is configured to be 1, the UE may consider that a corresponding MAC-CE can be applied to each codepoint of TCI state fields in a PDCCH transmitted in CORESET corresponding to CORESETPoolIndex 1.

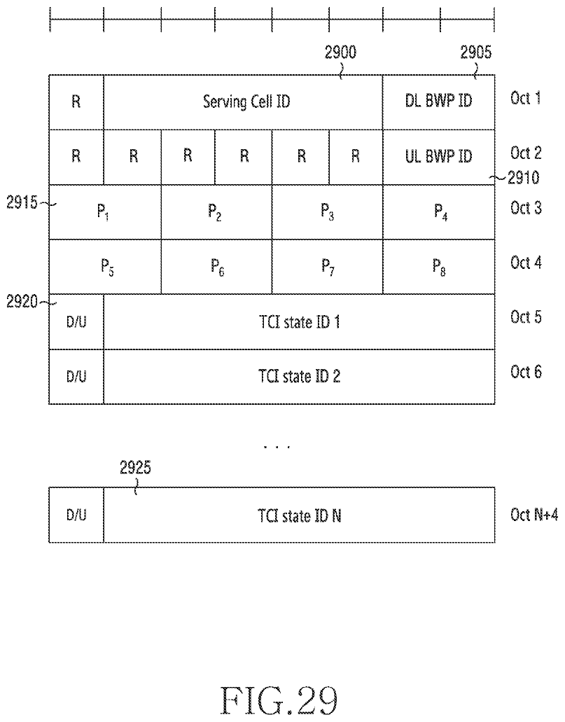

FIG. 29 illustrates a MAC-CE structure for activation and indication of multiple joint TCI states, or separate DL or UL TCI states in a wireless communication system according to an embodiment.

Referring to FIG. 29, each field in the corresponding MAC-CE structure may be as follows:
Serving Cell ID 2900: This field may indicate a serving cell to which a corresponding MAC-CE is to be applied. This field may have a length of 5 bits. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which is higher layer signaling, the corresponding MAC-Ce may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4 including the serving cell indicated by this field.
DL BWP ID 2905: This field may indicate a DL BWP to which a corresponding MAC-CE is applied, and a meaning of each codepoint of this field may correspond to each codepoint of a BWP indicator in DCI. This field may have a length of 2 bits.
UL BWP ID 2910: This field may indicate a UL BWP to which a corresponding MAC-CE is applied, and a meaning of each codepoint of this field may correspond to each codepoint of a BWP indicator in DCI. This field may have a length of 2 bits.
Pᵢ 2915: This field may indicate whether each codepoint of a TCI state field in DCI format 1_1 or 1_2 has multiple TCI states or one TCI state.
   In case that a UE can configure unifiedTCI-StateType-r17 in MIMOparam-r17 within higher layer signaling ServingCellConfig as one of joint and separate, regardless of which of two pieces of configuration information is configured, this field may be interpreted as follows.
      The case in which Pᵢ has a value of “00” indicates that a corresponding i-th codepoint has a single TCI state, which may indicate that the corresponding codepoint may include one of a joint TCI state, or a separate DCI TCI state or separate UL TCI state.
      The case in which Pᵢ has a value of “01” indicates that a corresponding i-th codepoint has two TCI states, which may indicate that the corresponding codepoint may include one of two joint TCI states, one separate DL TCI state, and one separate UL TCI state, or two separate DL TCI states, or two separate UL TCI states.
      The case in which Pᵢ has a value of “10” indicates that a corresponding i-th codepoint has three TCI states, which may indicate that the corresponding codepoint may include one separate DL TCI state and two separate UL TCI states, or two separate DL TCI states and one separate UL TCI state.
      The case in which Pᵢ has a value of “11” indicates that a corresponding i-th codepoint has four TCI states, which may indicate that the corresponding codepoint may include two separate DL TCI states and two separate UL TCI states.
   In case that a UE can configure unifiedTCI-StateType-r17 in MIMOparam-r17 within higher layer signaling ServingCellConfig as one of joint, separate, and mixed mode, regardless of which of possible configuration values is configured, this field may be interpreted as follows. The mixed mode may be expressed as one configuration value having a meaning that a general mixed mode of a joint TCI state and a separate DL or UL TCI state is possible, and expressed with multiple configuration value, such as “1joint+1DL” and “1joint+1UL”, and configured to indicate a specific combination of a specific number of TCI states and a specific number of separate DL or UL TCI states.
      The case in which Pᵢ has a value of “00” indicates that a corresponding i-th codepoint has a single TCI state, which may indicate that the corresponding codepoint may include one of a joint TCI state, or a separate DCI TCI state or separate UL TCI state.
      The case in which Pᵢ has a value of “01” indicates that a corresponding i-th codepoint has two TCI states, which may indicate that the corresponding codepoint may include one of two joint TCI states, one joint TCI state and one separate DL TCI state, one joint TCI state and one separate UL TCI state, one separate DL TCI state and one separate UL TCI state, two separate DL TCI states, or two separate UL TCI state. If the UE is configured with a value having a meaning that a general mixed mode, such as the mixed mode, of a joint TCI state and a separate DL or UL TCI state for unifiedTCI-StateType-r17 in MIMOparam-r17 within higher layer signaling ServingCellConfig is possible, both the one joint TCI state and one separate DL TCI state, and the one joint TCI state and one separate UL TCI state described above may be possible If the UE is configured with one of “1joint+1DL” and “1joint+1UL” for unifiedTCI-StateType-r17 in MIMOparam-r17 within higher layer signaling ServingCellConfig, from among the one joint TCI state and one separate DL TCI state, and the one joint TCI state and one separate UL TCI state described above, only a case corresponding to a unifiedTCI-StateType-r17 configuration value may be possible.
      The case in which Pᵢ has a value of “10” indicates that a corresponding i-th codepoint has three TCI states, which may indicate that the corresponding codepoint may include one separate DL TCI state and two separate UL TCI states, or two separate DL TCI states and one separate UL TCI state.
      The case in which Pᵢ has a value of “11” indicates that a corresponding i-th codepoint has four TCI states, which may indicate that the corresponding codepoint may include two separate DL TCI states and two separate UL TCI states.
   The corresponding field may have a length of 2 bits.
D/U 2920: This field may indicate whether a TCI state ID field in the same octet is a joint TCI state or separate DL TCI state, or a separate UL TCI state. If this field is 1, TCI state ID fields in the same octet may be a joint TCI state or a separate DL TCI state, and if this field is 0, TCI state ID fields in the same octet may be a separate UL TCI state.
TCI state ID 2925: This field may indicate a TCI state which may be identified with higher layer signaling TCI-StateId. If the D/U field is configured to be 1, this field may be used for expressing TCI-StateId which may be expressed using 7 bits. If the D/U field is configured to be 0, an MSB of this field may be considered as a reserved bit and the remaining six bits may be used for expressing higher layer signaling UL-TCIState-Id. In case that a maximum number of TCI state which may be activated may be 8 for a joint TCI state, and 16 for a DL or UL TCI state.
R: This field indicates a reserved bit and may be configured to be 0.

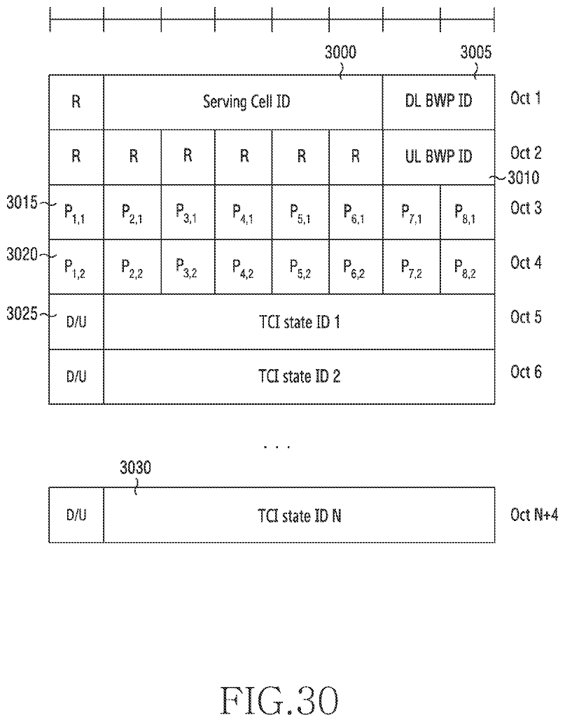

FIG. 30 illustrates a MAC-CE structure for activation and indication of multiple joint TCI states, or separate DL or UL TCI states in a wireless communication system according to an embodiment.

Referring to FIG. 30, each field in the corresponding MAC-CE structure may be as follows:
Serving Cell ID 3000: This field may indicate a serving cell to which a corresponding MAC-CE is to be applied. This field may have a length of 5 bits. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which is higher layer signaling, the corresponding MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4 including the serving cell indicated by this field.
DL BWP ID 3005: This field may indicate a DL BWP to which a corresponding MAC-CE is applied, and a meaning of each codepoint of this field may correspond to each codepoint of a BWP indicator in DCI. This field may have a length of 2 bits.
UL BWP ID 3010: This field may indicate a UL BWP to which a corresponding MAC-CE is applied, and a meaning of each codepoint of this field may correspond to each codepoint of a BWP indicator in DCI. This field may have a length of 2 bits.
P_{i,1} 3015 and P_{i,2} 3020: These two fields may indicate whether each codepoint of a TCI state field in DCI format 1_1 or 1_2 has multiple TCI states or one TCI state.
   With respect to the case in which a UE can configure unifiedTCI-StateType-r17 in MIMOparam-r17 within higher layer signaling ServingCellConfig as one of joint and separate, or as one of joint, separate, and mixed mode, when higher layer signaling unifiedTCI-StateType-r17 is configured as joint, the fourth octet including P_{1,2}, P_{2,2}, . . . , and P_{8,2} fields may be omitted and only P_{i,1} may be interpreted as follows. The mixed mode may be expressed as one configuration value having a meaning that a general mixed mode of a joint TCI state and a separate DL or UL TCI state is possible, and expressed with multiple configuration value, such as “1joint+1DL” and “1joint+1UL” and configured to indicate a specific combination of a specific number of TCI states and a specific number of separate DL or UL TCI states.
      The case in which P_{i,1} has a value of “0” indicates that a corresponding i-th codepoint has one TCI state, which may indicate that the corresponding codepoint includes one joint TCI state.
      The case in which P_{i,1} has a value of “1” indicates that a corresponding i-th codepoint has two TCI states, which may indicate that the corresponding codepoint includes two joint TCI states.
   With respect to the case in which a UE can configure unifiedTCI-StateType-r17 in MIMOparam-r17 within higher layer signaling ServingCellConfig as one of joint and separate, or as one of joint, separate, and mixed mode, when higher layer signaling unifiedTCI-StateType-r17 is configured as separate, the UE may consider P_{i,1} of a third octet and P_{i,2} of a fourth octet as one field and interpret as follows. The mixed mode may be expressed as one configuration value having a meaning that a general mixed mode of a joint TCI state and a separate DL or UL TCI state is possible, and expressed with multiple configuration value, such as “1joint+1DL” and “1joint+1UL”, and configured to indicate a specific combination of a specific number of TCI states and a specific number of separate DL or UL TCI states.
      The case in which P_{i,1} has a value of “0” and P_{i,2} has a value of “0” indicates that a corresponding i-th codepoint has a single TCI state, which may indicate that the corresponding codepoint may include one of a separate DL TCI state or a separate UL TCI state.
      The case in which P_{i,1} has a value of “0” and P_{i,2} has a value of “1” indicates that a corresponding i-th codepoint has two TCI states, which may indicate that the corresponding codepoint may include one of one separate DL TCI state, and one separate UL TCI state, or two separate DL TCI states, or two separate UL TCI states.
      The case in which P_{i,1} has a value of “1” and P_{i,2} has a value of “0” indicates that a corresponding i-th codepoint has three TCI states, which may indicate that the corresponding codepoint may include one separate DL TCI state and two separate UL TCI states, or two separate DL TCI states, and one separate UL TCI state.
      The case in which P_{i,1} has a value of “1” and P_{i,2} has a value of “1” indicates that a corresponding i-th codepoint has four TCI states, which may indicate that the corresponding codepoint may include two separate DL TCI states and two separate UL TCI states.
   In case that a UE can configure unifiedTCI-StateType-r17 in MIMOparam-r17 within higher layer signaling ServingCellConfig as one of joint, separate, and mixed mode, when higher layer signaling unifiedTCI-StateType-r17 is configured as mixed mode, the UE may interpret P_{i,1} of the third octet and may not transmit the fourth octet. The mixed mode may be expressed as one configuration value having a meaning that a general mixed mode of a joint TCI state and a separate DL or UL TCI state is possible.
      The case in which P_{i,1} has a value of “0” may indicate that a corresponding i-th codepoint include one joint TCI state and one separate DL TCI state.
      The case in which P_{i,1} has a value of “1” may indicate that a corresponding i-th codepoint include one joint TCI state and one separate UL TCI state.
   In case that a UE can configure unifiedTCI-StateType-r17 in MIMOparam-r17 within higher layer signaling ServingCellConfig as one of joint, separate, and mixed mode, when higher layer signaling unifiedTCI-StateType-r17 is configured as mixed mode, the UE may interpret P_{i,1} of the third octet and P_{i,2} of the fourth octet as follows. The mixed mode may be expressed as one configuration value having a meaning that a general mixed mode of a joint TCI state and a separate DL or UL TCI state is possible.
      The case in which P_{i,1} has a value of “0” may indicate that a corresponding i-th codepoint include only one joint TCI state. That is, the mixed mode is not used and thus the value of P_{i,2} may be ignored.
      The case in which P_{i,1} has a value of “1” may indicate that a corresponding i-th codepoint include one of one separate UL TCI state and one separate DL TCI state in addition to one joint TCI state. That is, the mixed mode may be used for the corresponding codepoint, when P_{i,2} has a value of “0”, one separate UL TCI state may be additionally used, and when P_{i,2} has a value of “1”, one separate UL TCI state may be additionally used.
D/U 3025: This field may indicate whether a TCI state ID field in the same octet is a joint TCI state or separate DL TCI state, or a separate UL TCI state. If this field is 1, TCI state ID fields in the same octet may be a joint TCI state or a separate DL TCI state, and if this field is 0, TCI state ID fields in the same octet may be a separate UL TCI state.
TCI state ID 3030: This field may indicate a TCI state which may be identified with higher layer signaling TCI-StateId. If the D/U field is configured to be 1, this field may be used for expressing TCI-StateId which may be expressed using 7 bits. If the D/U field is configured to be 0, an MSB of this field may be considered as a reserved bit and the remaining six bits may be used for expressing higher layer signaling UL-TCIState-Id. In case that a maximum number of TCI state which may be activated may be 8 for a joint TCI state, and 16 for a DL or UL TCI state.
R: This field indicates a reserved bit and may be configured to be 0.

Aforementioned unifiedTCI-StateType-r17 in MIMOparam-r17 within higher layer signaling ServingCellConfig may be defined with a new parameter, such as unifiedTCI-StateType-r18 in higher layer signaling MIMOparam-r18 within ServingCellConfig, or an existing parameter may be used.

### Third Embodiment: Beam Reporting Method for Simultaneous Transmission Using Multi-Panel

In accordance with an embodiment of the disclosure, a method of performing beam report by a UE to a BS for simultaneously transmitting an UL channel by using multiple panels is provided.

In NR Release 17, technologies for supporting, by using one unified TCI framework, beams having been individually managed for UL and DL have been developed and introduced. As described above, based on the unified TCI, not only a reception beam for receiving a DL signal but also a transmission beam for transmitting an UL signal may be indicated through the TCI. A UE may determine a transmission beam or a reception beam based on a transmission filter or a reception filter having been used for transmitting or receiving a reference signal indicated by a TCI state.

A UL transmission filter for each channel may be required for the UE to simultaneously transmitting UL signals by using multiple panels. If selecting two panels among multiple panels to transmit an UL signal via each transmission beam, the UE needs to determine two transmission beams. As an extension of this, if selecting N panels among multiple panels to transmit an UL signal via each transmission beam, the UE may need to determine N transmission beams. In order to support UL simultaneous transmission using multiple panels, a transmission beam determined in the same manner as a method for commonly reporting N transmission beams to a single DCI (sDCI)-based multi-panel simultaneous transmission supporting system and a multi-DCI (mDCI)-based multi-panel simultaneous transmission supporting system and determining same may be applied to UL simultaneous transmission.

Alternatively, while commonly reporting N transmission beams to the sDCI-based system and the mDCI-based system, separate application methods appropriate for each system may be considered. Alternatively, a method for reporting and determining N transmission beams appropriate for the sDCI-based system and a method for reporting and determining N transmission beams appropriate for the mDCI-based system are distinguished and may be applied individually.

The UE may perform beam reporting for determining a transmission beam to the BS. In order to perform beam reporting, the UE may use a beam reporting method supported until NR Release 17. Alternatively, a method generated by reinforcing a beam reporting method supported until NR Release 17 may be used or a new beam reporting method different from a beam reporting method supported until NR Release 17 may be introduced. For example, in order to support UL simultaneous transmission using multiple panels, beam reporting may be performed by additionally performing group-based beam reporting reinforced from NR Release 17.

As a more specific description of the reinforced group-based beam reporting, CSI information reported from the UE to the BS may include information below (wherein, it may be assumed that the group-based beam reporting method supported by NR Release 17 is identical to a case in which N=2 in N transmission beams described above. That is, in the transmission beam reporting and determining method to support simultaneous transmission using multiple panels based on NR Release 17 described below, the case of N=2 is assumed. However, this is merely an example, and N may be extended to be an integer greater than 2 and applied.)
Resource set indicator
A first or second CSI-RS resource indicator (CRI) or SSB resource indicator (SSBRI) for each resource group (up to four resource groups may be defined and the number of groups configured to a corresponding UE is determined based on a higher layer parameter configured by a BS)
RSRP or differential RSRP for a reported CRI or SSBRI. In this case, the RSRP is reported with 7 bits only for a first resource of a first resource group and differential RSRP is reported with 4 bits for each resource group or each resource of the resource group

As described above, the CSI information is reported by the UE to the BS according to a CSI reporting method supported by NR Release 17 and the UE may report additional CSI information to the BS for multi-panel simultaneous transmission by additionally reporting information below.
Report CapabilityIndex (or an indicator having a certain name for performing an operation capable of indicating the number of SRS ports maximally supported by the UE with respect to a reported CRI or SSBRI, such as UE capability set index may correspond thereto) for indicating a capability value with respect to a reported CRI or SSBRI to each resource group and resource of the resource group with 2 bits
CORESETPoolIndex (corresponding information may be implicitly omitted, and when omitted, it may be assumed that first beam information of each resource group is associated with a case in which CORESETPoolIndex is configured to be “0” or CORESETSETPoolIndex is not configured and second beam information of each resource group is associated with a case in which CORESETSETPoolIndex is “1”. CORESETSETPoolIndex different from what is exemplified and mapping information between beam information may be included.)

Here, first beam information and second beam information within a beam group in each resource group are reported. That is, one of CRS-RS resources within a first resource group or one of SSB resources within the first resource group for indicating a first beam of a certain beam group may be selected from the first resource group. One of CRS-RS resources within a second resource group or one of SSB resources within the second resource group for indicating a second beam of a certain beam group may be selected from the second resource group. In this case, respective resource groups may refer to two CSI-RS resource groups or two SSB resource groups for mTRP NC-JT introduced in NR Release 17. The UE should be able to simultaneously perform transmission and reception using multiple panels by using a transmission beam according to two selected CSI-RS resources or SSB resources within each beam group.

Alternatively, in the same way as supporting groupBasedBeamReporting introduced before NR Release 17, a CRI or SSBRI may be selected from two different CSI-RS resources or two different SSB resources which may be transmitted or received by the UE via one or multiple spatial domain receive filters. Unlike group-based beam reporting based on NR Release 17, in a beam reporting method based on releases prior to NR Release 17, two separate resource groups may not be configured, and among the multiple resources, any two different CSI-RS or SSB resources capable of simultaneous transmission and reception by the UE using multiple panels may be configured.

The UE may support the BS to configure two TCI states for simultaneous support using multiple panels by additionally reporting a maximum number of SRS ports that may be supported for each beam group and resources within the group. For example, the BS may expect that two resources included in the same group are received through different panels. As such, by configuring a resource group and a corresponding CSI resource set, the BS may activate two TCI states by using a reported beam group pair.

Alternatively, in the same way as groupBasedBeamReporting before NR Release 17, among multiple CSI-RS resources or multiple SSB resources, two TCI states may be activated by using a beam pair within the beam group reported from two different CSI-RS resources or two different SSB resources which the UE may simultaneously receive via one or multiple spatial domain receive filters, as described above. That is, for the MAC CE to activate/deactivate the unified TCI state reinforced in NR Release 17, an operation where conventionally only one TCI state may be indicated in one codepoint may be expanded to allow up to two TCI states to be indicated in one codepoint, and in this case, the two TCI states for supporting simultaneous transmission by using multiple panels in one code point may refer to a beam group pair in a beam group report reported from the UE. For convenience of description, the case in which two TCI states are indicated has been described in the aforementioned explanation, but in the case of simultaneous transmission using N_{UL,panel} number of panels greater than 2, instead of two TCI states being indicated to one codepoint, N_{UL,panel} TCI states may be indicated to one codepoint.

As another example, the BS may consider an operation of configuring the same CSI resource to the same CSI resource set in the same group through a higher layer configuration and performing reception for the same CSI resource by using different panels. This may be used as a method for considering simultaneous transmission and reception of a single TRP via multiple panels.

When reporting a beam to the BS, the UE may perform the reporting by configuring panel information of the reported beam as additional CSI information. For example, when the maximum number of panels that may be supported by the UE is defined as Nₚₐₙₑₗ, log₂Nₚₐₙₑₗ bits are added for each reported CRI or SSBRI to notify information on the panel to the BS. The case may be defined as “panel index” or configured as another form of CSI report information that may implicitly indicate as information for the panel rather than explicitly indicate same.

For example, if the number of resources within a CSI resource set associated with CSI reporting is 8, and a CRI is received via a first panel among two panels in which the UE may operate CSI-RS resources corresponding to 0 or 1, or 2 or 3, the reporting may be performed by configuring additional one bit as “0” in addition to the corresponding CRI and RSRP (or SINR or some channel measurement information may be applicable) according thereto. That is, the UE may report to the BS that reception is performed through the first panel among two panels.

Similarly, a CRI is received via a second panel among two panels in which the UE may operate CSI-RS resources corresponding to 4 or 5, or 6 or 7, the reporting may be performed by configuring additional one bit as “1” in addition to the corresponding CRI and RSRP (or SINR or some channel measurement information may correspond thereto) according thereto. As such, when adding additional information to the CSI report, the BS may configure a beam combination capable of simultaneous transmission using multiple panels, based on the reported beam information and corresponding panel information, and may transmit a MAC CE configuring multiple TCI states as one codepoint to the UE. The UE receives the MAC CE from the BS to activate a TCI state, and when finally, one codepoint is indicated through DCI format 1_1 or DCI format 1_2, the UE may apply the one codepoint to UL signal transmission after BAT time.

With respect to the case of adding panel information, an operation in which the BS configures the same CSI resource to the same CSI resource set in the same group through a higher layer configuration and reception is performed for the same CSI resource by using different panels may be considered. As such, even in case that the same CSI resource is configured with respect to different resource sets within a group, the UE may report the corresponding CRI, RSRP (or SINR or some channel measurement information may be applicable) according thereto, and panel information (including, e.g., log₂Nₚₐₙₑₗ bits as described above) to the BS.

As described above, in the second embodiment, the UE may report beam information to the BS, and based thereon, the BS may configure a higher layer parameter for supporting simultaneous transmission using multiple panels and transmit the MAC CE to the UE so as to activate the TCI state. In this case, the MAC CE transmitted from the BS to the UE may use the MAC CE for indicating unified TCI-based multiple TCI states as shown in FIGS. 25 to 27 of the first embodiment described above.

Alternatively, in order to indicate multiple TCI states via one codepoint, the MAC CE may be configured as shown in FIG. 29 or 30 and multiple TCI states for supporting multi-panel simultaneous transmission may be activated at one codepoint. The multiple TCI states activated at one codepoint through the MAC CE (FIGS. 25 to 27 or FIG. 29 or FIG. 30) may be multiple TCI states simultaneously transmittable by using multiple panels or may be multiple TCI states to which simultaneous transmission using multiple panels is not supported. The former and the latter may be identified and configured by the BS through a group-based beam report transmitted by the UE to the BS, and the UE and the BS may implicitly identify, through the reported (received) group-based beam report, whether the TCI states is a TCI state combination of which simultaneous transmission using multiple panels is possible, or a TCI stat combination of which simultaneous transmission using multiple panels is not possible.

Alternatively, an indicator indicating multi-panel simultaneous transmission with respect to each codepoint may be added by using an unused field of a reserved region (R region).

Alternatively, when reserved regions are not secured as many as the total number of codepoints, a new indicator region for indicating multi-panel simultaneous transmission may be added by using a new octet (8 bits). For example, in case that a total of 8 codepoints exist, additional 8 bits for indicating multi-panel simultaneous transmission may be configured, and a MAC CE may be configured by using a reserved region or adding a new octet. Here, in case that a first bit (MSB) is configured to be 1 and multiple (e.g., two) TCI states are indicated at a first codepoint, a TCI state may be activated to perform unlink simultaneous transmission using multiple panels based on the multiple TCI states.

Alternatively, in case that a first bit (MSB) is configured to be 1 and multiple (e.g., two) TCI states are indicated at a first codepoint, it may be indicated that unlink simultaneous transmission using multiple panels based on the multiple TCI states is impossible. As such, in case that the simultaneous transmission using multiple panels is not performed, the multiple TCI states indicated via the corresponding codepoint may support TDM-based multi-TRP transmission.

That is, the multiple TCI states described above may be activated/configured/indicated via one codepoint, and a method for indicating one codepoint representing multiple TCI states through one field in a single DCI is suitable for simultaneous transmission using sDCI-based multi-panel. As beam reporting for simultaneous transmission using mDCI-based multi-panel to perform UL transmission via a TRP which may correspond to each CORESETPoolIndex through multiple DCIs, the UE may determine multiple (e.g., N=2) transmission beam pairs as one beam group through the same or similar procedure as described above and report the determined beam group to the BS. In case that the BS and the UE may define first transmission beam information (which may indicate beam information reported firstly in any beam group of CSI information included in UCI in case of considering a group-based beam reporting (groupBasedBeamReporting) method, the beam information corresponding to CRI or SSBRI) to be associated with CORESETPoolIndex=0 within the beam group by defining explicit rules in the 3GPP specifications, and define secondly reported beam information (which may indicate beam information reported secondly in the beam group, including the first transmission beam information, of CSI information included in UCI in case of considering a group-based beam reporting (groupBasedBeamReporting) method, the beam information corresponding to CRI or SSBRI) to be associated with CORESETPoolIndex=1.

Alternatively, the BS and the UE may define an association relationship between CORESETPoolIndex and the beam group reported according to an implicit method. In this case, as following the explicit rule as described above, the first and second beam information within the reported beam group and CORESETPoolIndex having different indexes may have the relationship in which the first beam information in the beam group may be associated with CORESETPoolIndex=0 and the second beam information in the beam group may be associated with CORESETPoolIndex=1. In case of following the implicit method, although, the association relationship may not be described in the 3GPP specifications, in consideration of the implicit relationship, the BS may indicate the beam information (e.g., a CRI or SSBRI) associated with corresponding CORESETPoolIndex within the beam group through DCI (i.e., a PDCCH received through CORESET in which CORSETPoolIndex is 0 (or may not configured) or 1) associated with corresponding CORESETPoolIndex, using a reference signal (referenceSignal) of the TCI state (DLorJoint-TCIstate-r17 or UL-TCIstate) for UL channel transmission to be scheduled. Here, the DCI indicating the TCI state may be indicated through DL scheduling or a DL DCI format (e.g., DCI format 1_1 or 1_2) for indicating the TCI state, like a conventional unified TCI framework to be applied to UL transmission after BAT, may be indicated through a UL DCI format (e.g., DCI format 0_1 or 0_2) for scheduling UL PUSCH to be applied after BAT or immediately applied to a time point at which the PUSCH scheduled by corresponding DCI.

### Fourth Embodiment: SRS Configuration Method for Codebook-Based PUSCH Simultaneous Transmission Using Multi-Panel

In accordance with an embodiment of the disclosure, a method for configuring an SRS resource set and an SRS resource for supporting codebook-based PUSCH simultaneous transmission using multiple panels is provided.

In case that UL simultaneous transmission using multiple panels is possible based on a capability of a UE, the UE may configure that the corresponding UE capability is supportable and transmit same to a BS. For example, a UE capability (ability) report parameter reported by the UE to the BS may correspond to “simulTx-PUCCH-PUSCH”, and by configuring a value for the corresponding parameter as “supported” or “enable”, etc., it may be reported that PUCCH or PUSCH may be transmitted simultaneously by using multiple panels. In this case, it may be possible to simultaneously transmit multiple PUCCHs or PUCCH repetitive transmission, or to simultaneously transmit multiple PUSCHs or PUSCH repetitive transmission by using multiple panels.

An operation of simultaneously transmitting a PUCCH and a PUSCH by using multiple panels may not be supported. The UE capability (ability) report parameter, “simulTx-PUCCH-PUSCH”, reported by the UE to the BS is merely an example, and the UE may report to the BS that UE is capable of simultaneous UL transmission using multiple panels through a parameter with another name, which may perform similar or identical UE capability (ability) reporting.

Thereafter, the BS may configure higher layer parameters for supporting the UE and a higher layer parameter for UL simultaneous transmission using multiple panels may be included in the higher layer parameter to be configured. In case that the BS configures the higher layer parameter for UL simultaneous transmission using multiple panels to the UE, an SRS resource set for PUSCH transmission may be configured. In this case, if a codebook-based PUSCH is supported by using multiple panels, an SRS resource set in which “usage” of the SRS resource set is configured to be “codebook” may be configured to the UE. There may be configured one or multiple SRS resource sets in which “usage” for codebook-based PUSCH simultaneous transmission using multiple panels is configured as “codebook”. The case in which multiple SRS resource sets having “usage” configured as “codebook” are configured may represent that an UL signal may be transmitted via multiple TRPs as many as the number of the SRS resource sets according to a relationship between TCI states described below. For example, the case in which two SRS resource sets having “usage” configured as “codebook” are configured to the UE by the BS may represent that the UE may transmit an UL signal via up to two TRP.

Herein, for convenience of explanation, a method of simultaneously transmitting an UL signal through two TRPs is mainly described, but based on the described method, it may be extended to simultaneously transmit an UL signal via TRPs having a number greater than 2. When configuring multiple SRS resource sets having “usage” configured as “codebook”, the BS may configure one or more SRS resources within each SRS resource set. When configuring a higher layer parameter for an SRS resource set to the UE, the BS may additionally configure “followUnifiedTCTstate-r17”. If “followUnifiedTCTstate-r17” is configured in an SRS resource set, the UE may transmit an SRS resource within the SRS resource set according to a spatial relation referring to an RS (e.g., an SRS) or an RS (e.g., CSI-RS or SSB) having been used for determining an UL transmission spatial filter in which “qcl-Type” is configured as typeD in “QCL-Info”, such as the indicated “DLorJoint-TCIstate-r17” (or “TCI-State” when a higher layer parameter “unifiedTCI-StatType” is configured to be “joint”) or “UL-TCIstate” (or “TCI-UL-State” when a higher layer parameter “unifiedTCI-StatType” is configured as “separate”). In this case, a reference RS indicated via DLorJoint-TCIstate-r17 may include a CSI-RS within NZP-CSI-RS-ResourceSet in which a higher layer parameter repetition is configured or a CSI-RS within NZP-CSI-RS-ResourceSet in which a higher layer parameter trs-info is configured. Alternatively, a reference RS indicated via “UL-TCIstate” may include a CSI-RS within NZP-CSI-RS-ResourceSet in which a higher layer parameter repetition is configured, a CSI-RS within NZP-CSI-RS-ResourceSet in which a higher layer parameter trs-info is configured, an SRS resource in which “usage” is configured as “beamManagement”, or an SSB associated PCI the same as or different from PCI of a serving cell.

Herein, for convenience of explanation, it is assumed that the higher layer parameter “followUnifiedTCTstate-r17” is configured in multiple SRS resource sets, and an SRS resource is transmitted according to the spatial relation determined by referring to the TCI state indicated by DCI (e.g., DLorJoint-TCIstate-r17 or UL-TCIstate) is determined.

As described above in the third embodiment, in case that a MAC CE for activating multiple TCI states for supporting UL simultaneous transmission using multiple panels is received by the UE from the BS, and one codepoint including multiple (e.g., N number) TCI states is indicated through DCI or the like, a first SRS resource set in the multiple SRS resource sets is associated with a first TCI state among the indicated N TCI states. That is, according to the spatial relation determined by referring to the first TCI state among the indicated N TCI states, all SRS resources within the first SRS resource set may be transmitted by the UE. In this case, the first SRS resource set indicates an SRS resource set with a smallest SRS-ResourceSetId value among multiple SRS resource sets (for convenience of explanation, the SRS resource set described in the fourth embodiment and the fifth embodiment indicates the SRS resource set of which “usage” is “codebook”) having “usage” configured as “codebook”.

Similarly, a second SRS resource set among the multiple SRS resource sets is associated with a second TCI state among the indicated N TCI states. That is, according to the spatial relation determined by referring to the second TCI state among the indicated N TCI states, all SRS resources within the second SRS resource set may be transmitted by the UE. Similarly applied to SRS resource sets and TCI states with numbers greater than 2, the UE may transmit all SRS resources included in an n-th SRS resource set according to the spatial relation determined by referring to an n-th TCI state. Here, if one SRS resource set includes multiple SRS resources, each SRS resource may be associated with a panel according to different methods as follows. In case that the UE reports that the UE can perform simultaneous UL transmission using multiple panels through UE capability reporting and in consideration thereof, the BS configures a higher layer parameter for simultaneous UL transmission using multiple panels, an association relationship between the SRS resource and the panel to be described may be established.

[Association Relationship 1]

Each SRS resource included in an SRS resource set may be associated with one panel supported by the UE. For example, a first SRS resource in a first SRS resource set may be associated with a first panel (the order of panels in multiple panels may be determined by the implementation of the UE if information about the panels is implicitly configured and indicated, or may be determined by a lowest panel indicator if information about the panels is explicitly configured and indicated. Afterwards, second, third, etc., panels may be defined in a similar manner) among panels supported by the UE. A second resource in the first SRS resource set may be associated with a second panel among panels supported by the UE. The above-described configuration method is merely one example, SRS resources having the number other than 2 may be configured in one SRS resource set, and each SRS resource may be associated with a certain panel supported by the UE. However, the association relationship should be established so that the BS and the UE have the same understanding, and the method for defining the association relationship between the SRS resource and the panel supported by the UE in order as in the above-described example may be considered. Furthermore, the group-based beam report information described above may be used so that the BS and the UE have the same understanding with respect to the association relationship between the SRS resource and the panel.

Alternatively, information for the panel supported by the UE may be additionally configured within SRS-Resource explicitly configured as a higher layer parameter. For example, a higher layer parameter like “panel_Index” may be added to the higher layer parameter SRS-Resource and the information may be indicated with one value from 0 to Nₚₐₙₑₗ−1.

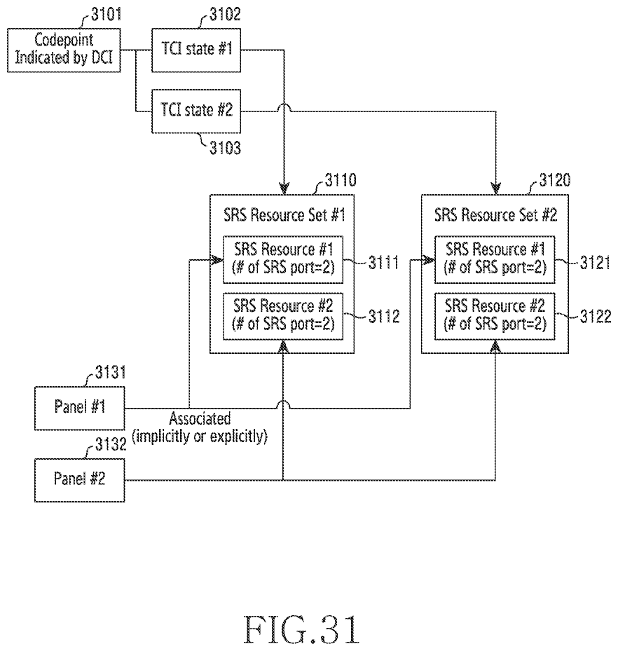

FIG. 31 illustrates two SRS resource sets including two SRS resources and a UE supporting simultaneous UL transmission by using two panels in a wireless communication system according to an embodiment.

Referring to FIG. 31, a codepoint indicated by a TCI region of DCI 3101 received by a UE from a BS indicates two TCI states 3102 and 3103 for simultaneous transmission using multiple panels. In this case, a first TCI state 3102 may be used to determine a spatial relation for transmitting of SRS resources 3111 and 3112 within a first SRS resource set 3110. A second TCI state 3103 may be used to determine a spatial relation for transmitting of SRS resources 3121 and 3122 within a second SRS resource set 3120. A first panel 3131 of the UE may be implicitly or explicitly associated with the first resource 3111 within the first SRS resource set 3110. If the first TCI state includes, as a reference RS, an RS transmitted from a first TRP among multiple TRPs, the UE may understand that the first resource 3111 within the first SRS resource set 3110 is configured to be transmitted to the first TRP by using the first panel 3131 of the UE. In addition, the first panel 3131 of the UE may be implicitly or explicitly associated with a first resource 3121 within the second SRS resource set 3120 as well. If the second TCI state includes, as a reference RS, an RS transmitted from a second TRP among multiple TRPs, the UE may understand that the first resource 3111 within the first SRS resource set 3110 is configured to be transmitted to the second TRP by using the first panel 3131 of the UE.

A second panel 3132 of the UE may be implicitly or explicitly associated with the second resource 3112 within the first SRS resource set 3120. If the first TCI state includes, as a reference RS, an RS transmitted from a first TRP among multiple TRPs, the UE may understand that the first resource 3111 within the first SRS resource set 3110 is configured to be transmitted to the first TRP by using the second panel 3132 of the UE. In addition, the second panel 3132 of the UE may be implicitly or explicitly associated with a second resource 3122 within the second SRS resource set 3120 as well. If the second TCI state includes, as a reference RS, an RS transmitted from a second TRP among multiple TRPs, the UE may understand that the second resource 3122 within the second SRS resource set 3120 is configured to be transmitted to the second TRP by using the second panel 3132 of the UE. As described above, FIG. 31 illustrates a case in which the number of SRS ports of an SRS resource included in each SRS resource set is 2.

[Association Relationship 2]

An SRS resource included in an SRS resource set may be associated with one panel or multiple panels. For example, the first SRS resource within the first SRS resource set may be associated with the first panel (or the second panel) among panels supported by the UE and the second SRS resource within the first SRS resource set may be associated with the first panel and the second panel among panels supported by the UE. Similarly, the first SRS resource within the second SRS resource set may be associated with the second panel (or the first panel) among panels supported by the UE and the second SRS resource within the second SRS resource set may be associated with the first panel and the second panel among panels supported by the UE. The above-described configuration method is merely one example, SRS resources having the number other than 2 may be configured in one SRS resource set, and each SRS resource may be associated with any panel supported by the UE.

Furthermore, unlike the example described above, the first SRS resource within the SRS resource set may be associated with multiple panels. However, identical to [Association relationship 1], [Association relationship 2] should be established so that the BS and the UE have the same understanding, and like the example described, may be considered as a method for defining the association relationship between the SRS resource and the panel supported by the UE. Furthermore, the group-based beam report information described above may be used so that the BS and the UE have the same understanding with respect to the association relationship between the SRS resource and the panel.

Alternatively, information for the panel supported by the UE may be additionally configured within SRS-Resource explicitly configured as a higher layer parameter. For example, a higher layer parameter like “panel_Index” may be added to the higher layer parameter SRS-Resource and the information may be indicated with one value or multiple values from 0 to Nₚₐₙₑₗ−1.

Alternatively, “panel_Index” may configure a higher layer parameter by using a bitmap format to configure a panel associated with a corresponding SRS resource to be 1 and a panel not associated therewith to be 0. In this case, “panel_Index” may include Nₚₐₙₑₗ bits.

Alternatively, “panel_Index” may include ┌log₂(Σₖ₌₁^{N}^{ₚₐₙₑₗ}(ₖ^{N}^{ₚₐₙₑₗ}))┐ bits to consider the entire combination of supported panels.

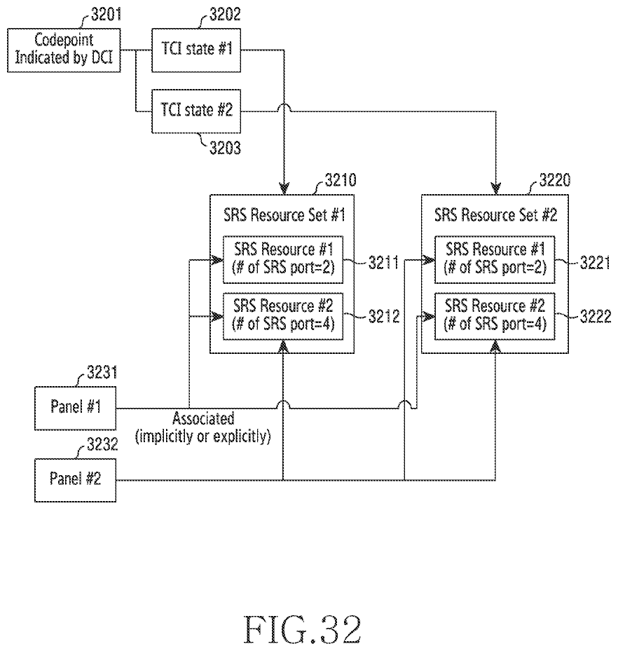

FIG. 32 illustrates two SRS resource sets including two SRS resources and a UE supporting simultaneous UL transmission by using two panels in a wireless communication system according to an embodiment.

Referring to FIG. 32, a codepoint indicated by a TCI region of DCI 3201 received by a UE from a BS indicates two TCI states 3202 and 3202 for simultaneous transmission using multiple panels. In this case, a first TCI state 3202 may be used to determine a spatial relation for transmitting of SRS resources 3211 and 3212 within a first SRS resource set 3210. A second TCI state 3203 may be used to determine a spatial relation for transmitting of SRS resources 3221 and 3222 within a second SRS resource set 3220. A first panel 3231 of the UE may be implicitly or explicitly associated with the first resource 3211 within the first SRS resource set 3210. If the first TCI state includes, as a reference RS, an RS transmitted from a first TRP among multiple TRPs, the UE may understand that the first resource 3211 within the first SRS resource set 3210 is configured to be transmitted to the first TRP by using the first panel 3231 of the UE. In this case, the number of SRS ports configured in the first SRS resource 3211 within the first SRS resource set 3210 may be 2. A second panel 3232 of the UE may be implicitly or explicitly associated with the first resource 3221 within the second SRS resource set 3220. If the second TCI state includes, as a reference RS, an RS transmitted from a second TRP among multiple TRPs, it may be understood that the first resource 3221 within the second SRS resource set 3220 is configured to be transmitted to the second TRP by using the second panel 3232 of the UE. In this case, the number of SRS ports configured in the first SRS resource 3221 within the second SRS resource set 3220 may be 2. The second SRS resource 3212 configured in the first SRS resource set 3210 may be implicitly or explicitly associated with the first panel 3231 and the second panel 3232, which correspond to all panels of the UE. If the first TCI state includes, as a reference RS, an RS transmitted from a first TRP among multiple TRPs, it may be understood that the second resource 3212 within the first SRS resource set 3210 is configured to be transmitted to the first TRP by using the first panel 3231 and the second panel 3232, which correspond to all panels of the UE. In this case, the number of SRS ports configured in the second SRS resource 3212 within the first SRS resource set 3210 may be 4, which may be supported using both panels. Here, first two SRS ports may be associated with the first panel 3231 and the other two SRS ports may be associated with the second panel 3232. The SRS ports and the multiple panels may have an association relationship established implicitly in order or have a relationship explicitly indicated via a new higher layer parameter. For example, panel_Index as many as the SRS ports for the SRS resources may be configured in a form of sequence. The second SRS resource 3222 configured in the second SRS resource set 3220 may be implicitly or explicitly associated with the first panel 3231 and the second panel 3232, which correspond to all panels of the UE. If the second TCI state includes, as a reference RS, an RS transmitted from a second TRP among multiple TRPs, it may be understood that the second resource 3222 within the second SRS resource set 3220 is configured to be transmitted to the second TRP by using the first panel 3231 and the second panel 3232, which correspond to all panels of the UE. In this case, the number of SRS ports configured in the second SRS resource 3222 within the second SRS resource set 3220 may be 4, which may be supported using both panels. As the second SRS resource 3212 within the first SRS resource set 3210 described above, an implicit or explicit association relationship between the SRS ports and the panels supported by the UE may be established.

The above has been described in detail assuming the case in which the SRS resources are transmitted based on the indicated TCI state. However, even for the case in which “followUnifiedTCTstate-r17” is not configured, simultaneous transmission using multiple panels may be supported by applying the above-described method based on spatial relation info configured in an SRS resource within each SRS resource set. In this case, the first TCI state may be replaced with spatialRelationInfo configured as a higher layer parameter with respect to an SRS resource within the first SRS resource set, and the second TCI state may be replaced with spatialRelationInfo configured as a higher layer parameter with respect to an SRS resource within the second SRS resource set.

The above-described methods indicate multiple TCI states through sDCI, and each of the indicated TCI states may be associated with each SRS resource set and an SRS resource (resources) included in each SRS resource set. That is, if each TCI state and each SRS resource set are associated, the SRS resource may be transmitted by referring to a reference signal (referenceSignal) indicated via the TCI state, a PUSCH may be transmitted by configuring PUSCH transmission ports identical to the SRS port of the SRS resource indicated through SRI (in case of supporting noncodebook-based PUSCH), or a PUSCH may be transmitted by applying a precoder indicated via TPMI (in case of supporting codebook-based PUSCH) to a PUSCH transmission port configured identical to the SRS port of the SRS resource indicated through SRI.

Meanwhile, each PUSCH may be scheduled by using multiple pieces of DCI through mDCI and each scheduled PUSCH may be fully/partially/non overlap with each other in time/frequency domain. Each DCI is associated with different CORESETPoolIndex, and each scheduled PUSCH is associated with different CORESETPoolIndex. In this case, two different SRS resource sets may be configured through a higher layer parameter to transmit the PUSCH scheduled by each DCI, and according to an explicit rule within the 3GPP technical specifications or an implicit rule between the BS and the UE, a first SRS resource set (may represent an SRS resource set configured with low (small) SRS-ResourceSetId among different SRS resource sets of which usage is “codebook” or “nonCodebook”) may be associated with CORESET in which CORESETPoolIndex=0 (or no CORESETPoolIndex is configured) and a PUSCH scheduled by DCI within corresponding CORESET. A second SRS resource set (may represent an SRS resource set configured with high (large) SRS-ResourceSetId among different SRS resource sets of which usage is “codebook” or “nonCodebook”) may be associated with CORESET in which CORESETPoolIndex=1 and a PUSCH scheduled by DCI within corresponding CORESET. In this case, the DCI associated with each CORESETPoolIndex may indicate a TCI state based on the beam information within the beam group which may be associated with each CORESETPoolIndex to schedule corresponding PUSCH transmission as described in the third embodiment. For example, a TCI state (DLorJoint-TCIstate-r17 or UL-TCIstate) within the DCI received via CORESET in which CORESETPoolIndex=0 (or no CORESETPoolIndex is configured) may be indicated through first beam information within the beam group. Here, as described in the third embodiment, the TCI state may be indicated through a DL DCI format (e.g., DCI format 1_1 or 1_2) and beam information indicated via the TCI state may be applied to UL transmission after BAT.

Alternatively, as described in the third embodiment, the TCI state may be indicated through a UL DCI format (e.g., DCI format 0_1 or 1_2) and beam information indicated via the TCI state may be applied to UL transmission after BAT or applied immediately at the time of transmitting the UL PUSCH scheduled via the corresponding DCI.

### Fifth Embodiment: Association Relationship Between SRS Port and PUSCH Port and Configuration Method when Performing Single DCI-Based Multi-Panel Simultaneous Transmission

In accordance with an embodiment of the disclosure, with respect to a UE supporting simultaneous transmission using sDCI-based multi-panel, an association relationship between a PUSCH port and an SRS port and a configuration method is provided.

In the fourth embodiment above, the two methods (Association relationship 1 and Association relationship 2) of configuring an SRS resource set for supporting multi-panel simultaneous transmission were described. If the UE can simultaneously transmit PUSCHs to two TRPs by using two panels based on sDCI, a BS may indicate an SRS resource for PUSCH transmission via SRI by using an SRS resource set (or a higher layer parameter may be configured to follow beam information configured in an SRS resource set or beam information configured in an SRS resource within an SRS resource set not follow a unified TCI state, but, for convenience of explanation, it is assumed that the UE transmits an SRS resource set according to multiple TCI states indicated according to the unified TCI state) associated with each TRP (each TRP may be implicitly indicated to the UE through multiple TCI states determined through group-based beam reporting). In this case, similar to the two SRI for supporting NR Release 17 sDCI TDM mTRP PUSCH repetitive transmission, the BS may indicate two SRI regions to the UE via sDCI. Bits may be configured so that the number of PUSCH layers (ranks) transmitted to a second TRP may be indicated via a second SRI region among two SRI fields when supporting a noncodebook PUSCH, unlike first NR Release 17. In addition, the numbers of SRS resources which may be configured in each SRS resource set may be the same or different. If the numbers of SRS resources included in a first SRS resource set and a second SRS resource set are different, unlike NR Release 17, both SRI regions should be able to indicate rank, the number of bits in the first SRI region and the number of bits in the second SRI region may be different, and thus depending on a configuration, the number of bits in the second SRI region may be larger than the number of bits in the first SRI region. Similarly, when supporting a codebook PUSCH, the number of ranks of a second PUSCH through which a second TPMI region is transmitted needs to be able to be indicated, and the number of bits in each TPMI region may be selected differently depending on the number of SRS ports of an SRS resource indicated via the SRI region.

Alternatively, if a constraint is added so that the number of SRS ports of SRS resources in each SRS resource set indicated via each SRI region is the same, unlike NR Release 17, since the second TPMI region needs to be able to indicate the number of ranks as well, the number of bits in both TPMI regions may be selected to be the same.

If the BS schedules the UE so that two PUSCHs are simultaneously transmitted via each panel toward each TRP through mTRP multi-panel simultaneous transmission, the BS may include information for simultaneous mTRP multi-panel transmission in DCI for PUSCH scheduling. For example, the BS may use an SRS resource set indicator to indicate multi-panel simultaneous transmission to the UE.

In NR Release 17, the SRS resource set indicator indicates one of single TRP TDM PUSCH repetitive transmission or multi-TRP TDM PUSCH repetitive transmission, but in NR Release 18, the SRS resource set indicator may be used to indicate single TRP transmission or multi-TRP transmission. Here, for the single TRP transmission, transmission based on single TRP panel selection may be performed through a single panel, or single TRP multi-panel simultaneous transmission may be performed through multiple panels.

After indicating single TRP transmission via the SRS resource set indicator, one SRS resource associated with one panel is selected from among the SRS resources that have an association relationship of the SRS resource and the panel, as in Association relationship 1 in the fourth embodiment, through the SRI region (as the two SRS resource sets are configured, the two SRI regions are included in the DCI, so the UE uses only the first or second SRI region and ignores the remaining regions, or more codepoints may be used by configuring one SRI region using all bits of the first and second SRI areas) (for single TRP panel selection-based transmission), or two SRS resources associated with two panels may be selected (for TRP multi-panel simultaneous transmission). That is, the BS may schedule one of single TRP panel selection-based transmission or single TRP multi-panel simultaneous transmission to the UE through a combination of SRS resource set indicator indication for single TRP transmission and an SRI region according thereto. Here, the single TRP panel selection-based transmission may be the same as the single TRP transmission of releases before NR Release 18, and accordingly, an association relationship between an SRS port and a PUSCH port may be determined similarly. That is, in the case of a codebook PUSCH, PUSCH ports may be configured identical to SRS ports of the indicated SRS resource, PUSCH ports may be configured in numbers identical to that of SRS ports determined according to the higher layer parameter configuration for the SRS resource. For example, if four SRS ports of an SRS resource are selected via a SRI for scheduling PUSCH transmission, four PUSCH ports may be used for PUSCH transmission and respective PUSCH ports may be configured identical to the SRS ports. A first SRS port, a second SRS port, a third SRS port, and a fourth SRS port may be mapped to PUSCH port 0, PUSCH port 1, PUSCH port 2, and PUSCH port 3, respectively. In the case of the noncodebook PUSCH, each SRS resource includes one SRS port, and an SRS port of an (i+1)-th SRS resource in an SRS resource set may be mapped to PUSCH port i. For example, in case that four SRS resources are configured in an SRS resource set, an SRS port of a first SRS resource may be mapped to PUSCH port 0, an SRS port of a second resource to PUSCH port 1, an SRS port of a third resource to PUSCH port 2, and an SRS port of a fourth resource to PUSCH port 3. In case that single TRP multi-panel simultaneous transmission is supported, if two SRS resources are indicated via SRI (possibly one or two SRI regions), a mapping relationship between SRS port in the two SRS resources and PUSCH ports may need to be determined. Two mapping methods may be considered as follows:
Mapping method 1) A method for mapping each SRS resource selected via SRI to PUSCH transmission in each panel and separately indexing a PUSCH port: in mapping method 1, indexing of a PUSCH port may be performed individually for a PUSCH transmitted via each panel. In the case of the codebook PUSCH, for a PUSCH transmitted via a first SRS resource, in the same manner as SRS ports of the first SRS resource, SRS port 0 to 3 (when the number of SRS ports of the first SRS resource is four) are mapped to PUSCH port 0 to 3, which are transmitted by configuring ports identical to the first SRS resource, and for a PUSCH transmitted via a second SRS resource, in the same manner as SRS ports of the second SRS resource, SRS port 0 to 3 (when the number of SRS ports of the second SRS resource is four) are mapped to PUSCH port 0 to 3, which are transmitted by configuring ports identical to the second SRS resource. In the case of the noncodebook PUSCH, for a PUSCH transmitted via a first panel, among SRS resources having an association relationship with the first panel (a relationship between SRS resources and panels may be defined by implicit or explicit higher layer parameters), a port of a first SRS port may be mapped to PUSCH port 0 transmitted via the first panel, a port of a second SRS port to PUSCH port 1 transmitted via the first panel, a port of a third SRS port to PUSCH port 2 transmitted via the first panel, and a port of a fourth SRS port to PUSCH port 3 transmitted via the first panel. In addition, for a PUSCH transmitted via a second panel, among SRS resources having an association relationship with the first panel (a relationship between SRS resources and panels may be defined by implicit or explicit higher layer parameters), a port of a first SRS port may be mapped to PUSCH port 0 transmitted via the second panel, a port of a second SRS port to PUSCH port 1 transmitted via the second panel, a port of a third SRS port to PUSCH port 2 transmitted via the second panel, and a port of a fourth SRS port to PUSCH port 3 transmitted via the second panel. This is merely an example, the number of ports of an SRS resource associated with each panel or the number of SRS resources may be a value other than 4 as in the example. Here, mapping between the SRS port and the PUSCH port may be performed in the same manner as the method described above.
Mapping method 2) A method for mapping all of two SRS resources selected via SRI to PUSCH transmission and indexing a PUSCH port by considering all SRS ports of the two SRS resources: mapping method 2 is a method for indexing a PUSCH port by considering all ports transmitted through two panels together. In the case of the codebook PUSCH, for a PUSCH transmitted via a first SRS resource, in the same manner as SRS ports of the first SRS resource, SRS port 0 to 3 (when the number of SRS ports of the first SRS resource is four) are mapped to PUSCH port 0 to 3, which are transmitted by configuring ports identical to the first SRS resource, and for a PUSCH transmitted via a second SRS resource, in the same manner as SRS ports of the second SRS resource, SRS port 0 to 3 (when the number of SRS ports of the second SRS resource is four) are mapped to PUSCH port 4 to 7, which are transmitted by configuring ports identical to the second SRS resource. In the case of the noncodebook PUSCH, for a PUSCH transmitted via a first panel, among SRS resources having an association relationship with the first panel (a relationship between SRS resources and panels may be defined by implicit or explicit higher layer parameters), a port of a first SRS port may be mapped to PUSCH port 0 transmitted via the first panel, a port of a second SRS port to PUSCH port 1 transmitted via the first panel, a port of a third SRS port to PUSCH port 2 transmitted via the first panel, and a port of a fourth SRS port to PUSCH port 3 transmitted via the first panel. In addition, for a PUSCH transmitted via a second panel, among SRS resources having an association relationship with the first panel (a relationship between SRS resources and panels may be defined by implicit or explicit higher layer parameters), a port of a first SRS port may be mapped to PUSCH port 4 transmitted via the second panel, a port of a second SRS port to PUSCH port 5 transmitted via the second panel, a port of a third SRS port to PUSCH port 6 transmitted via the second panel, and a port of a fourth SRS port to PUSCH port 7 transmitted via the second panel. This is merely an example, the number of ports of an SRS resource associated with each panel or the number of SRS resources may be a value other than 4 as in the example. Here, mapping between the SRS port and the PUSCH port may be performed in the same manner as the method described above.
Mapping method 1 and Mapping method 2 have been described in detail by assuming of single DCI-based single TRP panel selection or single DCI-based single TRP multi-panel simultaneous transmission. However, in order to support single DCI-based multi-TRP multi-panel simultaneous transmission by using the same mapping method, port indexing between a PUSCH transmitted to each TRP through each panel, and an SRS resource set associated with transmission of the PUSCH and an SRS resource indicated through each SRI region by using one of Mapping method 1 and Mapping method 2. For example, in case that single DCI-based multi-TRP multi-panel simultaneous codebook PUSCH transmission is supported according to Mapping method 1, in order to transmit a PUSCH to TRP1 via a first panel, a first SRS port of an SRS resource indicated via SRI within a first SRS resource set for transmitting the PUSCH to TRP1 may be mapped to PUSCH port 0 transmitted to TRP1, a second SRS port to PUSCH port 1 transmitted to TRP1, a third SRS port to PUSCH port 2 transmitted to TRP1, and a fourth SRS port to PUSCH port 3 transmitted to TRP1.

In addition, in order to transmit a PUSCH to TRP2 via a second panel, a first SRS port of an SRS resource indicated via SRI within a second SRS resource set for transmitting the PUSCH to TRP2 may be mapped to PUSCH port 0 transmitted to TRP2, a second SRS port to PUSCH port 2 transmitted to TRP2, a third SRS port to PUSCH port 2 transmitted to TRP2, and a fourth SRS port to PUSCH port 3 transmitted to TRP2. In case that single DCI-based multi-TRP multi-panel simultaneous codebook PUSCH transmission is supported according to Mapping method 2, a relationship between an SRS port of an SRS resource indicated via SRI in a first SRS resource set and a PUSCH port is the same as Mapping method 1, and in order to transmit a PUSCH to TRP2 via a second panel, a first SRS port of an SRS resource indicated via SRI within a second SRS resource set for transmitting the PUSCH to TRP2 may be mapped to PUSCH port 4 transmitted to TRP2, a second SRS port to PUSCH port 5 transmitted to TRP2, a third SRS port to PUSCH port 6 transmitted to TRP2, and a fourth SRS port to PUSCH port 7 transmitted to TRP2.

In the case that single DCI-based multi-TRP multi-panel simultaneous noncodebook PUSCH transmission is supported according to Mapping method 1, for a PUSCH transmitted to TRP1, among SRS resources having an association relationship with the first panel (a relationship between SRS resources and panels may be defined by implicit or explicit higher layer parameters) in a first SRS resource set, a port of a first SRS port may be mapped to PUSCH port 0 transmitted via the first panel, a port of a second SRS port to PUSCH port 1 transmitted via the first panel, a port of a third SRS port to PUSCH port 2 transmitted via the first panel, and a port of a fourth SRS port to PUSCH port 3 transmitted via the first panel. In addition, for a PUSCH transmitted to TRP2, among SRS resources having an association relationship with the second panel (a relationship between SRS resources and panels may be defined by implicit or explicit higher layer parameters) in a second SRS resource set, a port of a first SRS port may be mapped to PUSCH port 0 transmitted via the second panel, a port of a second SRS port to PUSCH port 1 transmitted via the second panel, a port of a third SRS port to PUSCH port 2 transmitted via the second panel, and a port of a fourth SRS port to PUSCH port 3 transmitted via the second panel.

Similarly, in the case that single DCI-based multi-TRP multi-panel simultaneous noncodebook PUSCH transmission is supported according to Mapping method 2, for a PUSCH transmitted to TRP1 by using the first panel, a PUSCH port is indexed in the same manner as Mapping method 1, and for a PUSCH transmitted to TRP2 by using the second panel, among SRS resources having an association relationship with the second panel (a relationship between SRS resources and panels may be defined by implicit or explicit higher layer parameters) in a second SRS resource set, a port of a first SRS port may be mapped to PUSCH port 4 transmitted via the second panel, a port of a second SRS port to PUSCH port 5 transmitted via the second panel, a port of a third SRS port to PUSCH port 6 transmitted via the second panel, and a port of a fourth SRS port to PUSCH port 7 transmitted via the second panel.

The method is described above assuming a specific relationship between each TRP, SRS resource set, SRS resource, and panel (assuming that TRP1 is associated with the first SRS resource set, TRP2 is associated with the second SRS resource set, and an SRS resource within an SRS resource set is implicitly or explicitly associated with a specific panel). However, for association relationships among other TRPs, SRS resource sets, SRS resources, and panels, PUSCH port indexing referring to the SRS port associated with the PUSCH port may be performed according to Association relationship 1 or Association relationship 2.

### Sixth Embodiment: A Method for Determining an Association Relationship Between PTRS and DMRS when Supporting Single DCI Single Codeword-Based Multi-Panel Simultaneous Transmission

In accordance with an embodiment, a method for associating one PTRS port or two PTRS ports with a DMRS port of PUSCHs simultaneously transmitted via multiple panels when supporting sDCI single codeword (single CW or 1CW)-based multi-panel simultaneous transmission is provided.

When supporting a PUSCH up to NR Release 17, PUSCH transmission with up to 4 layers may be supported, and by using codeword-to-layer mapping (CW-to-layer mapping) identical to DL, even one codeword may be provided for PUSCH transmission. In the case of supporting multi-panel simultaneous transmission in NR Release 18, up to 4 layers in total of a PUSCH transmitted via two panels may be supported. In the future, NR Release or a next generation wireless communication system may support more than 4 layers during multi-panel simultaneous transmission. When more than 4 layers are used for multi-panel transmission, simultaneous multi-panel transmission based on two codewords (dual codewords, two CW, or 2CW) as well as 1CW may be supported. If up to 2CW can be used for multi-panel simultaneous transmission, similar to the configuration for DL PDSCH reception, a higher layer parameter “maxNrofCodeWordsScheduledByDCI” for configuring a maximum number of codewords supported may be configured in an upper layer parameter “PUSCH-Config” (or may be configured in another higher layer parameter for a PUSCH configuration) for a PUSCH configuration. The sixth embodiment illustrates a method for determining, when sDCI-based multi-panel simultaneous transmission is supported as in a conventional way, an association relationship between PTRS and DMRS for a case in which only 1CW may be supported, or up to 2CW may be supported, but a higher layer parameter (e.g., “maxNrofCodeWordsScheduledByDCI” is configured to “n1” or “1”) is configured to support only 1CW, or a higher layer parameter is configured to support up to 2CW, but the number of PUSCH layers is scheduled to be less than or equal to 4, so only 1CW is supported, or a case in which only 1CW is supported during sDCI-based multi-panel simultaneous transmission in addition to the examples described.

The BS receives a UE capability report for features supportable by the UE. Thereafter, the BS configures a higher layer parameter to the UE based thereon. Here, the UE may establish a UE capability report including information that sDCI-based multi-panel simultaneous transmission is possible (e.g., “simulTx-PUCCH-PUSCH”), two PTRS ports may be supported (e.g., “twoPortsPTRS-UL”), and if up to 2CW are supported with respect to UL, UL 2CW may be supported (e.g., “enableUL2CWs”) and reports the UE capability report to the BS. Based on the UE capability report, the BS may configure a higher layer parameter for UL/DL and multi-panel simultaneous transmission to the UE. For convenience of explanation, it is assumed that the BS may support up to 4 layers for all UL transmissions, including a higher layer parameter (including, e.g., as described in the fourth embodiment, a configuration of two SRS resource sets or the like) for sDCI-based multi-panel simultaneous transmission and multi-panel simultaneous transmission, and up to 1 CW is supported. Of course, a case in which 2CW may be supported for 4 layers and when scheduling an sDCI-based multi-panel simultaneous transmission PUSCH, the BS schedules a PUSCH transmitted via multiple panels with 1CW to the UE, or the like may be included, but for convenience of explanation, the corresponding support case is assumed.

The BS may configure the number of supported UL PTRS ports to “1”. This may be configured through a parameter maxNrofPorts in PTRS-UplinkConfig in DMRS-UplinkConfig in a higher layer parameter PUSCH-config for PUSCH configuration, and since the number of supported UL PTRS ports is “1”, a value of a corresponding parameter maxNrofPorts may be configured to be “n1”. If 1 PTRS port is used during 1CW-based simultaneous transmission with up to 4-layer multi-panel, an association relationship between a PTRS port and a DMRS port of a PUSCH simultaneously transmitted via multiple panels may be determined by considering following methods.
Method 1) Using the same PTRS-DMRS association relationship determination method as in NR Release 15/16/17: Since the total number of layers is 4, regardless of the number of layers transmitted via each panel, it needs to indicate one DMRS port associated with a PTRS port for one of the four layers. Accordingly, the method for indicating the association relationship between 1 PTRS port and DMRS port defined in the conventional NR Release 15/16/17 may be used as is. That is, by using a 2-bit PTRS-DMRS association relationship region within DCI format 0_1 or 0_2 scheduling a PUSCH, one DMRS port may be selected by interpreting as in Table 42-1. Here, since different layers are transmitted via two panels and different DMRS ports may be transmitted on each PUSCH, it is necessary to clarify the definition of first to fourth DMRS ports in Table 42-1. In this case, DMRS ports may be aligned in order according to an SRS resource set with which each PUSCH is associated. For example, DMRS ports for a first PUSCH transmitted in association with a first SRS resource set are sequentially aligned from a first DMRS port to a DMRS port having an ordinal number corresponding to the number of layers allocated to first PUSCH transmission (e.g., a second if the number of layers is 2), and DMRS ports for a second PUSCH transmitted in association with a second SRS resource set are aligned in the following order so as to be aligned from a DMRS port having an ordinal number corresponding to the number of layers allocated to the first PUSCH transmission+1 (as the described example, a third if the number of layers of the first PUSCH) to a fourth DMRS port. As such, when the order of DMRS ports is aligned, DMRS associated with panels through which PTRS ports are transmitted according to a value of a PTRS-DMRS association relationship region included in DCI for scheduling a PUSCH. For example, a PTRS-DMRS region within DCI has a value of 0, a first scheduled DMRS port is associated with a PTRS port, which means that the first DMRS port of a first PUSCH associated with a first SRS resource set is associated with the PTRS port. In other words, it may also be interpreted that the first DMRS port of the first PUSCH transmitted via the first panel and PTRS port are associated. For example, a PTRS-DMRS region within DCI has a value of 3, a fourth scheduled DMRS port is associated with a PTRS port, which means that second DMRS port of a second PUSCH associated with a second SRS resource set is associated with the PTRS port. In other words, it may also be interpreted that the second DMRS port of the second PUSCH transmitted via the second panel and PTRS port are associated.

This is merely an example, and a DMRS port for the second PUSCH associated with the second SRS resource set may be aligned first, and then a DMRS port for the first PUSCH associated with the first SRS resource set may be sequentially aligned.
Method 2) Defining to be associated with one predefined panel (or SRS resource set): in Method 2, a BS and a UE may define one PTRS port to be associated with one panel (or SRS resource set) in advance. For example, one PTRS port may be associated with a DMRS port of the first PUSCH associated with the first SRS resource set. That is, the PTRS-DMRS association relationship region included in DCI for scheduling a multi-panel simultaneous transmission PUSCH indicates one of DMRS ports of the first PUSCH associated with the first SRS resource set to indicate being associated with one PTRS port. Through the method unlike Method 1, the PTRS port may not be associated with the DMRS port of the second PUSCH associated with the second SRS resource set.

As another example, the DMRS port of the second PUSCH associated with the second SRS resource set not the DMRS port of the first PUSCH associated with the first SRS resource set may be associated with one PTRS port. The BS and the UE should have a common understanding to operate in Method 2, and for the common understanding, a higher layer parameter (e.g., a parameter for indicating one SRS resource set or panel, such as associatedSRSResourceSet) may be configured, or rules determined in standardization specifications may be specified.
Method 3) A PTRS port association method according to transmission power of a PUSCH transmitted via each panel: In Method 3, transmission power of two PUSCHs transmitted in association with each SRS resource set for determining one SRS resource set (or one panel) to which one PTRS port is associated. Here, it is assumed that transmission power of the two PUSCH associated with each SRS resource set (or each panel) may be determined individually according to a separate TCI state or spatial relation information. That is, when assuming that the first PUSCH associated with the first SRS resource set is transmitted based on the unified TCI state, UL transmission power of the first PUSCH is calculated based on an UL transmission power parameter indicated by a first TCI state of two TCI states (unified TCI states or UL TCI states) indicated by the BS. When assuming that the second PUSCH associated with the second SRS resource set is transmitted based on the unified TCI state, UL transmission power of the second PUSCH is calculated based on an UL transmission power parameter indicated by a second TCI state of two TCI states (unified TCI states or UL TCI states) indicated by the BS. As such, when transmission power of two PUSCH transmitted vie multiple panels is individually determined, there may be a difference in the transmission power of the two PUSCHs. Here, one PTRS port may be associated with one DMRS port of the PUSCH having a smaller transmission power among the two PUSCHs. If the PUSCH associated with a PTRS port is transmitted via multiple DMRS ports, one DMRS port may be indicated through the PTRS-DMRS association field in the DCI that schedules a multi-panel simultaneous transmission PUSCH. This may mean that the PUSCH is transmitted over a link with relatively good channel quality, and it shows an effect of improving the BS's PUSCH reception performance by compensating for a phase error through PTRS while using less transmission power than the PUSCH transmitted via another panel (another SRS resource set).

Alternatively, one PTRS port may be associated with one DMRS port of the PUSCH having a greater transmission power among the two PUSCHs. If the PUSCH associated with a PTRS port is transmitted via multiple DMRS ports, one DMRS port may be indicated through the PTRS-DMRS association field in the DCI that schedules a multi-panel simultaneous transmission PUSCH. This may mean that the PUSCH is transmitted over a link with relatively bad channel quality, and it shows an effect of improving the BS's PUSCH reception performance by compensating for a phase error through PTRS since reception performance may not be as good as a PUSCH transmitted via another panel (another SRS resource set). As such, depending on a channel situation, a rule may be determined that one DMRS port of the PUSCH with smaller or larger transmission power among the two PUSCHs is associated. In this case, the BS and the UE should have one common understanding and thus by configuring a new higher layer parameter, it may be indicated so that the PTRS port and the DMRS port of the PUSCH with the smaller or larger transmission power among the two PUSCHs may be associated, or by determining a rule in standardization specifications (e.g., a PTRS port and a DMRS of a PUSCH with low transmission power may be associated), one PUSCH DMRS port that may be associated with a PTRS port may be indicated.

The BS may configure the number of supported UL PTRS ports to “2”. This may be configured through a parameter maxNrofPorts in PTRS-UplinkConfig in DMRS-UplinkConfig in a higher layer parameter PUSCH-config for PUSCH configuration, and since the number of supported UL PTRS ports is “2”, a value of a corresponding parameter maxNrofPorts may be configured to be “n2”. If 2 PTRS port is used during 1CW-based simultaneous transmission with up to 4-layer multi-panel, an association relationship between a PTRS port and a DMRS port of a PUSCH simultaneously transmitted via multiple panels may be determined by considering following methods.
Method 4) One PTRS port is associated for each panel (or each SRS resource set): In Method 4, the first PTRS port of the two PTRS ports may be associated with the DMRS port of the first PUSCH associated with the first SRS resource set (or first panel), and the second PTRS port may be associated with the DMRS port of the second PUSCH associated with the second SRS resource set (or second panel). The association relationship may be implicitly or explicitly determined and may be predetermined so that the BS and the UE may perform the same operation according a rule predetermined or specified in the 3GPP specifications. In case that a PTRS port is respectively associated with simultaneously transmitted two PUSCHs as Method 4, without referring to [Table 42-2] indicating the codepoints of the PTRS-DMRS association relationship field used in NR Release 15/16, the BS may indicate a new interpretation to the UE as shown in Table 48 below. Here, it is assumed that layers scheduled in each PUSCH have the number of 2 or less.

TABLE 48

| Value | | Value | |
|---|---|---|---|
| of MSB | DMRS port | of LSB | DMRS port |
| 0 | 1^{st} DMRS port which is | 0 | 1^{st} DMRS port which is |
| | associated with first SRS | | associated with second SRS |
| | resource set | | resource set |
| 1 | 2^{nd} DMRS port which is | 1 | 2^{nd} DMRS port which is |
| | associated with first SRS | | associated with second SRS |
| | resource set | | resource set |

In this case, an MSB bit among two bits of the PTRS-DMRS association relationship region is a bit for indicating PTRS port 0, and as described in Table 48, a first DMRS port among DMRS ports of a PUSCH transmitted in association with the first SRS resource set is indicated as 0 and a second DMRS port is indicated as 1. Similarly, an LSB bit among two bits is a bit for indicating PTRS port 1, and as described in Table 48, a first DMRS port among ports of a PUSCH transmitted in association with the second SRS resource set is indicated as 0 and a second DMRS port is indicated as 1. If each PUSCH may support 3 layers instead of supporting up to 2 layers, a 2-bit PTRS-DMRS association region may be differently interpreted depending on the number of layers of the PUSCH scheduled for multi-panel simulate nous transmission. Here, all of the 2-bit PTRS-DMRS association region indicated via DCI may be used for indicating an association relationship between the PTRS port and the DMRS port of the PUSCH scheduled with 3 layers. This is because a PUSCH DMRS port scheduled with 1 layer may be associated with a PTRS port that has an association relationship with the associated SRS resource set without additional indications.

For example, if the first PUSCH associated with the first SRS resource set is scheduled with 1 layer and the second PUSCH associated with the second SRS resource set is scheduled with 3 layers, PTRS port 0 may be associated with the first DMRS port of the first PUSCH by the UE without an additional indication region. PTRS port 1 may be associated with one of three DMRS ports of the second PUSCH, and the UE may associate indicated one DMRS port from among the three DMRS ports with the PTRS port by using all of 2 bits of the PTRS-DMRS association region within DCI identical to the DCI for scheduling the corresponding PUSCH.

Table 42-2 may be used as a method for determining an association relationship between other PTRSs and PUSCH DMRSs, and with respect to a PUSCH that supports simultaneous multi-panel transmission, a new definition of the PUSCH DMRS port to which PTRS port 0 and PTRS port 1 may be associated may be made.

Until NR Release 17, with respect to the codebook PUSCH, rules were predefined so that a layer transmitted via a specific PUSCH antenna port could be associated with PTRS port 0 or PTRS port 1, and with respect to the noncodebook PUSCH, rules were predefined to be associated with the PTRS port configured in a higher layer parameter of an SRS resource selected via SRI to transmit the corresponding PUSCH. However, if a PUSCH is transmitted by performing multi-panel simultaneous transmission and each PTRS port may be associated with each panel (or each SRS resource set) as in Method 4, the PTRS port may be associated not with the PUSCH antenna port on which each PUSCH is transmitted (when the codebook PUSCH is supported) or with the port of the SRS resource to indicate the port of the transmitted PUSCH (when the noncodebook PUSCH is supported), but with the first SRS resource (or first panel) or the second SRS resource set (or second panel).

When a condition that the PUSCH is simultaneously transmitted via multiple panels and the number of supported UL PTRS ports is 2 are satisfied through a higher layer parameter, other DCI-based indication, or the like, the association relationship between the PTRS and the DMRS may be applied. In this case, in Table 42-2, the DMRS port sharing PTRS port 0 may represent DMRS ports of the first PUSCH associated with the first SRS resource set. In Table 42-2, the DMRS port sharing PTRS port 1 may represent DMRS ports of the first PUSCH associated with the second SRS resource set.

The method supports NR Release 17 mTRP TDM PUSCH repetitive transmission, and when the number of layers of NR Release 17 mTRP TDM PUSCH repetitive transmission is 4, two PTRS-DMRS association fields are used. However, the method may indicate an association relationship between the PTRS port and the PUSCH DMRS port transmitted via each channel by only using a first PTRS-DMRS association field without using a second PTRS-DMRS association field. That is, in case that it is configured (including a higher layer configuration and a DCI-based indication) to support multi-panel simultaneous transmission and two PUSCHs with a maximum layer sum of 4 with multiple panels are supported, only one PTRS-DMRS association field may be configured in the DCI that schedules the corresponding PUSCH.

Alternatively, although two SRS resource sets (of which usage is “codebook” or “nonCodebook”) are configured and thus two PTRS-DMRS association regions may be configured, the second PTRS-DMRS association region may be ignored and may not be used.

Alternatively, the previous explanation focused on the method for indicating the association relationship between PTRS-DMRS by using the first PTRS-DMRS association region, but in a way of using both PTRS-DMRS association regions, the first PTRS-DMRS association region may be used to indicate the association relationship between the PTRS port and the DMRS of the first PUSCH transmitted via the first panel (or by referring to the first SRS resource set), and the second PTRS-DMRS association region may be used to indicate the association relationship between the PTRS port and the DMRS of the first PUSCH transmitted via the second panel (or by referring to the second SRS resource set).
Method 5) Two PTRS ports may be associated with any PUSCH transmission: When simultaneous transmission using multiple panels is supported, unlike Method 4, in which each PTRS port is associated with two different PUSCH transmissions, method 5 allows a PTRS port to be associated with any PUSCH transmission without this condition. That is, while one PTRS port is mapped to be associated with one PUSCH transmission in Method 4, in Method 5, one PTRS port may be associated with one PUSCH transmission and two PTRS ports may be associated with on PUSCH transmission so that no PTRS port may be associated with another PUSCH transmission. This may support full flexible scheduling based on a channel situation, a channel estimated by the BS through a received SRS resource for each panel. In this case, it may need to indicate a panel (or SRS resource set) among two panels (or two SRS resource sets), with which the PTRS port is associated.

During 1CW-based simultaneous transmission with up to 4-layer multi-panel, in Method 5, a first PTRS-DMRS association region included in DCI for indicating an SRS resource set (or panel) with which the PTRS port is associated may be reinterpreted and used. For example, in case that the first PTRS-DMRS association region is configured as “0”, the UE may understand that both PTRS ports are associated with the first PUSCH transmitted via the first SRS resource set (or the first panel). In case that the first PTRS-DMRS association region is configured as “1”, the UE may understand that both PTRS ports are associated with the second PUSCH transmitted via the second SRS resource set (or the second panel). In case that the first PTRS-DMRS association region is configured as “2”, the UE may understand that one (e.g., PTRS port 0) of two PTRS ports is associated with the first PUSCH transmitted via the first SRS resource set (or the first panel) and the other (e.g., PTRS port 1) is associated with the second PUSCH transmitted via the second SRS resource set (or the second panel). Thereafter, as for the second PTRS-DMRS association region, one or two DMRS ports associated with the PTRS port are selected from among DMRS ports with respect to the PUSCH transmission with which the PTRS port may be associated.

When assuming that multi-panel simultaneous transmission is supported and the number of layers scheduled for each PUSCH is less than or equal to 2, in case that a value of the first PTRS-DMRS association region is indicated as “0” or “1, regardless of a value of the second PTRS-DMRS association region, PTRS port 0 and PTRS port 1 of two PTRS ports may be sequentially associated with two DMRS ports of the first PUSCH (associated with the first SRS resource set or the first panel, in case that the value of first PTRS-DMRS association region is indicated as “0”) or the second PUSCH (associated with the second SRS resource set or the second panel, in case that the value of first PTRS-DMRS association region is indicated as “1”). For example, in case that the value of the first PTRS-DMRS association region is “0” and DMRS ports 0 and 1 are indicated in the first PUSCH of 2 layers, both PTRS ports are associated with the first PUSCH, and the UE may associate, regardless of the value of the second PTRS-DMRS association filed (or a corresponding 2-bit region may be configured as “00”), PTRS port 0 with DMRS port 0 of the first PUSCH and PTRS port 1 with DMRS port 1 of the first PUSCH. In case that the value of the first PTRS-DMRS association region is “1” and DMRS ports 2 and 3 are indicated in the second PUSCH of 2 layers, both PTRS ports are associated with the second PUSCH, and the UE may associate, regardless of the value of the second PTRS-DMRS association filed (or a corresponding 2-bit region may be configured as “00”), PTRS port 0 with DMRS port 2 of the second PUSCH and PTRS port 1 with DMRS port 3 of the second PUSCH. In case that the value of the first PTRS-DMRS association region is “2”, DMRS ports 0 and 1 are indicated in the first PUSCH of 2 layers, DMRS ports 2 and 3 are indicated in the second PUSCH of 2 layers, and the second PTRS-DMRS association region is indicated as “01” (or a value of “1), the UE may associate PTRS port 0 with DMRS port 0 which is the first DMRS port of the first PUSCH and associate PTRS port 1 with DMRS port 4 which is the second DMRS port of the second PUSCH. That is, if the value of the first PTRS-DMRS association region is “2”, the same method as above-described Method 4 in which each PTRS port and the DMRS associated with the PTRS of each PUSCH are indicated by using one PTRS-DMRS association region having 2 bits may be used.

If each PUSCH may support 3 layers instead of supporting up to 2 layers, a 2-bit second PTRS-DMRS association region may be differently interpreted depending on the number of layers of the PUSCH scheduled for multi-panel simulate nous transmission. If the first PTRS-DMRS association region is indicated as “0” or “1” and the PUSCH with which both indicated PTRS are associated is transmitted via 3 layers, among the three PUSCH DMRS ports, two PUSCH DMRS ports associated with two PTRS ports need to be selected. Here, a rule for the DMRS port with which PTRS port 0 or 1 may be associated may be established using the same method as NR Release 15/16. For example, if the codebook PUSCH is supported, a layer (DMRS) transmitted via PUSCH port 0 and PUSCH port 2 of the first or second PUSCH transmitted via an SRS resource set (or panel) may be associated with PTRS port 0 and a layer (DMRS) transmitted via PUSCH port 1 and PUSCH port 3 of the first or second PUSCH may be associated with PTRS port 1. For example, if the noncodebook PUSCH is supported, an associated PTRS port may be determined for each SRS resource according to a configuration of an SRS resource in each SRS resource set. Thereafter, as for the second PTRS-DMRS association region, referring to Table 42-2, a 1-bit MSB may indicate one of DMRS, which may be associated with PTRS port 0, and a 1-bit LSB may indicate one of DMRS, which may be associated with PTRS port 1. As such, by indicating each DMRS associated with each PTRS port one by one, two DMRS ports associated with two PTRS ports may be indicated from among three DMRS ports.

If, as Mapping method 2 in the fifth embodiment, the PUSCH ports are indexed by considering all PUSCH ports transmitted via all SRS resources and all panels, a rule with respect to a PUSCH port which may be associated with PTRS port 0 and PTRS port 1 may need to be updated. This may be required for supporting the codebook PUSCH, and the noncodebook PUSCH is determined according to associated ptrs-PortIndex configured in a higher layer parameter PUSCH-Resource, and thus a rule therefor does not need to be updated.

If each of two PUSCHs simultaneously transmitted via two SRS resource sets (or two panels) is transmitted via 4 PUSCH ports and a PUSCH port is indexed in the same manner as Mapping method 2 described in the first embodiment, the first PUSCH (transmitted via the first SRS resource set or the first panel) is transmitted via PUSCH ports 0 to 3, and the second PUSCH (transmitted via the second SRS resource set or the second panel) is transmitted via PUSCH ports 4 to 7. In this case, PTRS port 0 may correspond to a layer (DMRS) transmitted via PUSCH port 0 or PUSCH port 2 or may be associated with a layer (DMRS) transmitted via PUSCH port 4 or PUSCH port 6. PTRS port 1 may correspond to a layer (DMRS) transmitted via PUSCH port 1 or PUSCH port 3 or may be associated with a layer (DMRS) transmitted via PUSCH port 5 or PUSCH port 7. If the first PTRS-DMRS association region is indicated as “2”, the number of layers of a PUSCH (e.g., the first PUSCH) transmitted via one SRS resource set or panel (e.g., the first SRS resource set or the first panel) is 1, and the number of layers of a PUSCH (e.g., the second PUSCH) transmitted via another SRS resource set or panel (e.g., the second SRS resource set or the second panel) is 3, one PTRS port (e.g., PTRS port 0) may be associated with a DMRS in a 1-layer PUSCH (e.g., the first PUSCH) transmitted via one SRS resource set or panel (e.g., the first SRS resource set or the first panel) without a separate PTRS-DMRS association relationship indication. Another PTRS port (e.g., PTRS port 1) may be associated with one DMRS among three DMRS ports in a 3-layer PUSCH (e.g., the second PUSCH) transmitted via another SRS resource set or panel (e.g., the second SRS resource set of the second panel) and an association relationship therefor may be determined by referring to the second PTRS-DMRS association region. That is, by using all 2 bits, the BS may indicate one of the three DMRS to the UE, and the UE may understand that one DMRS indicated by the second PTRS-DMRS association field among the three DMRSs is associated with the corresponding PTRS port (PTRS port 1 in the example).

Although Methods 1 to 5 are described above assuming that the PUSCH, which is transmitted simultaneously by using multiple panels, is transmitted through two TRPs, the methods may be similarly used for mTRP multi-panel simultaneous transmission PUSCH transmitted through two TRPs as well as sTRP multi-panel simultaneous transmission PUSCH transmitted through one TRP. In this case, a PTRS port may be associated with PUSCH transmission associated with two SRS resources within one SRS resource set, rather than two SRS resource sets. Here, SRS resources within one SRS resource set may have an implicit or explicit association with a panel that the UE may support. In this case, the above-described method may be applied by replacing the two SRS resource sets with two SRS resources in one set.

### Seventh Embodiment: A Method for Determining Association Relationship Between PTRS and DMRS when Supporting Single DCI Multi-Codeword-Based Multi-Panel Simultaneous Transmission

In accordance with an embodiment of the disclosure, a method for determining a DMRS associated with a PTRS when scheduling a multi-panel simultaneous transmission PUSCH based on multi-codeword (multiple codewords, dual codewords, dual CWs, or 2CWs) via sDCI is provided.

Until NR Release 17, up to 4 layers may be supported when transmitting a PUSCH, and 1CW was mapped to a layer and scheduled to be transmitted on the PUSCH. However, NR Release 18 or later NR Release may support up to 8-layer (in NR Release 18, PUSCH may be transmitted up to 8 layers and in subsequent releases, layers larger than 8 may also be considered) PUSCH transmission when transmitting a PUSCH, and accordingly, 2CWs (or in subsequent Release, a number of CWs greater than 2 may also be considered) instead of 1CW may be mapped to a layer and scheduled to be transmitted on the PUSCH. Furthermore, even if up to 4 layers are supported, if a multi-panel simultaneous transmission PUSCH is supported, a method of transmitting 1CW for each PUSCH transmitted via each panel (or each SRS resource set) for a total of 2CWs may be additionally considered. As such, if a multi-panel simultaneous transmission PUSCH is supported and a method for transmitting different codewords for each PUSCH transmission is supported, a method for determining an association relationship by considering a codeword may be considered in addition to the method for determining the association relationship between the PTRS and the DMRS described in the sixth embodiment above. That is, when the UE performs 2CW-based PUSCH simultaneous transmission via multiple panels, the association relationship between the PTRS and the DMRS may be determined according to the method described in the sixth embodiment, and the association relationship between the PTRS and the DMRS may be determined according to a method described below by additionally considering 2CWs. Here, the UE reports a UE capability for multi-panel simultaneous transmission to the BS, should receive a related higher layer parameter (e.g., two SRS resource sets and the like) from the BS, and then reports a UE capability to support 2CWs (or extending to more than 2 CWs) rather than 1CW. Thereafter, the BS may configure a higher layer parameter (may have a higher layer parameter name of, e.g., “enableTwoCWs” or another name for the same/similar operation) to the UE for the case of supporting up to 2CWs.

The BS may configure the number of supported UL PTRS ports to “1”. This may be configured through a parameter maxNrofPorts in PTRS-UplinkConfig in DMRS-UplinkConfig in a higher layer parameter PUSCH-config for PUSCH configuration, and since the number of supported UL PTRS ports is “1”, a value of a corresponding parameter maxNrofPorts may be configured to be “n1”. Although there is one PTRS port, two PUSCHs are transmitted via two different SRS resource sets (or two panels), so only one of the two PUSCHs may be associated with the PTRS port. In addition to Methods 1 to 3 described in the sixth embodiment, depending on the MCS of the CW transmitted on the two PUSCHs, the PUSCH DMRS port and PUSCH with which one PTRS port is associated may be determined. The BS may indicate that the DMRS of the PUSCH transmitting CW with a higher MCS among the two PUSCHs transmitted via the two panels is associated with the PTRS port. If multiple DMRS ports are indicated by transmitting the corresponding PUSCH with a layer greater than 1, one DMRS among the DMRS of the PUSCH transmitting CW via a higher MCS may be selected using 2 bits of the PTRS-DMRS association region. This may be applied to both of the case in which the number of layers that may be transmitted on each PUSCH supporting multi-panel simultaneous transmission is 2 and the case in which the number thereof is greater than 2.

When supporting as described above, since two SRS resource sets are configured, two PTRS-DMRS association regions may be indicated within the DCI that schedule the PUSCH transmitted, and the UE may use only the first PTRS-DMRS association region and ignore the second PTRS-DMRS region.

Alternatively, depending on one of the first PUSCH (the PUSCH transmitted via the first SRS resource set or the first panel) and the second PUSCH (the PUSCH transmitted via the second SRS resource set or the second panel), which is associated with the PTRS port according to each MCS, the first PTRS-DMRS association region may be used (when one PTRS port is associated with the first PUSCH) or the second PTRS-DMRS association region may be used (when one PTRS port is associated with the second PUSCH).

Alternatively, in case that a corresponding condition (higher layer parameter configuration conditions such as supporting multi-panel simultaneous transmission, and 2CW and 1 PTRS port, etc.) is satisfied, instead of indicating two PTRS-DMRS association regions via DCI, the BS may indicate only one PTRS-DMRS association region via DCI, and the UE may use only one PTRS-DMRS association region to determine the PUSCH and DMRS ports associated with the PTRS port.

The BS may configure the number of supported UL PTRS ports to “2”. This may be configured through a parameter maxNrofPorts in PTRS-UplinkConfig in DMRS-UplinkConfig in a higher layer parameter PUSCH-config for PUSCH configuration, and since the number of supported UL PTRS ports is “2”, a value of a corresponding parameter maxNrofPorts may be configured to be “n2”. The maximum number of PTRS ports is 2, and thus each PTRS port may be associated one by one with a PUSCH transmitted via each SRS resource set (or each panel) during multi-panel simultaneous transmission. This may operate in the same manner as Method 4 of the sixth embodiment.

As another method, all PTRS ports may be associated with only one PUSCH without any restrictions as in Method 5, or each PTRS port may be associated with each PUSCH transmission one by one. For example, during simultaneous multi-panel transmission, all two PTRS ports may be associated with one PUSCH and may be determined according to the MCS of each CW transmitted on the two PUSCHs. The BS may indicate that the DMRS port of the PUSCH transmitting CW with a higher MCS among the two PUSCHs transmitted via the two panels is associated with the two PTRS ports. If the PUSCH is scheduled with 2 layers, regardless of the PTRS-DMRS association region within the DCI, the DMRS port with the lower index of the two PUSCH DMRS ports may be associated with PTRS port 0, and the DMRS port with the higher index of the two PUSCH DMRS ports may be associated with PTS port 1. If the PUSCH is scheduled with layers larger than 3, two DMRS ports among the DMRS ports of the PUSCH transmitting CW via a higher MCS may be selected using 2 bits of the PTRS-DMRS association region.

The method for selecting two DMRS ports from among three DMRS ports may be performed using the same method as specifying two DMRS ports among three DMRS ports specifically described in Method 5 of the sixth embodiment. In other words, the UE may select the PUSCH transmitting CW via a higher MCS from among two PUSCH, and in case that the PUSCH is transmitted via three layers, determine two of the three DMRS ports as PTRS-DMRS association regions and associate the two DMRS ports with the two PTRS ports. In the same manner as the example described above, assuming that one PTRS port is supported, when a corresponding condition (higher layer parameter configuration conditions such as supporting multi-panel simultaneous transmission, 2CW, and two PTRS ports, etc.) is satisfied, since two SRS resource sets are configured, the BS may indicate two PTRS-DMRS association regions via DCI and use only one of them, or may indicate only one PTRS-DMRS association region instead of indicating two PTRS-DMRS association regions.

### Eighth Embodiment: A Method for Determining an Association Relationship Between PTRS and DMRS and Transmitting a PTRS when Supporting Multi-DCI-Based Multi-Panel Simultaneous Transmission

In accordance with an embodiment, a method for associating a PTRS port with a DMRS port for transmitting a PUSCH in case that two PUSCHs are transmitted via multiple panels based on mDCI is provided and scheduling conditions that should be satisfied in this case will be explained in detail.

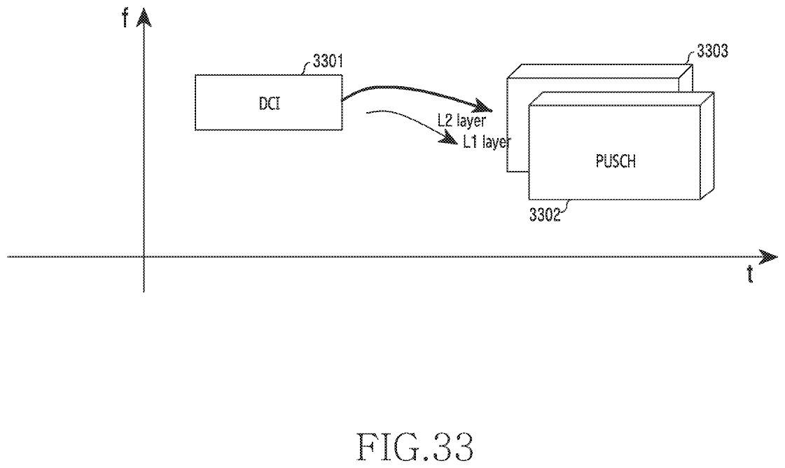

FIG. 33 illustrates two PUSCHs simultaneously transmitted to a single DCI-based multi-panel according to an embodiment.

The sixth and seventh embodiments specifically illustrated the method in which the UE determines the DMRS port associated with the PTRS port to transmit the PTRS port when two PUSCHs 3302 and 3303 are scheduled based on sDCI (single DCI) 3301 and transmitted simultaneously through the same time and frequency resources as shown in FIG. 33.

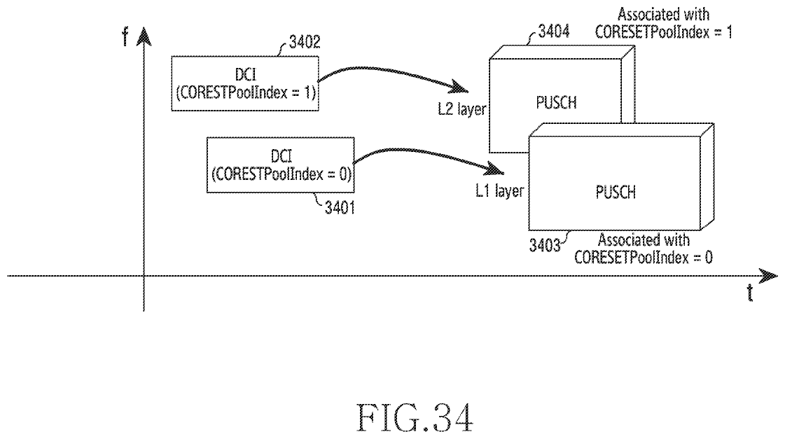

FIG. 34 illustrates two PUSCHs simultaneously transmitted to a multi-DCI-based multi-panel according to an embodiment

However, as shown in FIG. 34, when scheduling multi-panel simultaneous transmission 3403 or 3404 based on mDCI 3401 or 3402, each PUSCH is scheduled from each DCI, and in this case, the DCI needs to be received from CORESET with different CORESETPoolIndex. Since each PUSCH is scheduled through each DCI, different time/frequency/space resources may be allocated to the two PUSCHs 3403 and 3404, and the TB size and MCS may be different.

In addition, each PTRS-DMRS association region may also be indicated via each DCI. When two mDCI-based PUSCHs are scheduled, in the time domain, two PUSCHs may partially or completely overlap, and in the frequency domain, the two PUSCHs may partially or completely overlap or not overlap each other. In this case, the UE simultaneously transmits the two PUSCHs scheduled via two DCIs by using multiple panels. However, if up to 2 PTRS ports are associated with each PUSCH, up to 4 PTRS ports may be transmitted on time/frequency/space resources where two PUSCHs overlap. With respect to the case, two PUSCHs scheduled via two DCIs may be transmitted simultaneously using multiple panels through following methods:
Option 1) In case of supporting mDCI-based multi-panel simultaneous transmission, up to 4 PTRS ports may be supported, the UE performs a UE capability report with respect to same, and the BS may configure same via a higher layer parameter based on the UE capability report. Similarly, in case that the UE supports up to one PTRS port for each PUSCH, the UE reports, as a UE capability, whether two PUSCHs overlap and the UE may support up to 2 PTRS ports, and the BS may configure same via a higher layer parameter.
Option 2) A constraint may be added so that the maximum number of PTRS ports does not exceed 2 for two overlapping PUSCHs. That is, when transmitting each PUSCH, it may be constrained to use only one PTRS port.
Option 3) Although any restrictions are added in terms of a standard, when scheduling two PUSCHs that are simultaneously transmitted via multiple panels, the BS may consider scheduling constraints so that the number of PTRS ports for the two overlapping PUSCHs does not exceed 2. That is, up to 2 PTRS ports are available for each PUSCH, if two PUSCHs are transmitted overlapping via multiple panels, scheduling may be constrained so that only one actual PTRS port is transmitted on each PUSCH.

As defined in 3GPP specification 38.214, if a layer scheduled to transmit a corresponding PUSCH is associated with only one PTRS port, the number of actual PTRS ports may be considered to be 1, and if a layer scheduled to transmit a PUSCH is associated with two PTRS ports, the number of actual PTRS ports may be considered to be 2. That is, when scheduling two PUSCHs to perform multi-panel simultaneous transmission via mDCI, the BS may constrain the scheduling so that the actual number of PTRS ports for each PUSCH is 1, and PUSCHs may be associated with different PTRS ports. In this case, two TRPs in an mTRP may need some of the scheduling information for the other TRP, and information on the constraints which is performed to cause each TRP to be associated with a certain PTRS port should be shared.

As described in the sixth, seventh, and eighth embodiments above, when supporting multi-panel simultaneous transmission, the number of configurable PTRS ports may be configured to 1 or 2. In this case, during multi-panel transmission, the UE may perform a UE capability report on whether operation is possible with only one PTRS port, or with two PTRS ports, and the UE may report supportable features to the BS. In addition, if the operation is possible with two PTRS ports, the UE may report, to the BS, whether two PTRS ports may be used by being mapped to each PUSCH transmitted via each panel or two PTRS ports are mapped to one panel to support PUSCHs simultaneously transmitted via multiple panels through an additional UE capability report. This is, e.g., applicable to the mDCI-based multi-panel simultaneous transmission of the eighth embodiment, and all two PTRS ports may be associated with one of the two overlapping PUSCHs, and there may be no PTRS ports associated with the other PUSCH.

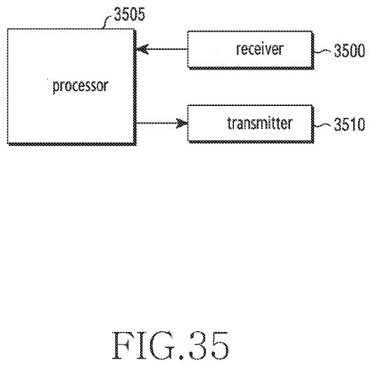

FIG. 35 illustrates a UE according to an embodiment.

Referring to FIG. 35, the UE includes a processor 3505, a receiver 3500, and a transmitter 3510. However, the components of the terminal are not limited to the examples described above.

For example, the UE may include a transceiver (e.g., including the receiver 3500 and the transmitter 3510), and a memory. The UE may also include more or fewer components than the aforementioned components. In addition, the transceiver, memory, and processor may be implemented in the form of a single chip.

Depending on the communication method of the UE described above, the UE's transceiver, memory, and processor 3505 can operate accordingly.

The transceiver can transmit and receive signals to and from the BS. Here, the signal may include control information and data. To this end, the transceiver may be composed of a radio frequency (RF) transmitter that up-converts and amplifies the frequency of the transmitted signal, and an RF receiver that amplifies the received signal with low noise and down-converts the frequency. However, this is only an example of the transceiver, and the components of the transceiver are not limited to the RF transmitter and RF receiver.

Additionally, the transceiver may receive a signal through a wireless channel and output it to the processor 3505, and transmit the signal output from the processor 3505 through a wireless channel.

The memory can store programs and data necessary for the operation of the terminal. Additionally, the memory can store control information or data included in signals transmitted and received by the terminal. The memory may include storage media such as read only memory (ROM), random access memory (RAM), a hard disk, a compact disc ROM (CD-ROM), a digital versatile disc (DVD), or a combination of storage media. Additionally, there may be multiple memories.

Additionally, the processor 3505 can control a series of processes so that the terminal can operate according to the above-described embodiment. For example, the processor 3505 can receive DCI composed of two layers and control the components of the terminal to transmit multiple PUSCHs at the same time. There may also be a plurality of processors, and the processors may perform a component control operation of the terminal by executing a program stored in the memory.

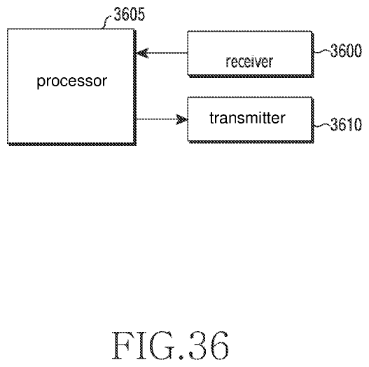

FIG. 36 illustrates a BS according to an embodiment. For example, the BS in FIG. 36 may refer to a TRP as described above.

Referring to FIG. 36, the BS includes a receiver 3600, a transmitter 3610, and a processor 3605. However, the components of the BS are not limited to the above examples.

For example, the BS may include a transceiver (e.g., including the BS transmitter 3610 and the receiver 3600), and a memory, Additionally, the BS may include more or fewer components than those described above. In addition, the transceiver, memory, and processor 3605 may be implemented in the form of a single chip.

According to the above-described communication method of the BS, the BS's transceiver, memory, and BS processing unit 3605 can operate accordingly.

The transceiver can transmit and receive signals to and from the terminal. Here, the signal may include control information and data. To this end, the transceiver may include an RF transmitter that up-converts and amplifies the frequency of the transmitted signal, and an RF receiver that amplifies the received signal with low noise and down-converts the frequency. However, this is only an example of the transceiver, and the components of the transceiver are not limited to the RF transmitter and RF receiver.

Additionally, the transceiver may receive a signal through a wireless channel and output it to the processor 3605, and transmit the signal output from the processor 3605 through a wireless channel.

The memory can store programs and data necessary for the operation of the BS. Additionally, the memory may store control information or data included in signals transmitted and received by the BS. The memory may include storage media such as ROM, RAM, hard disk, CD-ROM, DVD, or a combination of storage media. Additionally, there may be multiple memories.

The processor 3605 can control a series of processes so that the BS can operate according to the above-described embodiments of the disclosure. For example, the processor 3605 can configure two layers of DCIs containing allocation information for multiple PUSCHs and control each component of the BS to transmit them. There may be a plurality of processors, and the processors may perform a component control operation of the BS by executing a program stored in a memory.

Methods according to embodiments described in the claims or disclosure of the present disclosure may be implemented in the form of hardware, software, or a combination of hardware and software.

When implemented as software, a computer-readable storage medium that stores one or more programs (software modules) may be provided. One or more programs stored in a computer-readable storage medium are configured to be executable by one or more processors in an electronic device (configured for execution). One or more programs include instructions that cause the electronic device to execute methods according to embodiments described in the claims or disclosure of the present disclosure.

These programs (software modules, software) may be stored in RAM, non-volatile memory including flash memory, ROM, electrically erasable programmable ROM (EEPROM), a magnetic disc storage device, a CD-ROM, a DVD, or other types of memory, e.g., an optical storage device or magnetic cassette. Alternatively, the programs may be stored in a memory consisting of a combination of some or all of these. Additionally, multiple configuration memories may be included.

In addition, a program can be accessed through a communication network such as the Internet, Intranet, local area network (LAN), a wide LAN (WLAN), a storage area network (SAN), or a combination thereof.

A program may be stored in an attachable storage device that can be accessed. This storage device can be connected to a device performing an embodiment of the present disclosure through an external port. Additionally, a separate storage device on a communication network may be connected to the device performing an embodiment of the present disclosure.

In the above-described embodiments of the disclosure, elements included in the disclosure are expressed in singular or plural numbers depending on the specific embodiment presented. However, singular or plural expressions are selected to suit the presented situation for convenience of explanation, and the present disclosure is not limited to singular or plural components, and even components expressed in plural may be composed of singular or singular. Even expressed components may be composed of plural elements.

The embodiments of the disclosure and drawings are merely provided as examples to easily explain the technical content of the present disclosure and aid understanding of the disclosure, and are not intended to limit the scope of the disclosure. That is, those skilled in the art will appreciate that other modifications based on the technical idea of the disclosure can be implemented. Additionally, each of the above embodiments can be operated in combination with each other as needed. For example, a BS and a terminal may be operated by combining parts of one embodiment of the disclosure and another embodiment. For example, parts of the first and second embodiments of the disclosure may be combined to operate the BS and the terminal.

In addition, although the above embodiments were presented based on the FDD LTE system, other modifications based on the technical idea of the above embodiments may be implemented in other systems such as a TDD LTE system, 5G or NR system.

In the drawings explaining the method of the present disclosure, the order of description does not necessarily correspond to the order of execution, and the order of precedence may be changed or executed in parallel.

Alternatively, the drawings explaining the method of the present disclosure may omit some components and include only some components within the scope that does not impair the essence of the present disclosure.

In addition, the method of the present disclosure may be implemented by combining some or all of the content included in each embodiment within the range that does not impair the essence of the disclosure.

Various embodiments of the present disclosure have been described above. The above description of the present disclosure is for illustrative purposes, and the embodiments of the present disclosure are not limited to the disclosed embodiments. A person skilled in the art to which this disclosure pertains will understand that the present disclosure can be modified into another specific form without changing its technical idea or essential features.

The scope of the present disclosure is indicated by the claims described below rather than the detailed description above, and all changes or modified forms derived from the meaning and scope of the claims and their equivalent concepts should be construed as being included in the scope of the present disclosure.

What is claimed is:

1. A method performed by a user equipment (UE) in a wireless communication system, the method comprising:
receiving, from a base station (BS), configuration information associated with an uplink (UL), the configuration information including sounding reference signal (SRS) resource set information including a first SRS resource set and a second SRS resource set, information indicating that at most two phase tracking reference signal (PT-RS) ports are used for the UL, and information for a configuration of simultaneous transmission across multi-panel (STxMP);
receiving, from the BS, downlink control information (DCI) including association information between a PT-RS port and a demodulation reference signal (DMRS) port; and
transmitting, based on the DCI, the PT-RS using a first PT-RS port and a second PT-RS port, according to the received configuration of the STxMP,
wherein the first PT-RS port is associated with at least one first DMRS port associated with the first SRS resource set, and the second PT-RS port is associated with at least one second DMRS port associated with the second SRS resource set.

2. The method of claim 1, wherein the DCI further includes a first SRS resource indicator (SRI) field associated with the first SRS resource set, and a second SRI field associated with the second SRS resource set.

3. The method of claim 2, wherein usage of each of the first SRS resource set and the second SRS resource set is configured to a non-codebook,
wherein each of the first SRS resource set and the second SRS resource set includes information on at least one SRS resource including information on a PT-RS port associated with each of the at least one SRS resource, and
wherein, in case two PT-RS ports are used and the STxMP is configured, the information on the PT-RS port associated with each of the at least one SRS resource is ignored.

4. The method of claim 1, wherein the association information includes first information indicating a DMRS port used for the first PT-RS port among the at least one first DMRS port and second information indicating a DMRS port used for the second PT-RS port among the at least one second DMRS port.

5. A method performed by a base station (BS) in a wireless communication system, the method comprising:
transmitting, to a user equipment (UE), configuration information associated with an uplink (UL), the configuration information including sounding reference signal (SRS) resource set information including a first SRS resource set and a second SRS resource set, information indicating that at most two phase tracking reference signal (PT-RS) ports are used for the UL, and information for a configuration of simultaneous transmission across multi-panel (STxMP);
transmitting, to the UE, downlink control information (DCI) including association information between a PT-RS port and a demodulation reference signal (DMRS) port; and
receiving, based on the DCI, the PT-RS based on a first PT-RS port and a second PT-RS port, according to the received configuration of the STxMP,
wherein the first PT-RS port is associated with at least one first DMRS port associated with the first SRS resource set, and the second PT-RS port is associated with at least one second DMRS port associated with the second SRS resource set.

6. The method of claim 5, wherein the DCI further includes a first SRS resource indicator (SRI) field associated with the first SRS resource set, and a second SRI field associated with the second SRS resource set.

7. The method of claim 6, wherein usage of each of the first SRS resource set and the second SRS resource set is configured to a non-codebook,
wherein each of the first SRS resource set and the second SRS resource set includes information on at least one SRS resource including information on a PT-RS port associated with each of the at least one SRS resource, and
wherein, in case that two PT-RS ports are used and the STxMP is configured, the information on the PT-RS port associated with each of the at least one SRS resource is ignored.

8. The method of claim 5, wherein the association information includes first information indicating a DMRS port used for the first PT-RS port among the at least one first DMRS port and second information indicating a DMRS port used for the second PT-RS port among the at least one second DMRS port.

9. A user equipment (UE) in a wireless communication system, the UE comprising:
a transceiver;
a controller coupled with the transceiver and configured to:
receive, from a base station (BS), configuration information associated with an uplink (UL), the configuration information including sounding reference signal (SRS) resource set information including a first SRS resource set and a second SRS resource set, information indicating that at most two phase tracking reference signal (PT-RS) ports are used for the UL, and information for a configuration of simultaneous transmission across multi-panel (STxMP),
receive, from the BS, downlink control information (DCI) including association information between a PT-RS port and a demodulation reference signal (DMRS) port, and
transmit, based on the DCI, the PT-RS using a first PT-RS port and a second PT-RS port, according to the received configuration of the STxMP, and
wherein the first PT-RS port is associated with at least one first DMRS port associated with the first SRS resource set, and the second PT-RS port is associated with at least one second DMRS port associated with the second SRS resource set.

10. The UE of claim 9, the DCI further includes a first SRS resource indicator (SRI) field associated with the first SRS resource set, and a second SRI field associated with the second SRS resource set.

11. The UE of claim 10, wherein usage of each of the first SRS resource set and the second SRS resource set is configured to a non-codebook,
wherein each of the first SRS resource set and the second SRS resource set includes information on at least one SRS resource including information on a PT-RS port associated with each of the at least one SRS resource, and
wherein, in case that two PT-RS ports are used and the STxMP is configured, the information on the PT-RS port associated with each of the at least one SRS resource is ignored.

12. The UE of claim 9, wherein the association information includes first information indicating a DMRS port used for the first PT-RS port among the at least one first DMRS port and second information indicating a DMRS port used for the second PT-RS port among the at least one second DMRS port.

13. A base station (BS) in a wireless communication system, the BS comprising:
a transceiver;
a controller coupled with the transceiver and configured to:
transmit, to a user equipment (UE), configuration information associated with an uplink (UL), the configuration information including sounding reference signal (SRS) resource set information including a first SRS resource set and a second SRS resource set, information indicating that at most two phase tracking reference signal (PT-RS) ports are used for the UL, and information for a configuration of simultaneous transmission across multi-panel (STxMP),
transmit, to the UE, downlink control information (DCI) including association information between a PT-RS port and a demodulation reference signal (DMRS) port, and
receiving, based on the DCI, the PT-RS based on a first PT-RS port and a second PT-RS port, according to the received configuration of the STxMP, and
wherein the first PT-RS port is associated with at least one first DMRS port associated with the first SRS resource set, and the second PT-RS port is associated with at least one second DMRS port associated with the second SRS resource set.

14. The BS of claim 13, wherein the DCI further includes a first SRS resource indicator (SRI) field associated with the first SRS resource set, and a second SRI field associated with the second SRS resource set.

15. The BS of claim 14, wherein usage of each of the first SRS resource set and the second SRS resource set is configured to a non-codebook,
wherein each of the first SRS resource set and the second SRS resource set includes information on at least one SRS resource including information on a PT-RS port associated with each of the at least one SRS resource, and
wherein, in case that two PT-RS ports are used and the STxMP is configured, the information on the PT-RS port associated with each of the at least one SRS resource is ignored.

16. The BS of claim 13, wherein the association information includes first information indicating a DMRS port used for the first PT-RS port among the at least one first DMRS port and second information indicating a DMRS port used for the second PT-RS port among the at least one second DMRS port.
